(19) United States
(12) Patent Application Publication
(10) Pub. No.: US 2025/0324480 A1
(43) Pub. Date: Oct. 16, 2025

(54) BEAM INDICATION FOR MULTIPLE ENTITIES

(71) Applicant: Samsung Electronics Co., Ltd., Suwon-si (KR)

(72) Inventors: Emad Nader Farag, Flanders, NJ (US); Eko Onggosanusi, Coppell, TX (US); Md. Saifur Rahman, Plano, TX (US); Dalin Zhu, Allen, TX (US)

(21) Appl. No.: 19/096,423

(22) Filed: Mar. 31, 2025

Related U.S. Application Data
(60) Provisional application No. 63/634,242, filed on Apr. 15, 2024.
(60) Provisional application No. 63/635,951, filed on Apr. 18, 2024.
(60) Provisional application No. 63/637,190, filed on Apr. 22, 2024.

(51) Int. Cl. H04W 76/20; H04B 7/06; H04L 1/1607; H04L 5/00

(52) U.S. Cl. CPC H04W 76/20; H04B 7/06968; H04L 1/1614; H04L 5/0051

(57) ABSTRACT

Apparatuses and methods for beam indication for multiple entities. A method of operating a user equipment (UE) includes receiving a configuration of one or more sets of transmission configuration indicator (TCI) states, receiving a first message activating TCI state code points, from the one or more sets of TCI states, and receiving a second message indicating TCI state code points for N entities. The second message includes a field map of size N fields and a list of TCI states code points in order of the N fields of the field map and according to a number of TCI state code points indicated by each field. Each field of the N fields correspond to an entity of the N entities. Each field indicates the number of TCI state code points indicated for the corresponding entity.

### CROSS-REFERENCE TO RELATED APPLICATIONS AND CLAIM OF PRIORITY

The present application claims priority to:
U.S. Provisional Patent Application No. 63/634,242, filed on Apr. 15, 2024;
U.S. Provisional Patent Application No. 63/635,951, filed on Apr. 18, 2024; and
U.S. Provisional Patent Application No. 63/637,190, filed on Apr. 22, 2024. The contents of the above-identified patent documents are incorporated herein by reference.

### TECHNICAL FIELD

The present disclosure relates generally to wireless communication systems and, more specifically, the present disclosure relates to a beam indication for multiple entities in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a beam indication for multiple entities in a wireless communication system.

In one embodiment, a user equipment (UE) is provided. The UE includes a processor and a transceiver operably coupled to the processor. The transceiver is configured to receive a configuration of one or more sets of transmission configuration indicator (TCI) states, receive a first message activating TCI state code points, from the one or more sets of TCI states, and receive a second message indicating TCI state code points for N entities. The second message includes a field map of size N fields and a list of TCI states code points in order of the N fields of the field map and according to a number of TCI state code points indicated by each field. Each field of the N fields correspond to an entity of the N entities. Each field indicates the number of TCI state code points indicated for the corresponding entity.

In another embodiment, a base station (BS) is provided. The BS includes a processor and a transceiver operably coupled to the processor. The transceiver is configured to transmit a configuration of one or more sets of TCI states, transmit a first message activating TCI state code points, from the one or more sets of TCI states, and transmit a second message indicating TCI state code points for N entities. The second message includes a field map of size N fields and a list of TCI states code points in order of the N fields of the field map and according to a number of TCI state code points indicated by each field. Each field of the N fields correspond to an entity of the N entities. Each field indicates the number of TCI state code points indicated for the corresponding entity.

In yet another embodiment, a method of operating a UE is provided. The method includes receiving a configuration of one or more sets of TCI states, receiving a first message activating TCI state code points, from the one or more sets of TCI states, and receiving a second message indicating TCI state code points for N entities. The second message includes a field map of size N fields and a list of TCI states code points in order of the N fields of the field map and according to a number of TCI state code points indicated by each field. Each field of the N fields correspond to an entity of the N entities. Each field indicates the number of TCI state code points indicated for the corresponding entity.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be provided. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to the present disclosure;

FIG. 6 illustrates an example of antenna structure according to embodiments of the present disclosure;

FIG. 7 illustrates an example of beam in a wireless communication system according to embodiments of the present disclosure;

FIG. 8 illustrates an example of multi-beams in a wireless communication system according to embodiments of the present disclosure;

FIG. 9 illustrates an example of a UE communication with up to 4 TRPs according to embodiments of the present disclosure;

FIG. 10 illustrates an example of TCI state codepoint according to embodiments of the present disclosure;

FIG. 11 illustrates an example of TCI state codepoint from a second list according to embodiments of the present disclosure;

FIG. 12 illustrates an example of TCI state according to embodiments of the present disclosure;

FIG. 13 illustrates another example of TCI state according to embodiments of the present disclosure;

FIG. 14 illustrates yet another example of TCI state according to embodiments of the present disclosure;

FIG. 15 illustrates an example of TCI state codepoint according to embodiments of the present disclosure;

FIG. 16 illustrates an example of TCI state codepoint from a second list and a first list according to embodiments of the present disclosure;

FIG. 17 illustrates yet another example of TCI state according to embodiments of the present disclosure;

FIG. 18 illustrates yet another example of TCI state according to embodiments of the present disclosure;

FIG. 19 illustrates yet another example of TCI state code point according to embodiments of the present disclosure;

FIG. 20 illustrates another example of TCI state codepoint from a second list and a first list according to embodiments of the present disclosure;

FIG. 21 illustrates an example of network configuration according to embodiments of the present disclosure;

FIG. 22 illustrates an example of signaling flow according to embodiments of the present disclosure;

FIG. 23 illustrates yet another example of TCI state according to embodiments of the present disclosure;

FIG. 24 illustrates yet another example of TCI state according to embodiments of the present disclosure;

FIG. 25 illustrates an example of TCI state 1 and TCI state 2 according to embodiments of the present disclosure;

FIG. 26 illustrates another example of network configuration according to embodiments of the present disclosure;

FIG. 27 illustrates another example of signaling flow according to embodiments of the present disclosure;

FIG. 28 illustrates yet another example of TCI state according to embodiments of the present disclosure;

FIG. 29 illustrates yet another example of TCI state according to embodiments of the present disclosure;

FIG. 30 illustrates an example of TCI state 1, TCI state 2, and TCI state 3 according to embodiments of the present disclosure;

FIG. 31 illustrates an example of network configuration for UE mobility according to embodiments of the present disclosure;

FIG. 32 illustrates an example of UE configuration with CSI-RS resources according to embodiments of the present disclosure;

FIG. 33 illustrates an example of QCL-property bitmap according to embodiments of the present disclosure;

FIG. 34 illustrates another example of QCL-property bitmap according to embodiments of the present disclosure;

FIG. 35 illustrates an example of QCL information according to embodiments of the present disclosure;

FIG. 36 illustrates an example of antenna port list for each channel or signal type according to embodiments of the present disclosure;

FIG. 37 illustrates another example of antenna port list for each channel or signal type according to embodiments of the present disclosure;

FIG. 38 illustrates yet another example of antenna port list for each channel or signal type according to embodiments of the present disclosure;

FIG. 39 illustrates an example of a set of UE for TCI state indication according to embodiments of the present disclosure;

FIG. 40 illustrates another example of a set of entities for TCI state indication according to embodiments of the present disclosure;

FIG. 41 illustrates an example of DCI for conveying TCI state/source RS QCL type for antenna port according to embodiments of the present disclosure;

FIG. 42 illustrates an example of DCI for conveying TCI state/source RS QCL type for UEs according to embodiments of the present disclosure;

FIG. 43 illustrates an example of DCI for conveying TCI state/source RS QCL type for antenna port groups according to embodiments of the present disclosure;

FIG. 44 illustrates an example of DCI for conveying TCI state/source RS QCL type for antenna port lists according to embodiments of the present disclosure;

FIG. 45 illustrates an example of DCI for conveying TCI state/source RS QCL type for UE lists according to embodiments of the present disclosure;

FIG. 46 illustrates an example of two stage/part DCI according to embodiments of the present disclosure;

FIG. 47 illustrates an example of stage/part DCI according to embodiments of the present disclosure;

FIG. 48 illustrates another example of stage/part DCI according to embodiments of the present disclosure;

FIG. 49 illustrates yet another example of stage/part DCI according to embodiments of the present disclosure;

FIG. 50 illustrates yet another example of stage/part DCI according to embodiments of the present disclosure;

FIG. 51 illustrates yet another example of stage/part DCI according to embodiments of the present disclosure;

FIG. 52 illustrates yet another example of stage/part DCI according to embodiments of the present disclosure;

FIG. 53 illustrates an example of two stage/part DCI for conveying TCI state/source RS QCL type for antenna ports according to embodiments of the present disclosure;

FIG. 54 illustrates another example of two stage/part DCI for conveying TCI state/source RS QCL type for antenna ports according to embodiments of the present disclosure; and

FIG. 55 illustrates yet another example of two stage/part DCI for conveying TCI state/source RS QCL type for antenna ports according to embodiments of the present disclosure.

### DETAILED DESCRIPTION

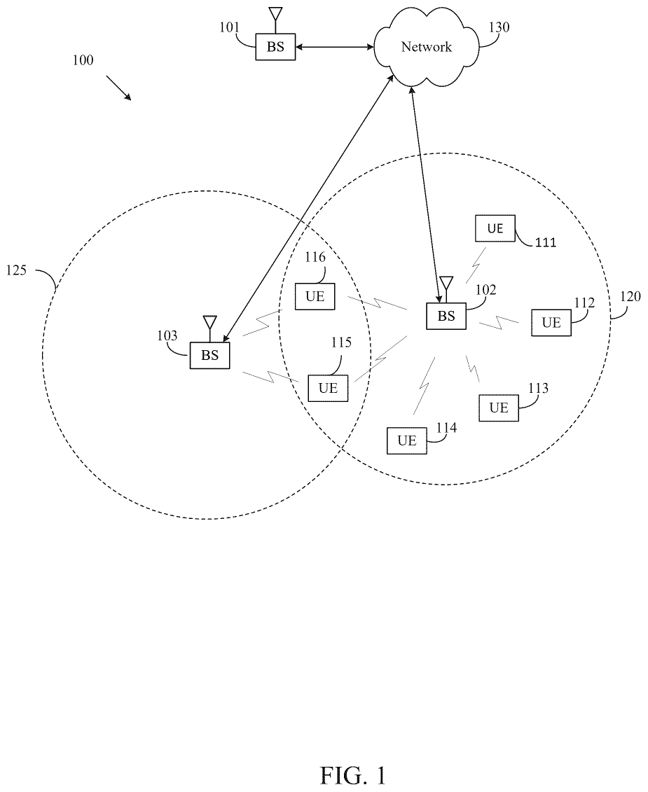

FIG. 1 through FIG. 55, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v18.1.0, “NR; Physical channels and modulation” [REF1]; 3GPP TS 38.212 v18.1.0, “NR; Multiplexing and Channel coding” [REF2]; 3GPP TS 38.213 v18.1.0, “NR; Physical Layer Procedures for Control” [REF3]; 3GPP TS 38.214 v18.1.0, “NR; Physical Layer Procedures for Data” [REF4]; 3GPP TS 38.321 v18.0.0, “NR; Medium Access Control (MAC) protocol specification” [REF5]; and 3GPP TS 38.331 v18.0.0, “NR; Radio Resource Control (RRC) Protocol Specification” [REF6].

To meet the demand for wireless data traffic having increased since deployment of 4G communication systems and to enable various vertical applications, 5G/NR communication systems have been developed and are being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation, radio access technology (RAT)-dependent positioning and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, embodiments of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of the present disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, longterm evolution (LTE), longterm evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the LUE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a beam indication for multiple entities in a wireless communication system. In certain embodiments, and one or more of the gNBs 101-103 includes circuitry, programing, or a combination thereof, for supporting a beam indication for multiple entities in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

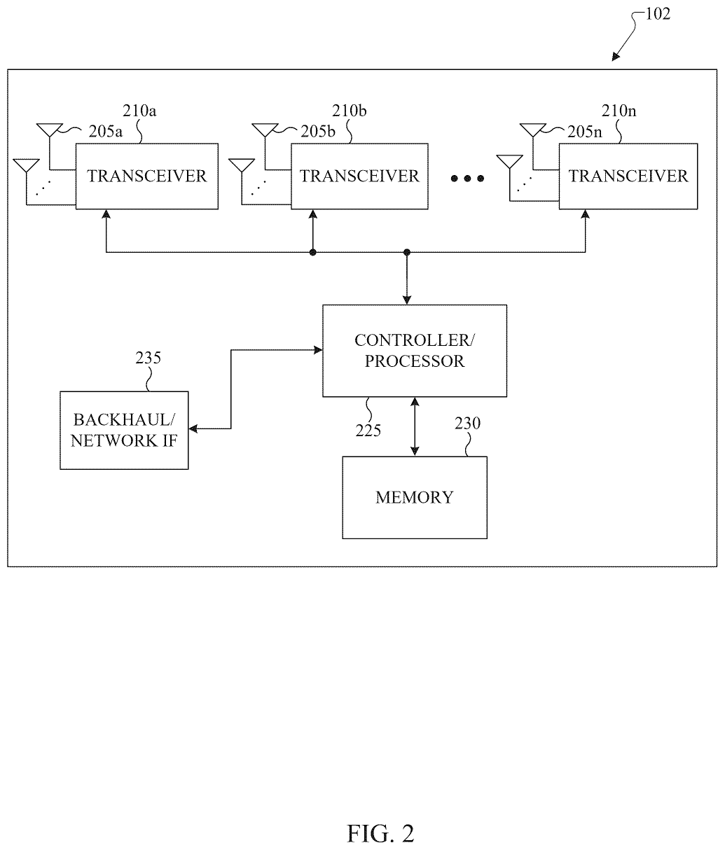

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channels or signals and the transmission of DL channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting a beam indication for multiple entities in a wireless communication system. The controller/processor 225 can move data into or out of the memory 230 as executed by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

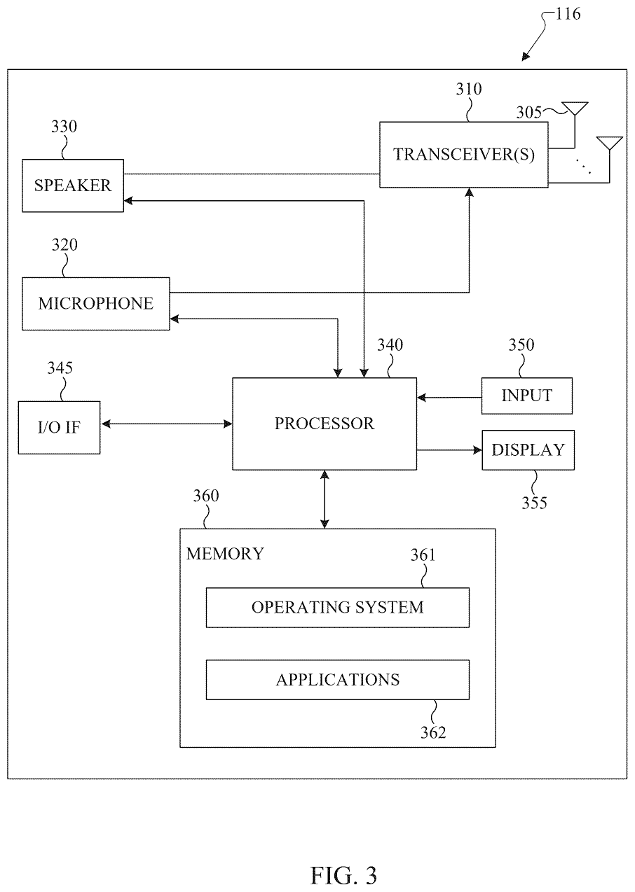

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-115) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals, the transmission of UL channels or signals, and reception and transmission of SL channels or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a beam indication for multiple entities in a wireless communication system.

The processor 340 can move data into or out of the memory 360 as provided by an executing process. In some embodiments, the processor 340 is configured to execute the applications 362 based on the OS 361 or in response to signals received from gNBs, another UE, or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

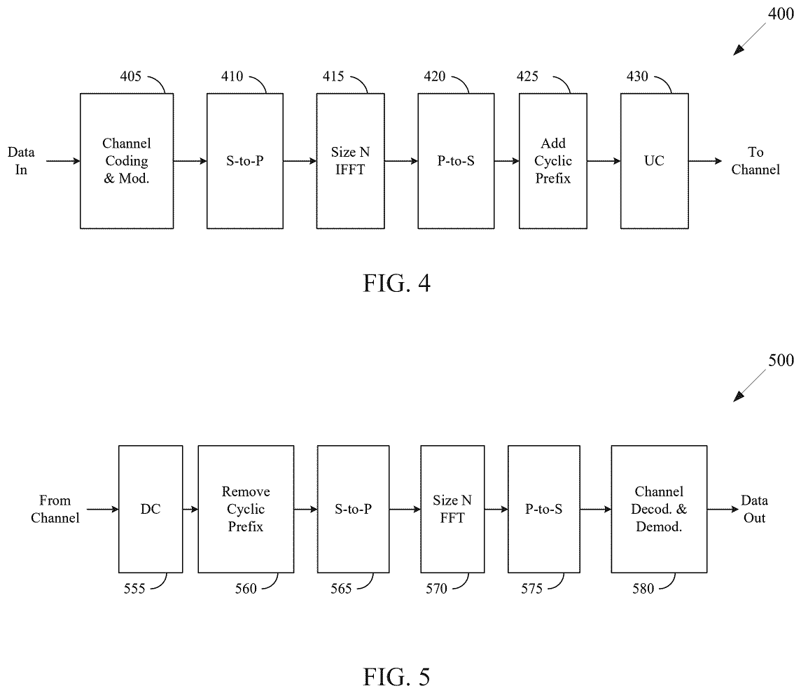

FIG. 4 and FIG. 5 illustrate example wireless transmit and receive paths according to the present disclosure. The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 or another UE arrives at the UE 116 after passing through the wireless channel, and reverse operations to those at the gNB 102 or another UE are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 or transmitting in the sidelink to another UE and may implement the receive path 500 for receiving in the downlink from the gNBs 101-103 or receiving in the sidelink from another UE. In some embodiments, the transmit path 400 and/or receive path 500 is configured to support a beam indication for multiple entities in a wireless communication system as described in embodiments of the present disclosure.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of the present disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

In NR, quasi-co-colocation (QCL) properties refers to large scale properties of signals. Two-signals that have a same QCL property are said to be quasi-co-located (QCLed) with respect to that QCL property. QCL properties can be frequency domain-related such Doppler spread or Doppler shift, time domain-related such as average delay or delay spread, or spatial domain-related, for example based on the spatial domain filter transmission filter (transmit beam) or spatial domain reception filter (receive beam). When using the QCL framework, a source reference signal (e.g., source RS) provides a QCL Type (one or more QCL properties) for a target signal or channel. This assists a receiver to receive the target signal or channel. For example, using the QCL framework, a PDSCH DMRS can be QCLed with source RS (e.g., CSI-RS) with respect to a set of QCL properties, the UE is indicated this QCL relation, which assists the UE to receive the PDSCH channel.

In NR, the TCI state framework provides linkage between source RS and QCL Type and is used for QCL information indication for a target RS to the UE. The source RS and QCL Type are included in the QCL information element (IE).

In the present disclosure, a beam can be determined by any of: (i) a TCI state, that establishes a quasi-colocation (QCL) relationship or spatial relation between a source reference signal (e.g., SSB and/or CSI-RS) and a target reference signal, and/or (ii) a spatial relation information that establishes an association to a source reference signal, such as SSB or CSI-RS or SRS.

Alternatively, a beam can be determined by any of: (i) a port with a static/fixed (e.g., for FR1) or dynamic virtualization (e.g., FR2, FR3), and/or a port group (PG) comprising multiple ports, with a dynamic indication/assignment of one (or two) ports from the multiple ports and associated QCL property=QCL TypeD or spatial relation.

In either case, the ID of the source reference signal or the one (or two) port(s) identifies the beam.

According to embodiments as disclosed in the present disclosure, the TCI state and/or the spatial relation reference RS can determine a spatial Rx filter or quasi-co-location information for reception of downlink channels at the UE, or a spatial Tx filter for transmission of uplink channels from the UE. The TCI state and/or the spatial relation reference RS can also determine a spatial Tx filter for transmission of downlink channels from the gNB, or a spatial Rx filter or quasi-co-location information for reception of uplink channels at the gNB.

Alternatively, for embodiments as disclosed in the present disclosure, the port with dynamic virtualization and/or the PG with dynamic indication of one (or two) ports can determine a spatial Rx filter or quasi-co-location information or port or PG for reception of downlink channels at the UE, or a spatial Tx filter or port or PG for transmission of uplink channels from the UE. The port with dynamic virtualization and/or the PG with dynamic indication of one (or two) ports can also determine a spatial Tx filter or a port or a PG for transmission of downlink channels from the gNB, or a spatial Rx filter or quasi-co-location information or a port or a PG for reception of uplink channels at the gNB.

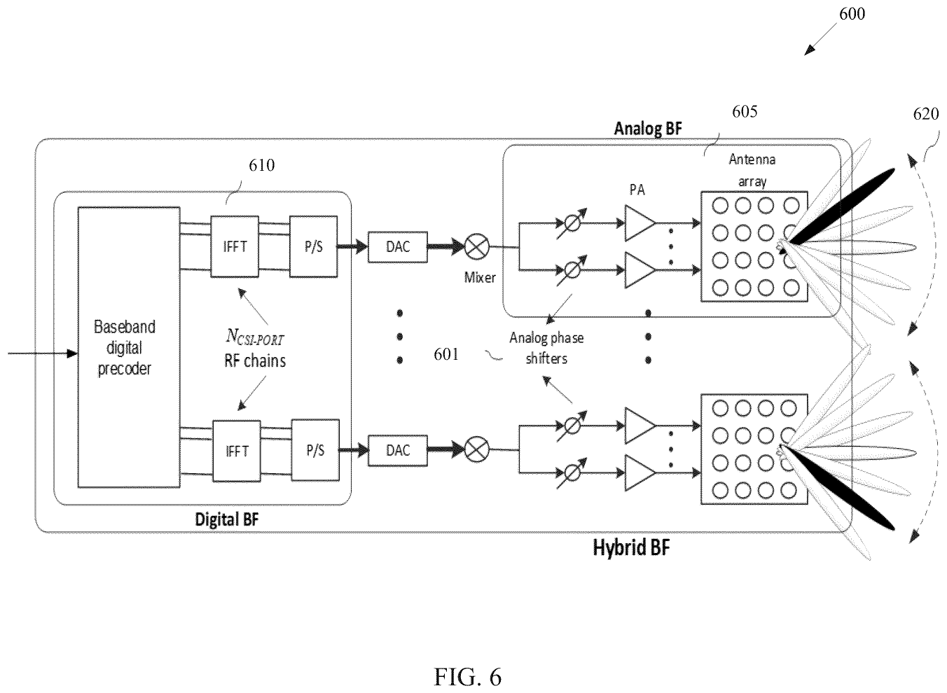

FIG. 6 illustrates an example antenna structure 600 according to embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL or SL TX beam (also termed “beam indication”), measuring at least one reference signal for calculating and performing beam reporting (also termed “beam measurement” and “beam reporting,” respectively), and receiving a DL or UL or SL transmission via a selection of a corresponding RX beam.

The aforementioned system is also applicable to higher frequency bands such as >52.6 GHz. In this case, the system can employ only analog beams. Due to the O2 absorption loss around 60 GHz frequency (˜10 dB additional loss @100 m distance), larger number of and sharper analog beams (hence larger number of radiators in the array) may be used to compensate for the additional path loss.

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6.

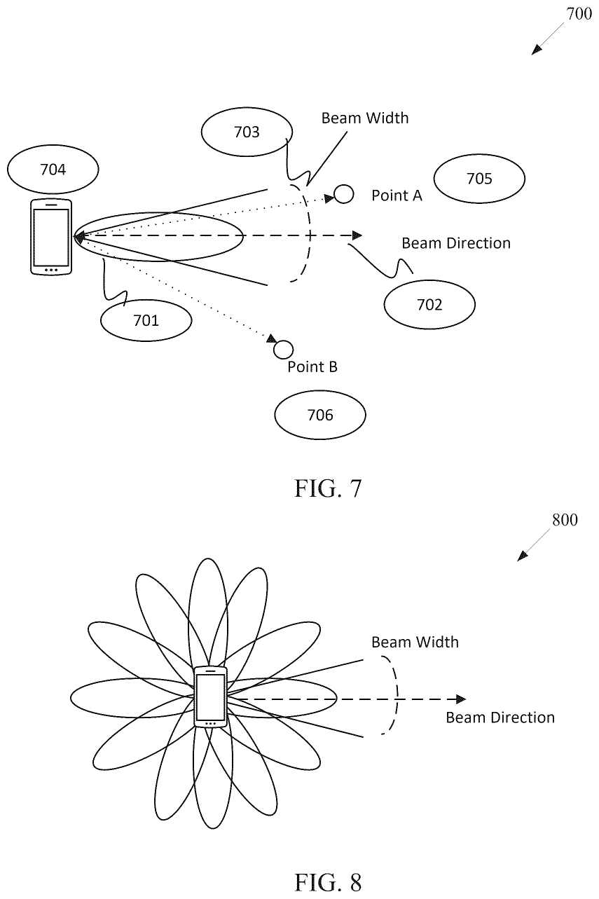

FIG. 7 illustrates an example of beam 700 in a wireless communication system according to embodiments of the present disclosure. An embodiment of the beam 700 shown in FIG. 7 is for illustration only.

As illustrated in FIG. 7, in a wireless system a beam (701), for a device (704), can be characterized by a beam direction (702) and a beam width (703). For example, a device (704) transmits radio frequency (RF) energy in a beam direction and within a beam width. A device (704) receives RF energy in a beam direction and within a beam width. As illustrated in FIG. 7, a device at point A (705) can receive from and transmit to device (704) as Point A is within a beam width and direction of a beam from device (704). As illustrated in FIG. 7, a device at point B (706) cannot receive from and transmit to device (704) as Point B is outside a beam width and direction of a beam from device (704). While FIG. 7, for illustrative purposes, shows a beam in 2-dimensions (2D), it should be apparent to those skilled in the art, that a beam can be in 3-dimensions (3D), where the beam direction and beam width are defined in space.

FIG. 8 illustrates an example of multi-beams 800 in a wireless communication system according to embodiments of the present disclosure. An embodiment of the multi-beams 800 shown in FIG. 8 is for illustration only.

In a wireless system, a device can transmit and/or receive on multiple beams. This is known as “multi-beam operation” and is illustrated in FIG. 8. While FIG. 8, for illustrative purposes, a beam is in 2D, it should be apparent to those skilled in the art, that a beam can be 3D, where a beam can be transmitted to or received from any direction in space.

Rel-17 introduced the unified TCI framework, where a unified or main or indicated TCI state is signaled to the UE. The unified or main or indicated TCI state can be one of: (i) in case of joint TCI state indication, wherein a same beam or port/PG is used for DL and UL channels, a joint TCI state that can be used at least for UE-dedicated DL channels and UE-dedicated UL channels; (ii) in case of separate TCI state indication, wherein different beams or ports/PGs are used for DL and UL channels, a DL TCI state that can be used at least for UE-dedicated DL channels; and/or (iii) in case of separate TCI state indication, wherein different beams or ports/PGs are used for DL and UL channels, a UL TCI state that can be used at least for UE-dedicated UL channels.

The unified (main or indicated) TCI state is TCI state of UE-dedicated reception on PDSCH/PDCCH or dynamic-grant/configured-grant based PUSCH and all of dedicated PUCCH resources.

The unified TCI framework also applies to intra-cell beam management, wherein the TCI states have a source RS that is directly or indirectly associated, through a quasi-co-location relation, e.g., spatial relation, with an SSB or port/PG of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB or port/PG of cell that has a physical cell identity (PCI) different from the PCI of the serving cell (e.g., the TCI state is associated with a TRP of a cell having a PCI different from the PCI of the serving cell).

Quasi-co-location (QCL) relation can be quasi-location with respect to one or more of the following relations (e.g., 3GPP standard specification, TS 38.214): (i) Type A, {Doppler shift, Doppler spread, average delay, delay spread}; (ii) Type B, {Doppler shift, Doppler spread}; (iii) Type C, {Doppler shift, average delay}; and (iv) Type D, {Spatial Rx parameter} or port/PG.

In addition, quasi-co-location relation and source reference signal or port/PG can also provide a spatial relation for UL channels, e.g., a DL source reference signal or ports/PGs provides information on the spatial domain filter or port/PG to be used for UL transmissions, or the UL source reference signal or ports/PGs provides the spatial domain filter to be used for UL transmissions, e.g., same spatial domain filter for UL source reference signal and UL transmissions.

The unified (main or indicated) TCI state applies at least to UE dedicated DL and UL channels. The unified (main or indicated) TCI can also apply to other DL and/or UL channels and/or signals e.g., non-UE dedicated channel and sounding reference signal (SRS).

A UE is indicated a TCI state by MAC CE when the CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2) or an UL related DCI format (e.g., format 0_1 or 0_2), or a purpose designed DCI format for beam (TCI state) indication, wherein the DCI format includes a “transmission configuration indication” field that includes/indicates a TCI state code point out of the TCI state code points activated by a MAC CE. A DL related DCI format (or an UL related DCI format or purpose designed DCI format for beam (TCI state) indication) can be used to indicate a TCI state when the UE is activated with more than one TCI state code points. The DL related DCI format can be with a DL assignment for PDSCH reception or without an DL assignment. Likewise, the UL related DCI format can be with a UL grant for PUSCH transmission or without an UL grant. A TCI state (TCI state code point) indicated/included in a DL related DCI format or UL related DCI format or purpose designed DCI format for beam (TCI state) indication is applied after a beam application time from the corresponding HARQ-ACK feedback.

In a wireless communication system, a UE can communicate to the network through multiple TRPs to enhance spectral efficiency and/or improve transmission diversity. Due to the nature of the wireless channel, each TRP can have its time profile (e.g., average delay and delay spread), frequency profile (e.g., Doppler shift and Doppler spread), and phase properties. Having different time/frequency/phase profiles or properties on different TRPs poses a challenge for coherent joint transmission schemes. To address this, a TRP is selected as a reference TRP, and the transmission on the other TRPs is pre-compensated with respect to time, frequency and/or phase. This impacts the UE operation when applying the TCI state of a TRP. In the present disclosure, features related to TCI state configuration and indication for multiple entities are provided.

For coherent joint transmission (CJT) across multiple TRPs, pre-compensation can be used for time (e.g., average delay or delay spread) and/or frequency (e.g., Doppler shift or Doppler spread) and/or phase properties. The UE can be indicated separate TCI states for each TRP. For example, if there are 4 TRPs in the system, each TRP can have its own TCI state, wherein a TCI state can indicate a source RS and corresponding QCL Type. For example, the source can be a tracking reference signal (TRS) or a NZP CSI-RS. The QCL Type can be QCL Type-A, which is for Doppler shift, Doppler spread, average delay, delay spread}. However, if some of the QCL properties are pre-compensated with respect to another TRP, this impacts how the QCL properties are indicated to the UE, and how to apply the QCL properties by the UE.

In the present disclosure, embodiments of signaling for the QCL properties for multiple entities are provided. In the present disclosure, embodiments related to configuration of TCI states for up to 4 TRPs are provided. In the present disclosure, embodiments related to activation of TCI state code points for up to 4 TRPs are provided. In the present disclosure, embodiments related to indication of TCI states/TCI state code points for up to 4 TRPs. In the present disclosure, the signaling of the QCL properties of the TCI state is provided when one or more QCL properties are pre-compensated including source reference signal for pre-compensated and non-compensated QCL properties.

The present disclosure relates to a NR/5G and/or 6G communication system.

The present disclosure provides embodiments related to beam indication for up to 4 TRPs with coherent joint transmission (CJT) including signaling of pre-compensated and non-compensated QCL properties: (i) signaling of TCI states for up to 4 TRPs, including grouping of reference signals for multiple TRPs within a TCI state or QCL information; (ii) signaling of source reference signal for pre-compensated or non-compensated QCL properties; and (iii) multiple reference TRPs for pre-compensation.

In the present disclosure, both frequency division duplexing (FDD) and time division duplexing (TDD) are considered as a duplex method for DL and UL signaling. In addition, full duplex (XDD) operation is possible, e.g., sub-band full duplex (SBFD) or single frequency full duplex (SFFD).

Although exemplary descriptions and embodiments to follow assume orthogonal frequency division multiplexing (OFDM) or orthogonal frequency division multiple access (OFDMA), the present disclosure can be extended to other OFDM-based transmission waveforms or multiple access schemes such as filtered OFDM (F-OFDM).

The present disclosure provides several components that can be used in conjunction or in combination with one another, or can operate as standalone schemes.

In the present disclosure, a RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In the present disclosure, a MAC CE signaling can be UE-specific e.g., to one UE or can be UE common (e.g., to a group of UEs or all UEs of a cell). MAC CE signaling can be DL MAC CE signaling or UL MAC CE signaling.

In the present disclosure, an L1 control signaling includes: (1) DL control information (e.g., DCI on PDCCH or DL control information on PDSCH) and/or (2) UL control information (e.g., UCI on PUCCH or PUSCH). L1 control signaling be UE-specific e.g., to one UE or can be UE common (e.g., to a group of UEs or to all UEs of a cell).

In this disclosure, configuration can refer to configuration by semi-static signaling (e.g., RRC or SIB signaling). In one example, a configuration can be applicable to multiple transmission instances, until a new configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In the present disclosure, a list with N elements can be denoted as L(i), where i can take N values, and L(i) can correspond to the element or entry associated with index i. In one example, i can take N arbitrary values. In one example, i=0, 1, . . . , N−1. In one example, i=1, 2, . . . , N. In one example, i is an identity of an element or entry in the list.

In the present disclosure, the term “activation” describes an operation wherein a UE receives and decodes first information provided by a first signal from the network (or gNB) and, based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and, based on the second information from the signal, the UE determines a stopping point in time. The stopping point can be a present or a future slot/subframe or symbol and the exact location is either implicitly or explicitly indicated, or is otherwise define in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group of RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

Terminology such as TCI, TCI states, SpatialRelationlnfo, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the necessary information to assign a particular DL (or/and UL) TX beam to the UE, for example in case of channel reciprocity.

In the present disclosure, a transmit receive point (TRP) can be a gNB or remote radio head (RRH) or a remote unit (RU), or an ORAN RU (O-RU), or a transmit point (TP), or a receive point (RP).

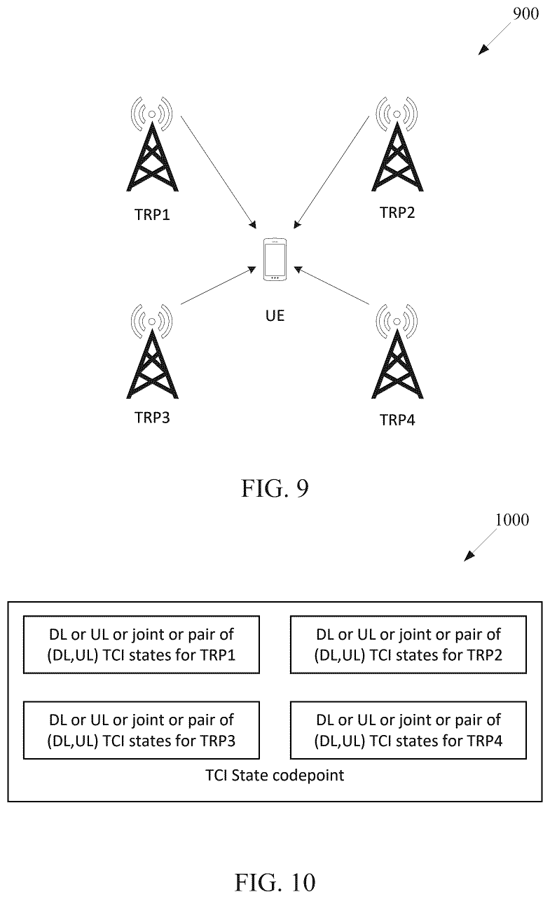

FIG. 9 illustrates an example of a UE communication with up to 4 TRPs 900 according to embodiments of the present disclosure. An embodiment of the UE communication with up to 4 TRPs 900 shown in FIG. 9 is for illustration only.

A UE can communicate with up to 4 TRPs are illustrated in FIG. 9.

In one example, reference signal RS1 is transmitted from TRP1. In one example, reference signal RS2 is transmitted from TRP2. In one example, reference signal RS3 is transmitted from TRP3. In one example, reference signal RS4 is transmitted from TRP4.

In one example, RS1 and/or RS2 and/or RS3 and/or RS4 can be a SS/PBCH block. In one example, RS1 and/or RS2 and/or RS3 and/or RS4 can be a periodic NZP CSI-RS. In one example, RS1 and/or RS2 and/or RS3 and/or RS4 can be a semi-persistent NZP CSI-RS. In one example, RS1 and/or RS2 and/or RS3 and/or RS4 can be an aperiodic NZP CSI-RS. In one example, RS1 and/or RS2 and/or RS3 and/or RS4 can be low-power synchronization signal (LP-SS).

In one example, a UE can be configured to receive a DL transmission (e.g., PDSCH) corresponding to a coherent joint transmission (CJT) hypothesis, i.e., a layer of the DL transmission is transmitted from multiple TRPs using a CJT precoder [p₁ p₂ . . . p_{N}_{ₜᵣₚ}]^{T} where pᵢ is associated with TRP i. In practice, the Nₜᵣₚ TRPs may perform a calibration/compensation operation for the delay or/and frequency or/and phase offsets between them, that are due to different propagation paths, frequency synchronization errors, and coupling losses (in case of TDD). The precoder after calibration can be given as [c₁p₁ c₂p₂ . . . C_{N}_{ₜᵣₚ}p_{N}_{ₜᵣₚ}]^{T} where cᵢ is calibration coefficient associated with TRP i.

In one example, a reference signal is configured for the UE to perform measurement for calibration. In one example, a reference signal is CSI-RS. In one example a CSI-RS resource (e.g., CSI-RS(n)) is configured for TRP(n), where n=1, 2, . . . , N, e.g., n is a TRP number within N TRPs (e.g., Nₜᵣₚ) used for coherent joint transmission. In the examples, of the present disclosure, without loss of generality N is taken as 4. However, other values of N can be used, whether less than 4 or greater than 4. In one example a CSI-RS resource set (e.g., CSI-RS set(n)) is configured for TRP(n), where n=1, 2, . . . , N, e.g., n is a TRP number within N TRPs used for coherent joint transmission.

In one example, a UE can be configured to transmit a sounding reference signal (SRS). In one example, a sounding reference signal SRS(n) is associated with TRP(n), where n=1, 2, . . . , N, e.g., n is a TRP number within N TRPs used for coherent joint transmission. In one example, an SRS is associated with more than one TRP, for example, SRS(i) can be associated with TRP(i1) and TRP(i2). In one example, an SRS is associated with all TRPs, for example, SRS can be associated with TRP(n), where n=1, 2, . . . , N, e.g., n is a TRP number within N TRPs used for coherent joint transmission.

In one example, SRS resource SRS(i) from a UE is associated with TRP(j), wherein TRP(j) uses SRS(i) to calculate a beam formed (BF) CSI-RS(i) transmission to the UE. The spatial filter of BF CSI-RS(i) is determined based on the SRS(i) resource. The UE uses the BF CSI-RS(j) for a measurement associated with CJT (for example, a measurement with report quantity set to cjtc-X), where X can be T for time domain measurement, or X can be F for frequency domain measurement or X can be P for phase-related measurement. In one example, the measurement is between a reference TRP (e.g., TRP(R)) transmitting BF CSI-RS(R) and TRP(j) transmitting BF CSI-RS(j) (measurement is between CSI-RS(R) and CSI-RS(j)).

In one example, the BF CSI-RS(j) transmitted with a spatial domain transmission filter at TRP(j) determined based on SRS(i) from a UE is configured with or indicated with, for CSI-RS(j), a quasi-co-location (QCL) information that includes: (1) SRS(i) as the QCL reference signal or source RS, and (2) QCL-Type D. In one example, the QCL information is induced in a TCI state, and the UE for CSI-RS(j) is configured with or indicated with the TCI state.

In one example, the BF CSI-RS(j) transmitted with a spatial domain transmission filter at TRP(j) determined based on SRS(i) from a UE is configured with or indicated with, for CSI-RS(j), a quasi-co-location (QCL) information that includes: (1) SRS(i) as the QCL reference signal or source RS, and (2) a QCL-Type that indicates determination of BF CSI-RS(j) spatial filter based on SRS(i), e.g., QCL-TypeR. In one example, the QCL information is induced in a TCI state, and the UE for CSI-RS(j) is configured with or indicated with the TCI state.

In one example, a QCL property can include phase related information. For example, a target reference signal can be configured or indicated to be quasi-co-located with a source reference signal with respect to phase related information. In one example, the target reference signal is a PDSCH DM-RS. In one example, the source reference signal is a CSI-RS configured for measurements (e.g., calibration measurement).

In one example, a QCL-Type (e.g., QCL-TypeE) includes at least QCL property associated with phase. In one example, QCL-TypeE can additionally include one or more of the following QCL properties or spatial relations: (i) frequency related QCL propert(ies), e.g., Doppler shift and/or Doppler spread; (ii) time related QCL propert(ies), e.g., average delay and/or delay spread; and (iii) spatial related information or QCL property.

In one example, the source RS of QCL-TypeE can be CSI-RS for measurement (e.g., calibration measurement), e.g., with a report quantity set to cjtc-X as disclosed in the present disclosure. Where X can be T for time domain measurement, or X can be F for frequency domain measurement or X can be P for phase-related measurement.

In one example, a QCL-Type (e.g., QCL-TypeF) includes only QCL property associated with phase.

In one example, the source RS of QCL-TypeF can be CSI-RS for measurement (e.g., calibration measurement), e.g., with a report quantity set to cjtc-X as disclosed in the present disclosure. Where X can be T for time domain measurement, or X can be F for frequency domain measurement or X can be P for phase-related measurement.

In the present disclosure, phase properties can refer to phase of carrier, or phase offset of carrier relative to a reference.

In one embodiment, an indication of TCI state for up 4 TRPs is provided.

In one example, a UE is configured with a first one or more lists of TCI states for TRP1, and a second one or more lists of TCI states for TRP2, and a third one or more lists of TCI states for TRP3, and a fourth one or more lists of TCI states for TRP4. Wherein each of the list of TCI states for TRPn (n=1 or 2 or 3 or 4) includes one or more of the following: (i) DL TCI states for TRPn; (ii) UL TCI states for TRPn; (iii) joint TCI states for TRPn; (iv) DL and joint TCI states for TRPn; (v) UL and joint TCI states for TRPn; (vi) DL and UL TCI states for TRPn; and (vii) DL, UL, and joint TCI states for TRPn.

In one example, a UE is configured with one or more lists of TCI states. A TCI state of the TCI states included in the list can be for TRP1 or TRP2 or TRP3 or TRP4. A list of TCI states includes one or more of the following: (i) DL TCI states for TRP1 or TRP2 or TRP3 or TRP4; (ii) UL TCI states for TRP1 or TRP2 or TRP3 or TRP4; (iii) joint TCI states for TRP1 or TRP2 or TRP3 or TRP4; (iv) DL and joint TCI states for TRP1 or TRP2 or TRP3 or TRP4; (v) UL and joint TCI states for TRP1 or TRP2 or TRP3 or TRP4; (vi) DL and UL TCI states for TRP1 or TRP2 or TRP3 or TRP4; and (vii) DL, UL, and joint TCI states for TRP1 or TRP2 or TRP3 or TRP4.

In one example a TCI state for TRPn (n=1 or 2 or 3 or 4) includes one or more quasi-co-location (QCL) information elements, wherein a QCL information element includes a reference signal associated with TRPn and a QCL Type (e.g., of TypeA or TypeB or TypeC or TypeD, or a new Type, e.g., TypeE or TypeF as disclosed in the present disclosure, for examples, the new type can be based on one or more of Doppler shift, Doppler spread, average delay, delay spread, phase properties and Spatial Rx parameter).

In one example, the QCL Type may depend on at least one of the following: (i) in one example, the QCL Type for one (i.e., reference) of the multiple TRPs (or multiple DL RSs such as NZP CSI-RSs as source RSs) is TypeX1 and the QCL Type for the rest of the multiple TRPs is TypeX2, where X1≠X2. The reference can be fixed (e.g., 1), or configured; (ii) in one example, the QCL Type is Type X, and all long-term channel properties associated with Type X applies for one of the multiple TRPs, and only a subset of all long-term channel (QCL) properties associated with Type X applies for the rest of the multiple TRPs. The reference can be fixed (e.g., 1), or configured; (iii) in one example, the QCL Type is Type X for all of the multiple TRPs; and (iv) in one example, the QCL Type is according to one of examples disclosed in the present disclosure when the TCI states are configured/indicated for the CJT calibration reporting (from the UE), and the QCL Type is according to one of examples disclosed in the present disclosure otherwise.

FIG. 10 illustrates an example of TCI state codepoint 1000 according to embodiments of the present disclosure. An embodiment of the TCI state codepoint 1000 shown in FIG. 10 is for illustration only.

In one example, a UE can be activated (e.g., by RRC signaling and/or MAC CE signaling and/or L1 control (DCI) signaling) a list of TCI state code points. Wherein a codepoint can include one or more of the following (as illustrated in FIG. 10): (i) a DL TCI state or UL TCI state or joint TCI state or a pair of UL and DL TCI states associated with TRP1; (ii) a DL TCI state or UL TCI state or joint TCI state or a pair of UL and DL TCI states associated with TRP2; (iii) a DL TCI state or UL TCI state or joint TCI state or a pair of UL and DL TCI states associated with TRP3; and (iv) a DL TCI state or UL TCI state or joint TCI state or a pair of UL and DL TCI states associated with TRP4.

In one example, a UE can be indicated by dynamic signaling (e.g., L1 control (DCI) and/or MAC CE) an indicated TCI state codepoint that includes a TCI state or a pair of TCI states for TRP1 and/or a TCI state or a pair of TCI states for TRP2 and/or a TCI state or a pair of TCI states for TRP3 and/or a TCI state or a pair of TCI states for TRP4.

FIG. 11 illustrates an example of TCI state codepoint from a second list 1100 according to embodiments of the present disclosure. An embodiment of the TCI state codepoint from a second list 1100 shown in FIG. 11 is for illustration only.

In one example, a UE can be activated (e.g., by RRC signaling and/or MAC CE signaling and/or L1 control (DCI) signaling a first list of TCI state code points and a second list of TCI state points. Wherein: (i) a codepoint in the first list of TCI state codepoints includes DL or UL or joint or a pair of (DL, UL) TCI states of TRPn1 and a codepoint in the second list of TCI state codepoints includes DL or UL or joint or a pair of (DL, UL) TCI states of TRPn2 and/or TRPn3 and/or TRPn4 as illustrated in FIG. 11. In one example, TRPn1 is a reference TRP (for example for pre-compensation as mentioned later in the present disclosure); (ii) a codepoint in the first list of TCI state codepoints includes DL or UL or joint or a pair of (DL, UL) TCI states of TRPn1 and/or TRPn2 and a codepoint in the second list of TCI state codepoints includes DL or UL or joint or a pair of (DL, UL) TCI states of TRPn3 and/or TRPn4; and (iii) n1, n2, n3 and n4 are distinct and from the set {1, 2, 3, 4}.

In one example, a UE can be indicated by dynamic signaling (e.g., L1 control (DCI) and/or MAC CE) a first indicated TCI state codepoint from the first list of TCI state codepoints and/or a second indicated TCI state codepoint from the second list of TCI state codepoints.

In one example, a UE can be activated (e.g., by RRC signaling and/or MAC CE signaling and/or L1 control (DCI) signaling) a first list of TCI state code points, a second list of TCI state points and a third list of TCI state codepoints. Wherein: (i) a codepoint in the first list of TCI state codepoints includes DL or UL or joint or a pair of (DL, UL) TCI states of TRPn1, a codepoint in the second list of TCI state codepoints includes DL or UL or joint or a pair of (DL, UL) TCI states of TRPn2 and a codepoint in the third list of TCI state codepoints includes DL or UL or joint or a pair of (DL, UL) TCI states of TRPn3 and/or TRPn4; and (ii) n1, n2, n3 and n4 are distinct and from the set {1, 2, 3, 4}.

In one example, a UE can be indicated by dynamic signaling (e.g., L1 control (DCI) and/or MAC CE) a first indicated TCI state codepoint from the first list of TCI state codepoints and/or a second indicated TCI state codepoint from the second list of TCI state codepoints and/or a third indicated TCI state codepoint from the third list of TCI state codepoints.

In one example, a UE can be activated (e.g., by RRC signaling and/or MAC CE signaling and/or L1 control (DCI) signaling a first list of TCI state code points, a second list of TCI state points, a third list of TCI state codepoints and a fourth list of TCI state codepoints. Wherein: (i) a codepoint in the first list of TCI state codepoints includes DL or UL or joint or a pair of (DL, UL) TCI states of TRP1, a codepoint in the second list of TCI state codepoints includes DL or UL or joint or a pair of (DL, UL) TCI states of TRP2, a codepoint in the third list of TCI state codepoints includes DL or UL or joint or a pair of (DL, UL) TCI states of TRP3 and a codepoint in the fourth list of TCI state codepoints includes DL or UL or joint or a pair of (DL, UL) TCI states of TRP4.

In one example, a UE can be indicated by dynamic signaling (e.g., L1 control (DCI) and/or MAC CE) a first indicated TCI state codepoint from the first list of TCI state codepoints and/or a second indicated TCI state codepoint from the second list of TCI state codepoints and/or a third indicated TCI state codepoint from the third list of TCI state codepoints and/or a fourth indicated TCI state codepoint from the fourth list of TCI state codepoints.

In one embodiment, an indication of TCI states for up to four TRPs with TRP grouping (1+3) is provided.

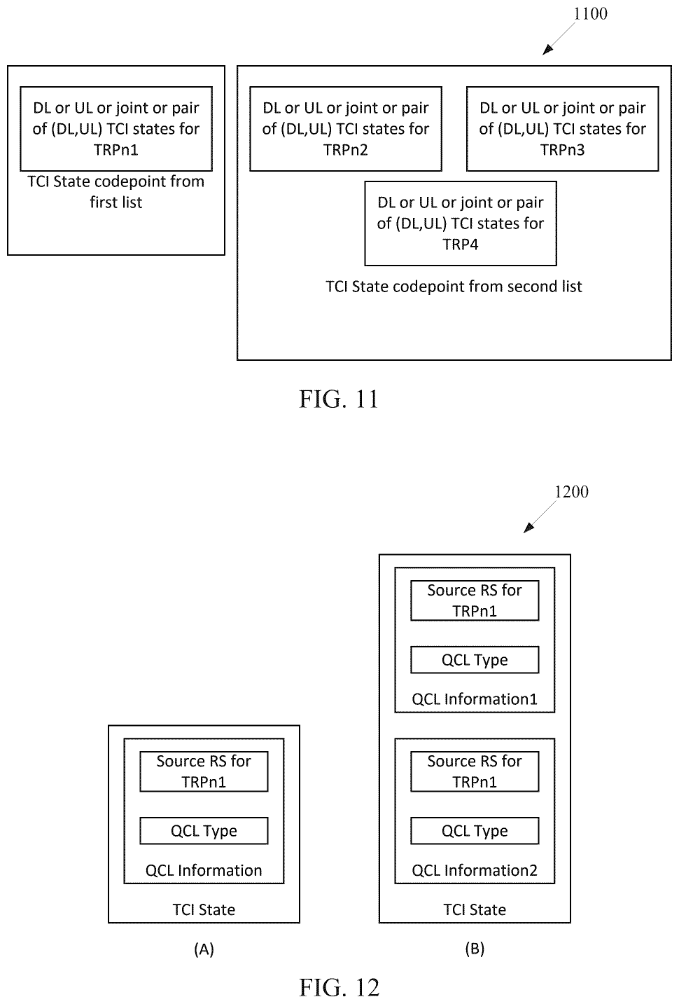

FIG. 12 illustrates an example of TCI state 1200 according to embodiments of the present disclosure. An embodiment of the TCI state 1200 shown in FIG. 12 is for illustration only.

In one example, a first TCI state is associated with TRPn1, and a second TCI state is associated with TRPn2 and TRPn3 and TRPn4. In one example, the first TCI state includes one QCL information, wherein the QCL information includes a source reference signal (e.g., associated with or transmitted by or received by TRPn1 or in an RS set associated with TRPn1) and a QCL type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter). This is illustrated in FIG. 12 (e.g., (A) in FIG. 12). In one example, the first TCI state includes two QCL information (a first QCL information and a second QCL information), wherein each QCL information includes a source reference signal (e.g., associated with or transmitted by or received by TRPn1) and a QCL type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter).

The first QCL information is associated with a first QCL type and the second QCL information is associated with a second QCL type. In one example, the first QCL Type and the second QCL type are different. In one example the source RS of the first QCL information and the RS of the second QCL information are the same. In one example, the source RS of the first QCL information and the source RS of the second QCL information can be different. This is illustrated in FIG. 12 (e.g., (B) in FIG. 12). In one example, the source RS of the first QCL information and the source RS of the second QCL information belong to a same RS set, e.g., the RS set associated with TRPn1. In one example, the first TCI state includes multiple (e.g., N) QCL information, wherein each QCL information includes a source reference signal (e.g., associated with or transmitted by or received by TRPn1) and a QCL type (as disclosed in the present disclosure). Each QCL information has a different QCL type. In one example, the source RS of each of the N QCL information belong to a same RS set, e.g., the RS set associated with TRPn1.

In one example, the second TCI state can include one or more source reference signals associated with up to Nₜᵣₚ−1 (e.g., three TRPs) (e.g., TRPn2 or TRPn3 or TRPn4) (e.g., associated with or transmitted by or received by the TRP), and corresponding QCL type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter). In one example, the QCL Type can apply to a source RS of a TRP. In one example, the QCL Type can apply to source RSes of multiple TRPs.

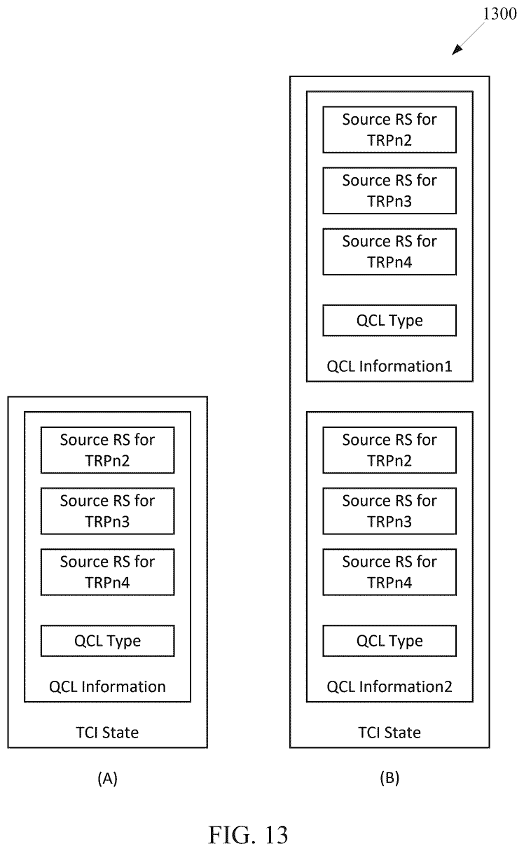

FIG. 13 illustrates another example of TCI state 1300 according to embodiments of the present disclosure. An embodiment of the TCI state 1300 shown in FIG. 13 is for illustration only.

In one example, the second TCI state includes one QCL information element, wherein the QCL information element includes: (i) a source reference signal associated with TRPn2 (e.g., associated with or transmitted by or received by TRPn2 or in an RS set associated with TRPn2), (ii) a source reference signal associated with TRPn3 (e.g., associated with or transmitted by or received by TRPn3 or in an RS set associated with TRPn3), (iii) a source reference signal associated with TRPn4 (e.g., associated with or transmitted by or received by TRPn4 or in an RS set associated with TRPn4), and/or (iv) a QCL type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter) common to the source reference signals in the QCL information. This is illustrated in FIG. 13 (e.g., (A) in FIG. 13). In one example, each source reference signal has it QCL type (as disclosed in the present disclosure).

In one example, the second TCI state includes two QCL information (a first QCL information and a second QCL information), wherein each QCL information includes: (i) a source reference signal (e.g., associated with or transmitted by or received by TRPn2 or in an RS set associated with TRPn2), (ii) a source reference signal (e.g., associated with or transmitted by or received by TRPn3 or in an RS set associated with TRPn3), (iii) a source reference signal (e.g., associated with or transmitted by or received by TRPn4 or in an RS set associated with TRPn4), and/or (iv) a QCL type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter). This is illustrated in FIG. 13 (e.g., (B) in FIG. 13). In one example, each source reference signal has it QCL type (as disclosed in the present disclosure).

The first QCL information is associated with a first QCL type(s) and the second QCL information is associated with a second QCL type(s). In one example, the first QCL Type and the second QCL type are different. In one example, the first QCL Type for a RS of a TRP and the second QCL type for a RS of the same TRP are different. In one example, the first QCL Type for an RS associated with a TRP and the second QCL type for an RS associated with the same TRP are different. In one example a source RS associated with a TRP of the first QCL information and a source RS associated with the same TRP of the second QCL information are the same. In one example, a source RS associated with a TRP of the first QCL information and a source RS associated with the same TRP of the second QCL information can be different.

In one example, the second TCI state includes multiple (e.g., N) QCL information, wherein each QCL information is as disclosed in the present disclosure. In one example, each QCL information has different QCL type. In one example, each QCL information has different QCL type for each TRP.

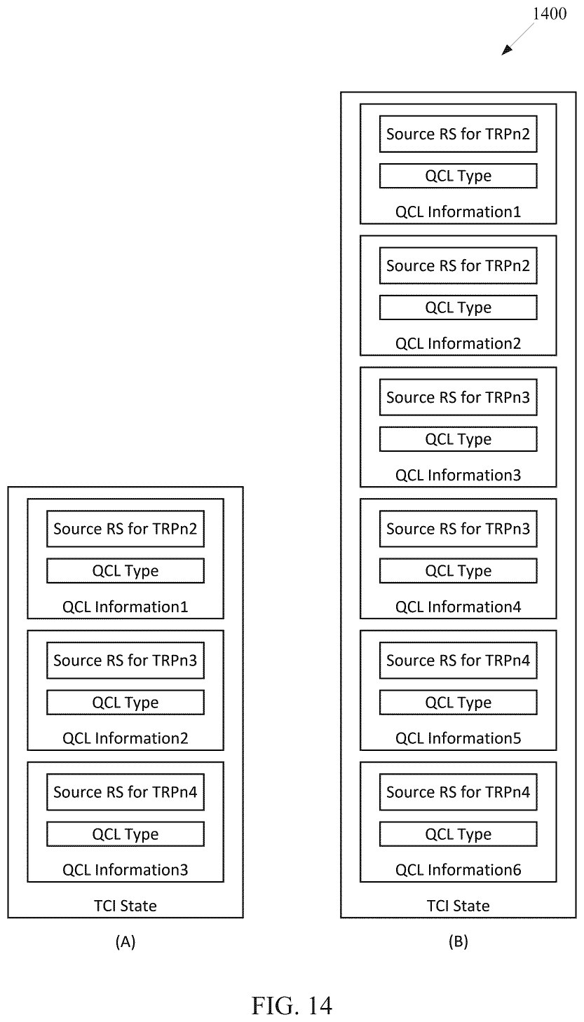

FIG. 14 illustrates yet another example of TCI state 1400 according to embodiments of the present disclosure. An embodiment of the TCI state 1400 shown in FIG. 14 is for illustration only.

In one example, the second TCI state includes: (i) one QCL information associated with TRPn2 (e.g., source RS of QCL information associated with or transmitted by or received by TRPn2 or in an RS set associated with TRPn2), (ii) one QCL information associated with TRPn3 (e.g., source RS of QCL information associated with or transmitted by or received by TRPn3 or in an RS set associated with TRPn3), and/or (iii) one QCL information associated with TRPn4 (e.g., source RS of QCL information associated with or transmitted by or received by TRPn4 or in an RS set associated with TRPn4).

Where each QCL information associated a TRP includes a source reference signal (e.g., associated with or transmitted by or received by the same TRP), and a corresponding QCL Type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter). This is illustrated in FIG. 14 (e.g., (A) in FIG. 14).

In one example, the second TCI state includes: (i) up to two QCL information elements associated with TRPn2 (e.g., source RS of QCL information associated with or transmitted by or received by TRPn2 or in an RS set associated with TRPn2), (ii) up to two QCL information elements associated with TRPn3 (e.g., source RS of QCL information associated with or transmitted by or received by TRPn3 or in an RS set associated with TRPn3), and/or (iii) up to two QCL information elements associated with TRPn4 (e.g., source RS of QCL information associated with or transmitted by or received by TRPn4 or in an RS set associated with TRPn4).

Where each QCL information associated a TRP includes a source reference signal (e.g., associated with or transmitted by or received by the same TRP), and a corresponding QCL Type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter). This is illustrated in FIG. 14 (e.g., (B) in FIG. 14).

The first QCL information associated with a TRP is associated with a first QCL type and the second QCL information associated with the same TRP is associated with a second QCL type. In one example, the first QCL Type and the second QCL type are different. In one example, for a same TRP, the source RS of the QCL information elements associated with the TRP are the same. In one example, for a same TRP, the source RS of the QCL information elements associated with the TRP can be different.

In one example, the second TCI state includes: (i) up to N QCL information elements associated with TRPn2 (e.g., source RS of QCL information associated with or transmitted by or received by TRPn2 or in an RS set associated with TRPn2), (ii) up to N QCL information elements associated with TRPn3 (e.g., source RS of QCL information associated with or transmitted by or received by TRPn3 or in an RS set associated with TRPn3), and/or (iii) up to N QCL information elements associated with TRPn4 (e.g., source RS of QCL information associated with or transmitted by or received by TRPn4 or in an RS set associated with TRPn4).

Where each QCL information associated a TRP includes a source reference signal (e.g., associated with or transmitted by or received by the same TRP), and a corresponding QCL Type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter).

In one example, for a same TRP, the QCL Types of the QCL information elements associated with the TRP are different. In one example, for a same TRP, the QCL Types of the QCL information elements associated with the TRP can be the same. In one example, for a same TRP, the source RS of the QCL information elements associated with the TRP are the same. In one example, for a same TRP, the source RS of the QCL information elements associated with the TRP can be different.

In one example, a UE is configured with a first one or more lists of first TCI states for TRPn1, and a second one or more lists of second TCI states for TRPn2 and/or TRPn3 and/or TRPn4. Wherein, the list of TCI states includes one or more of the following: (i) DL TCI states; (ii) UL TCI states; (iii) joint TCI states; (iv) DL and joint TCI states; (v) UL and joint TCI states; (vi) DL and UL TCI states; and/or (vii) DL, UL, and joint TCI states.

In one example, a UE is configured with one or more lists of TCI states. A TCI state of the TCI states included in the list can be a first TCI state for TRPn1 or a second TCI state for TRPn2 and/or TRPn3 and/or TRPn4. A list of TCI states includes one or more of the following: (i) DL TCI states for TRPn1 or (TRPn2 and/or TRPn3 and/or TRPn4); (ii) UL TCI states for TRPn1 or (TRPn2 and/or TRPn3 and/or TRPn4); (iii) joint TCI states for TRPn1 or (TRPn2 and/or TRPn3 and/or TRPn4); (iv) DL and joint TCI states for TRPn1 or (TRPn2 and/or TRPn3 and/or TRPn4); (v) UL and joint TCI states for TRPn1 or (TRPn2 and/or TRPn3 and/or TRPn4); (vi) DL and UL TCI states for TRPn1 or (TRPn2 and/or TRPn3 and/or TRPn4); and/or (vii) DL, UL and joint TCI states for TRPn1 or (TRPn2 and/or TRPn3 and/or TRPn4).

FIG. 15 illustrates an example of TCI state codepoint 1500 according to embodiments of the present disclosure. An embodiment of the TCI state codepoint from a second list 1500 shown in FIG. 15 is for illustration only.

In one example, a UE can be activated (e.g., by RRC signaling and/or MAC CE signaling and/or L1 control (DCI) signaling a list of TCI state code points. Wherein a codepoint can include one or more of the following (as illustrated in FIG. 15): (i) a DL TCI state or UL TCI state or joint TCI state or a pair of UL and DL TCI states associated with first TCI states for TRPn1; and (ii) a DL TCI state or UL TCI state or joint TCI state or a pair of UL and DL TCI states associated with second TCI state for TRPn2 and/or TRPn3 and/or TRPn4.

In one example, a UE can be indicated by dynamic signaling (e.g., L1 control (DCI) and/or MAC CE) an indicated TCI state codepoint that includes a first TCI state or a pair of first TCI states for TRPn1 and/or a second TCI state or a pair of second TCI states for TRPn2 and/or TRPn3 and/or TRPn4.

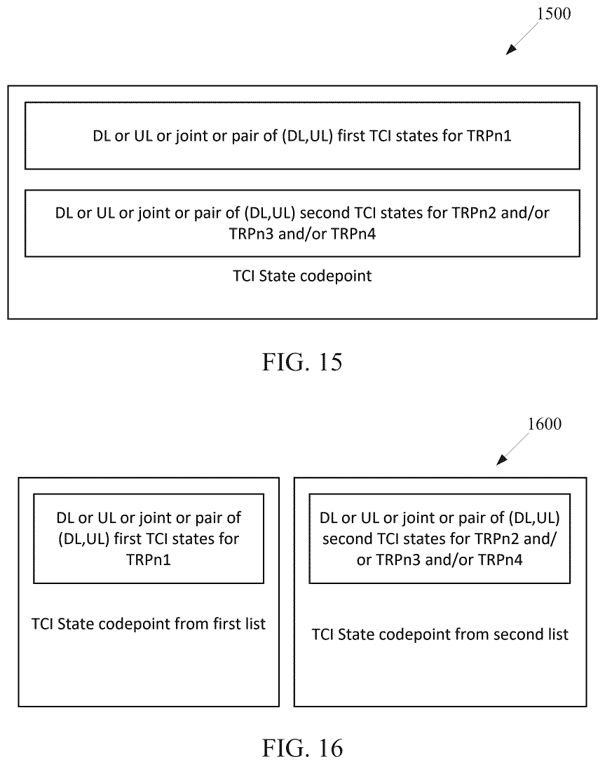

FIG. 16 illustrates an example of TCI state codepoint from a second list and a first list 1600 according to embodiments of the present disclosure. An embodiment of the TCI state codepoint from a second list and a first list 1600 shown in FIG. 16 is for illustration only.

In one example, a UE can be activated (e.g., by RRC signaling and/or MAC CE signaling and/or L1 control (DCI) signaling a first list of TCI state code points and a second list of TCI state points. Wherein (as illustrated in FIG. 16): a codepoint in the first list of TCI state codepoints includes DL or UL or joint or a pair of (DL, UL) first TCI states of TRPn1 and a codepoint in the second list of TCI state codepoints includes DL or UL or joint or a pair of (DL, UL) second TCI states of TRPn2 and/or TRPn3 and/or TRPn4.

In one example, a UE can be indicated by dynamic signaling (e.g., L1 control (DCI) and/or MAC CE) a first indicated TCI state codepoint from the first list of TCI state codepoints and/or a second indicated TCI state codepoint from the second list of TCI state codepoints.

In one embodiment, an indication of TCI states for up for 4 TRPs with TRP grouping (2+2) is provided.

In one example, a first TCI state is associated with TRPn1 and TRPn2, and a second TCI state is associated with TRPn3 and TRPn4.

In one example, the first or second TCI state can include one or more source reference signals associated with up to two TRPs (e.g., TRPn1 or TRPn2 for first TCI state or TRPn3 or TRPn4 for second TCI state, in the following the terms, TRPn1 or TRPn2 will be used, however this can also apply to TRPn3 or TRPn4) (e.g., associated with or transmitted by or received by the TRP), and corresponding QCL type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter). In one example, the QCL Type can apply to a source RS of a TRP. In one example, the QCL Type can apply to source RSes of multiple TRPs.

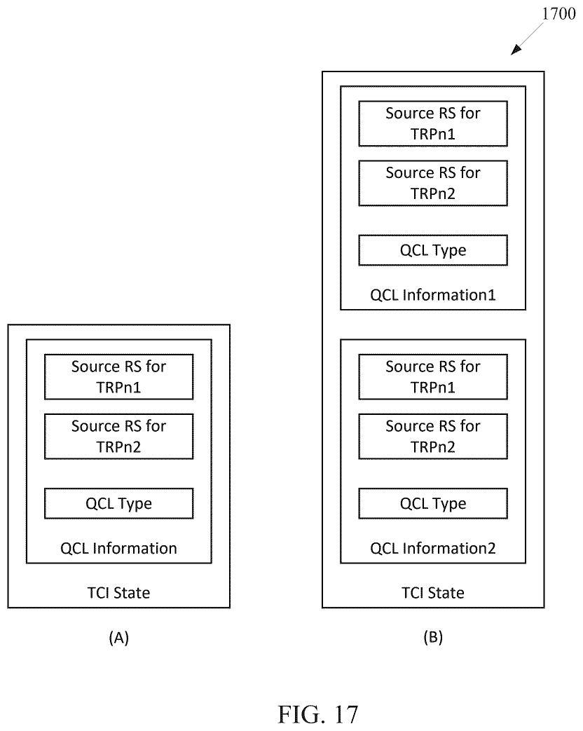

FIG. 17 illustrates yet another example of TCI state 1700 according to embodiments of the present disclosure. An embodiment of the TCI state 1700 shown in FIG. 17 is for illustration only.

In one example, the TCI state includes one QCL information element, wherein the QCL information includes: (i) a source reference signal associated with TRPn1 (e.g., associated with or transmitted by or received by TRPn1 or in an RS set associated with TRPn1), (ii) a source reference signal associated with TRPn2 (e.g., associated with or transmitted by or received by TRPn2 or in an RS set associated with TRPn2), and/or a QCL type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter) common to the source reference signals in the QCL information. This is illustrated in FIG. 17 (e.g., (A) in FIG. 17). In one example, each source reference signal has it QCL type (as disclosed in the present disclosure).

In one example, the TCI state includes two QCL information elements (a first QCL information element and a second QCL information element), wherein each QCL information element includes: (i) a source reference signal (e.g., associated with or transmitted by or received by TRPn1 or in an RS set associated with TRPn1), (ii) a source reference signal (e.g., associated with or transmitted by or received by TRPn2 or in an RS set associated with TRPn2), and/or a QCL type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter). This is illustrated in FIG. 17 (e.g., (B) in FIG. 17). In one example, each source reference signal has it QCL type (as disclosed in the present disclosure).

The first QCL information element is associated with a first QCL type(s) and the second QCL information is associated with a second QCL type(s). In one example, the first QCL Type and the second QCL type are different. In one example, the first QCL Type for a RS of a TRP and the second QCL type for a RS of the same TRP are different. In one example, the first QCL Type for an RS associated with a TRP and the second QCL type for an RS associated with the same TRP are different. In one example a source RS associated with a TRP of the first QCL information and a source RS associated with the same TRP of the second QCL information are the same. In one example, a source RS associated with a TRP of the first QCL information and a source RS associated with the same TRP of the second QCL information can be different.

In one example, the TCI state includes multiple (e.g., N) QCL information, wherein each QCL information is as disclosed in the present disclosure. In one example, each QCL information has different QCL type. In one example, each QCL information has different QCL type for each TRP.

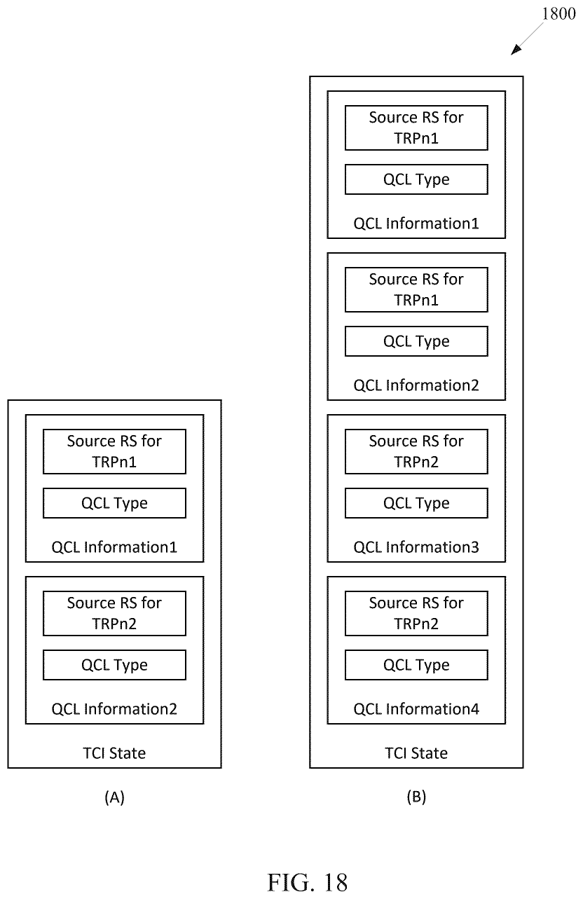

FIG. 18 illustrates yet another example of TCI state 1800 according to embodiments of the present disclosure. An embodiment of the TCI state 1800 shown in FIG. 18 is for illustration only.

In one example, the TCI state includes: (i) one QCL information element associated with TRPn1 (e.g., source RS of QCL information associated with or transmitted by or received by TRPn1 or in an RS set associated with TRPn1), and/or (ii) one QCL information element associated with TRPn2 (e.g., source RS of QCL information associated with or transmitted by or received by TRPn2 or in an RS set associated with TRPn2).

Where each QCL information associated a TRP includes a source reference signal (e.g., associated with or transmitted by or received by the same TRP or in an RS set associated with the same TRP), and a corresponding QCL Type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter). This is illustrated in FIG. 18 (e.g., (A) in FIG. 18).

In one example, the second TCI state includes: (i) up to two QCL information elements associated with TRPn1 (e.g., source RS of QCL information associated with or transmitted by or received by TRPn1 or in an RS set associated with TRPn1), and/or (ii) up to two QCL information elements associated with TRPn2 (e.g., source RS of QCL information associated with or transmitted by or received by TRPn2 or in an RS set associated with TRPn2).

Where each QCL information associated a TRP includes a source reference signal (e.g., associated with or transmitted by or received by the same TRP), and a corresponding QCL Type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter). This is illustrated in FIG. 18 (e.g., (B) in FIG. 18).

The first QCL information associated with a TRP is associated with a first QCL type and the second QCL information associated with the same TRP is associated with a second QCL type. In one example, the first QCL Type and the second QCL type are different. In one example, for a same TRP, the source RS of the QCL information elements associated with the TRP are the same. In one example, for a same TRP, the source RS of the QCL information elements associated with the TRP can be different.

In one example, the TCI state includes: (i) up to N QCL information elements associated with TRPn1 (e.g., source RS of QCL information associated with or transmitted by or received by TRPn1 or in an RS set associated with TRPn1), and/or (ii) up to N QCL information elements associated with TRPn2 (e.g., source RS of QCL information associated with or transmitted by or received by TRPn2 or in an RS set associated with TRPn2).

Where each QCL information associated a TRP includes a source reference signal (e.g., associated with or transmitted by or received by the same TRP or in an RS set associated with the same TRP), and a corresponding QCL Type (e.g., of TypeA or TypeB or TypeC or TypeD, a new Type, e.g., TypeE or TypeF as disclosed in the present disclosure, for examples, the new type can be based on one or more of Doppler shift, Doppler spread, average delay, delay spread, phase properties and Spatial Rx parameter).

In one example, for a same TRP, the QCL Types of the QCL information elements associated with the TRP are different. In one example, for a same TRP, the QCL Types of the QCL information elements associated with the TRP can be the same. In one example, for a same TRP, the source RS of the QCL information elements associated with the TRP are the same. In one example, for a same TRP, the source RS of the QCL information elements associated with the TRP can be different.

In one example, a UE is configured with a first one or more lists of first TCI states for TRPn1 and/or TRPn2, and a second one or more lists of second TCI states for TRPn3 and/or TRPn4. Wherein, the list of TCI states includes one or more of the following: (i) DL TCI states, (ii) UL TCI states, (iii) joint TCI states, (iv) DL and joint TCI states, (v) UL and joint TCI states, (vi) DL and UL TCI states, and/or (vii) DL, UL and joint TCI states.

In one example, a UE is configured with one or more lists of TCI states. A TCI state of the TCI states included in the list can a first TCI state for TRPn1 and/or TRPn2 or a second TCI state for TRPn3 and/or TRPn4. A list of TCI states includes one or more of the following: (i) DL TCI states for (TRPn1 and/or TRPn2) or (TRPn3 and/or TRPn4), (ii) UL TCI states for (TRPn1 and/or TRPn2) or (TRPn3 and/or TRPn4), (iii) joint TCI states for (TRPn1 and/or TRPn2) or (TRPn3 and/or TRPn4), (vi) DL and joint TCI states for (TRPn1 and/or TRPn2) or (TRPn3 and/or TRPn4), (v) UL and joint TCI states for (TRPn1 and/or TRPn2) or (TRPn3 and/or TRPn4), (vi) DL and UL TCI states for (TRPn1 and/or TRPn2) or (TRPn3 and/or TRPn4), and/or (vii) DL, UL, and joint TCI states for (TRPn1 and/or TRPn2) or (TRPn3 and/or TRPn4).

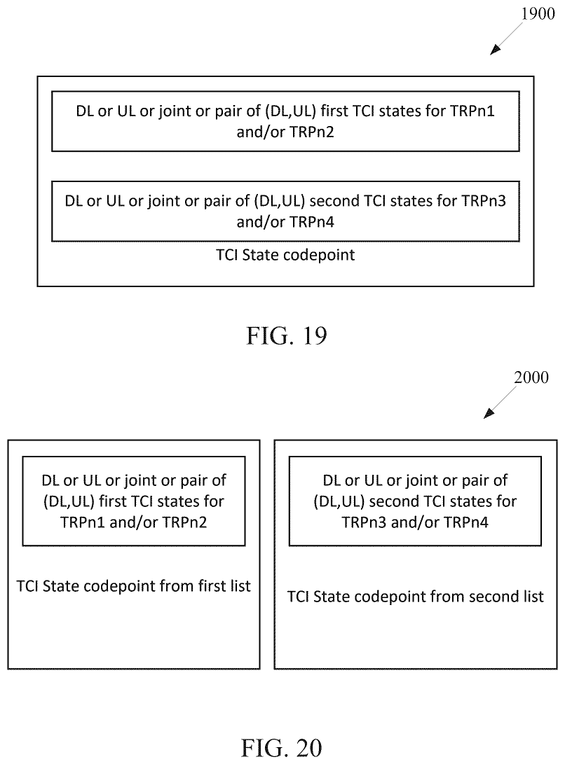

FIG. 19 illustrates yet another example of TCI state code point 1900 according to embodiments of the present disclosure. An embodiment of the TCI state code point 1900 shown in FIG. 19 is for illustration only.

In one example, a UE can be activated (e.g., by RRC signaling and/or MAC CE signaling and/or L1 control (DCI) signaling a list of TCI state code points. Wherein a codepoint can include one or more of the following (as illustrated in FIG. 19): (i) a DL TCI state or UL TCI state or joint TCI state or a pair of UL and DL TCI states associated with first TCI states for TRPn1 and/or TRPn2; and (ii) a DL TCI state or UL TCI state or joint TCI state or a pair of UL and DL TCI states associated with second TCI state for TRPn3 and/or TRPn4.

In one example, a UE can be indicated by dynamic signaling (e.g., L1 control (DCI) and/or MAC CE) an indicated TCI state codepoint that includes a first TCI state or a pair of first TCI states for TRPn1 and/or TRPn2 and/or a second TCI state or a pair of second TCI states for TRPn3 and/or TRPn4.

FIG. 20 illustrates another example of TCI state codepoint from a second list and a first list 2000 according to embodiments of the present disclosure. An embodiment of the TCI state codepoint from a second list and a first list 2000 shown in FIG. 20 is for illustration only.

In one example, a UE can be activated (e.g., by RRC signaling and/or MAC CE signaling and/or L1 control (DCI) signaling a first list of TCI state code points and a second list of TCI state points. Wherein (as illustrated in FIG. 20): a codepoint in the first list of TCI state codepoints includes DL or UL or joint or a pair of (DL, UL) first TCI states of TRPn1 and/or TRPn2 and a codepoint in the second list of TCI state codepoints includes DL or UL or joint or a pair of (DL, UL) second TCI states of TRPn3 and/or TRPn4.

In one example, a UE can be indicated by dynamic signaling (e.g., L1 control (DCI) and/or MAC CE) a first indicated TCI state codepoint from the first list of TCI state codepoints and/or a second indicated TCI state codepoint from the second list of TCI state codepoints.

In one embodiment, pre-compensated and non-compensated QCL properties are provide.

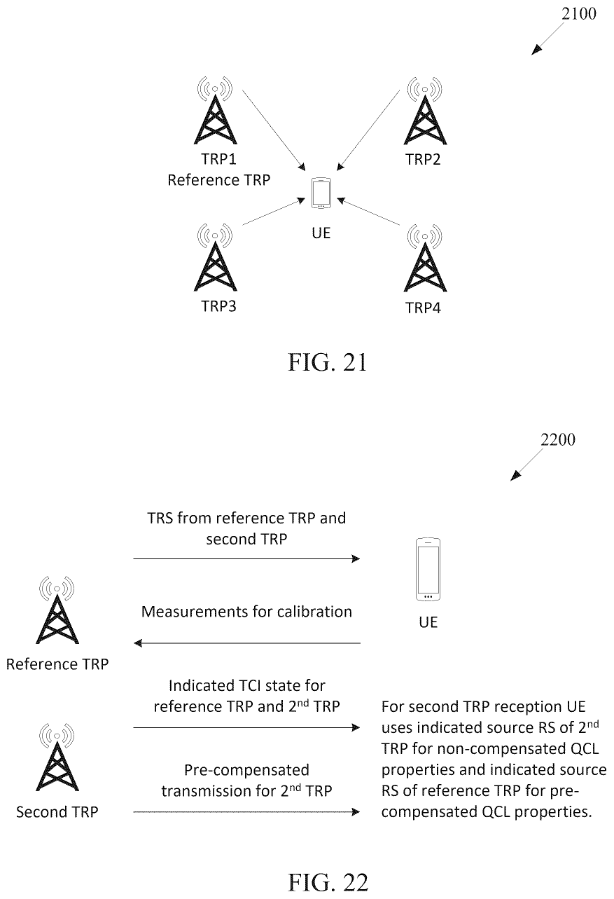

FIG. 21 illustrates an example of network configuration 2100 according to embodiments of the present disclosure. An embodiment of the network configuration 2100 shown in FIG. 21 is for illustration only.

In one example, a UE is configured to communicate with up four TRPs and one or more of the TRPs can be configured or activated or indicated as a reference TRP. For example, in FIG. 21, the TRP1 is configured as a reference TRP, the other TRPs can be pre-compensated relative to the reference TRP for some QCL parameters (e.g., associated with time and/or frequency and/or phase). The UE is further configured to receive a reference signal (RS) for each TRP, e.g., RS in RS set associated with TRP, wherein the reference signal can be tracking reference signal (TRS) or a non-zero power channel state information reference signal (NZP CSI-RS). In one example, the UE is configured to perform measurements on the reference signals, and report measurements. In one example, measurement and reporting is for calibration of mismatches, of QCL properties, between a reference TRP and the other TRPs, e.g. mismatches between RS belonging to different RS sets.

In one example, a UE can measure calibration coefficient between reference TRP (e.g., reference RS or reference RS set) and a second TRP (e.g., second RS or second RS set). In one example, the calibration coefficient can be related to time (e.g., related to time mismatch between a reference TRP and the second TRP) and/or frequency (e.g., related to frequency mismatch between a reference TRP and the second TRP) and/or phase (e.g., related to phase mismatch between a reference TRP and the second TRP). In one example, the calibration coefficient is related to a QCL parameter e.g., Doppler shift, Doppler spread, average delay, delay spread. The UE reports the calibration coefficient between the reference TRP (e.g., reference RS or reference RS set) and the second TRP (e.g., second RS or second RS set) to the network.

In one example, a UE can measure a coefficient for each TRP, a TRP can be replace by RS (e.g., associated with TRP) or RS set (e.g., associated with TRP). In one example, the coefficient can be related to time property and/or frequency property and/or phase property. In one example, the coefficient is related to a QCL parameter e.g., Doppler shift, Doppler spread, average delay, delay spread, phase properties. The UE reports the coefficient for a TRP to the network. The network can calculate a calibration coefficient between a reference TRP and a second TRP based on the reported coefficients and the selection of a reference TRP.

In one example, the CSI-RS used for measurement can have a TCI state or QCL information with a source RS as SRS, with a QCL-Type indicating spatial relation (e.g., spatial correspondence) between the CSI-RS and the SRS as disclosed in the present disclosure.

In one example, the PDSCH can be indicated or configured with one or more TCI states, wherein a TCI state can have CSI-RS for measurement (e.g., calibration measurement) as a source RS with QCL-TypeE or QCL-TypeF as disclosed in the present disclosure. The application of the source RS and QCL-Type to the TCI state is described later in this document.

In the example of FIG. 21, there can be two types of QCL properties: (i) QCL property1, where TRP1 (or a reference signal or TCI state from TRP1) is a reference for all TRPs. In one example, QCL property1 is phase related property, e.g., QCL-TypeF; and (ii) QCL property2, where each TRP (or a reference signal or TCI state from each TRP), is a reference for transmissions associated with that TRP. In one example, QCL property2 excludes phase related property (e.g., QCL-TypeE expect for phase).

For transmissions associated with TRP1 a reference signal associated with or transmitted from or received by TRP1 or RS in RS set associated with TRP is used for a TCI state to receive a transmission associated with TRP1. A TCI state can include QCL information with the reference signal and corresponding QCL Type.

For transmissions associated with TRP2 a first reference signal associated with or transmitted from or received by TRP1 or RS in RS set associated with TRP1 is used for QCL property1, while a second reference signal associated with or transmitted from or received by TRP2 or RS in RS set associated with TRP2 is used for the other QCL properties (e.g., QCL property 2) to receive a transmission associated with TRP2. The following examples, of a TCI state with first QCL properties associated to a first source reference signal and second QCL properties associated with second source reference signal can apply to this case. In one example, there can be more than one reference signal for each TRP with different QCL properties.

In one example, the PDSCH DM-RS port(s) are QCLed with first DL-RS(es) associated with the first TCI state (including first QCL information element(s)) with respect to QCL-TypeE and QCLed with second DL-RS(es) in the second TCI state (including second QCL information element(s)) with respect to QCL-TypeE, in one example except for phase property. In one example, first DL-RS(es) are source RS(es) of first QCL information element(s). In one example, second DL-RS(es) are source RS(es) of second QCL information element(s). In one example, first RS(es) can include CSI-RS used for measurement (e.g., calibration measurement). In one example, second RS(es) can include CSI-RS used for measurement (e.g., calibration measurement). In one example first DL-RS(es) are associated with a reference TRP or RS in RS set associated with reference TRP. In one example, second DL-RS(es) are associated with a non-reference TRP or RS in RS set associated with non-reference TRP.

In one example, the PDSCH DMRS port(s) are QCLed with first DL-RS(es) associated with the first TCI state (including first QCL information element(s)) with respect to QCL-TypeF (e.g., for QCL property related to phase). In one example, first DL-RS(es) are source RS(es) of first QCL information element(s). In one example, first RS(es) can include CSI-RS used for measurement (e.g., calibration measurement). In one example first DL-RS(es) are associated with a reference TRP.

In some examples as disclosed in the present disclosure, the network, can pre-compensate a transmission from the second TRP for a DL transmission. In one example, to a receive a pre-compensated transmission from the second TRP, the UE can apply the QCL parameters of the indicated TCI state of the second TRP (e.g., second TCI state) for the parameters or QCL properties that have not been pre-compensated by the network (e.g., source RS for QCL Types not pre-compensated are from TRP2 or non-reference TRP or RS in RS set associated with TRP2 or non-reference TRP), while the UE can apply the QCL parameters of the reference TRP for the parameters that have been pre-compensated by the network (e.g., source RS for QCL Types pre-compensated are from reference TRP or RS in RS set associated with reference TRP).

In some examples as disclosed in the present disclosure, a transmission from the reference TRP is not pre-compensated by the network. The UE can apply the QCL parameters or properties of the indicated TCI state of the reference TRP (e.g., first TCI state) to receive a transmission from the reference TRP.

FIG. 22 illustrates an example of signaling flow 2200 according to embodiments of the present disclosure. An embodiment of the signaling flow 2200 shown in FIG. 22 is for illustration only. The method 2200 as may be performed by a UE (e.g., 111-116 as illustrated in FIG. 1) and a base station (e.g., 101-103 as illustrated in FIG. 1). One or more of the components illustrated in FIG. 22 can be implemented in specialized circuitry configured to perform the noted functions or one or more of the components can be implemented by one or more processors executing instructions to perform the noted functions.

FIG. 22 illustrates an example disclosed in the present disclosure. In a first step, the reference TRP transmits a first reference signal (e.g., a first tracking reference signal (TRS) or a first non-zero power (NZP) channel state information reference signal (CSI-RS)). The second TRP transmits a second reference signal (e.g., a second TRS or a NZP CSI-RS). In one example, the CSI-RS of respective TRP is QCLed with an SRS transmitted from UE as described earlier in the present disclosure.

In a second step, the UE performs measurements for calibration as disclosed in the present disclosure and reports the measurements to the network.

In a third step, the UE is indicated a TCI state(s) for the reference TRP and for the second TRP. The configuration, activation and indication of the TCI state(s) can be as disclosed in the present disclosure. The TCI state(s) can include a source reference signal for the reference TRP or RS in RS set associated with reference TRP, in one example, the source reference signal for the reference TRP is the first reference signal (e.g., first TRS or first NZP CSI-RS e.g., from corresponding RS associated with reference TRP). The TCI state(s) can include a source reference signal for the second TRP, in one example, the source reference signal for the second TRP or RS in RS set associated with second TRP is the second reference signal (e.g., second TRS or second NZP CSI-RS e.g., from corresponding RS associated with second TRP). The TCI state(s) can include a QCL Type as described later in the present disclosure.

In a fourth step, the network pre-compensates a transmission for the second TRP based on the measurements from the UE and transmits the pre-compensated transmission from the second TRP. In one example, the pre-compensation is for a first set of QCL properties, for the remaining QCL properties (e.g., the remaining QCL properties are a second set of QCL properties) there is no pre-compensation. In one example, to receive a transmission from the second TRP, the UE applies the indicated TCI state of the reference TRP for the first set of QCL properties (e.g., that have been pre-compensated), and the UE applies the indicated TCI state of the second TRP for the second set of QCL properties (e.g., that have not been pre-compensated). In one example, to receive a transmission from the second TRP, UE applies (1) first QCL information(s) with first source RS(s) and first QCL Type(s), wherein first source RS(s) are associated with from RS set(s) associated with reference TRP and first QCL Type(s) can correspond to pre-compensated QCL properties, and (2) second QCL information(s) with second source RS(s) and second QCL Type(s), wherein second source RS(s) are associated with from RS set(s) associated with second TRP and second QCL Type(s) can correspond to non-pre-compensated QCL properties. In one example, first QCL information(s) and second QCL information(s) are in a TCI state associated with second TRP. In one example, to receive a transmission from the reference TRP, UE applies third QCL information(s) with source RS(s) and QCL Type(s), wherein source RS(s) are associated with from RS set(s) associated with reference TRP. In one example, third QCL information(s) are in a TCI associated with a reference TRP.

In one example, a new QCL-Type is defined, the QCL-Type is based on the QCL properties that are pre-compensated by the network. In one example, a new QCL-Type is defined, the QCL-Type is based on the QCL properties that are not pre-compensated by the network. A new QCL type can defined based on a row in TABLE 1, where an “x” indicates that the QCL property is considered in the QCL-Type. In one example, a new column is added to TABLE 1 for phase related QCL properties, accordingly new rows are added to TABLE 1 to cover the phase related QCL properties. The new QCL Type can be represented by a bitmap, with a bit representing each QCL property as: (Doppler shift, Doppler spread, average delay, delay spread, spatial parameter, phase shift). For example, a 6-bit bitmap can indicate whether the corresponding QCL property is included in the new QCL-Type or not. For example, a value of “1” for a bit can indicate that the QCL property corresponding to the bit is included in the new QCL-Type, while a value of “0” for a bit can indicate that the QCL property corresponding to the bit is not included in the new QCL-Type. The bitmap can be shorter than 6 if some of the QCL properties are not considered. TABLE 1 shows the each QCL properties.

TABLE 1
QCL properties

| Doppler | Doppler | Average | Delay | Spatial |
|---|---|---|---|---|
| Shift | spread | Delay | Spread | parameter |
| X | X | X | X | X |
| X | X | X | X | |
| X | X | X | | X |
| X | X | X | | |
| X | X | | X | X |
| X | X | | X | |
| X | X | | | X |
| X | X | | | |
| X | | X | X | X |
| X | | X | X | |
| X | | X | | X |
| X | | X | | |
| X | | | X | X |
| X | | | X | |
| X | | | | X |
| X | | | | |
| | X | X | X | X |
| | X | X | X | |
| | X | X | | X |
| | X | X | | |
| | X | | X | X |
| | X | | X | |
| | X | | | X |
| | X | | | |
| | | X | X | X |
| | | X | X | |
| | | X | | X |
| | | X | | |
| | | | X | X |
| | | | X | |
| | | | | X |

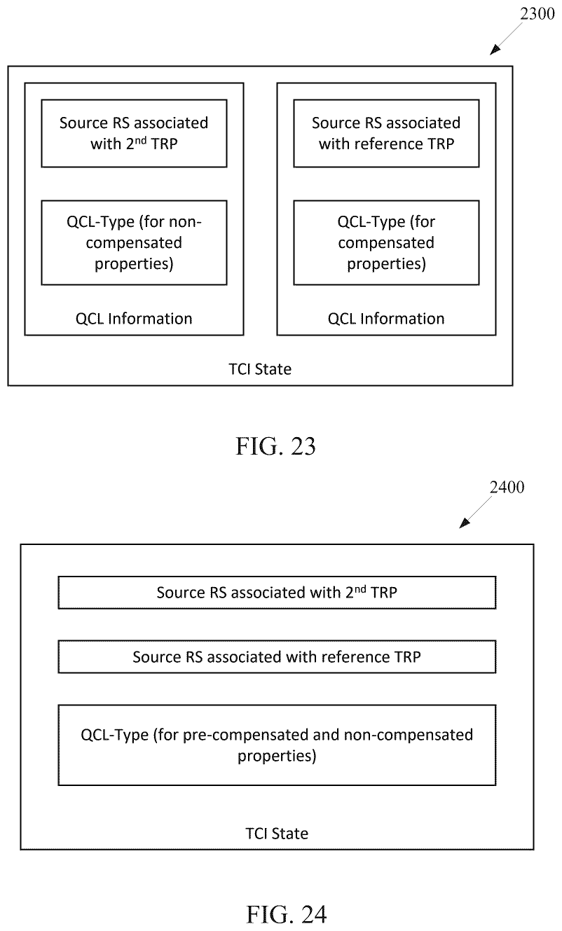

FIG. 23 illustrates yet another example of TCI state 2300 according to embodiments of the present disclosure. An embodiment of the TCI state 2300 shown in FIG. 23 is for illustration only.

In one example, for the second TRP (e.g., with some QCL properties pre-compensated), the UE is indicated TCI state(s) with (for example as illustrated in FIG. 23): (i) source RS (e.g., associated with (or transmitted by or received by) second TRP or RS in RS set associated with second TRP), and a corresponding QCL type, wherein the QCL type includes one or more QCL properties that are not pre-compensated for a transmission from the second TRP; and (ii) source RS (e.g., associated with (or transmitted by or received by) reference TRP or RS in RS set associated with reference TRP), and a corresponding QCL type, wherein the QCL type includes one or more QCL properties that are pre-compensated for a transmission from the second TRP, the compensation is with respect to the reference TRP.

In one example, as illustrated in FIG. 23, there is no QCL information, but the remaining parameters remain (e.g., without the QCL information grouping).

In one example as illustrated in FIG. 23, there is more than one QCL-Type and/or source RS associated with the second TRP for non-compensated QCL properties in the TCI state.

In one example as illustrated in FIG. 23, there is more than one QCL-Type and/or source RS associated with the reference TRP for compensated QCL properties in the TCI state.

In one example, for the second TRP (e.g., with some QCL properties pre-compensated), the UE is indicated TCI state(s) with a QCL Type(s) that includes non-compensated and pre-compensate QCL properties. The TCI state(s) include source RS for non-compensated QCL properties (e.g., associated with (or transmitted by or received by) second TRP or RS in RS set associated with second TRP). The TCI state(s) include source RS for compensated QCL properties (e.g., associated with (or transmitted by or received by) reference TRP or RS in RS set associated with reference TRP). In one example, for the reference TRP, the UE is indicated TCI state(s) with a QCL Type(s) that includes non-compensated and pre-compensate QCL properties, the TCI state(s) include source RS for non-compensated and pre-compensated QCL properties (e.g., associated with (or transmitted by or received by) reference TRP or RS in RS set associated with reference TRP).

FIG. 24 illustrates yet another example of TCI state 2400 according to embodiments of the present disclosure. An embodiment of the TCI state 2400 shown in FIG. 24 is for illustration only.

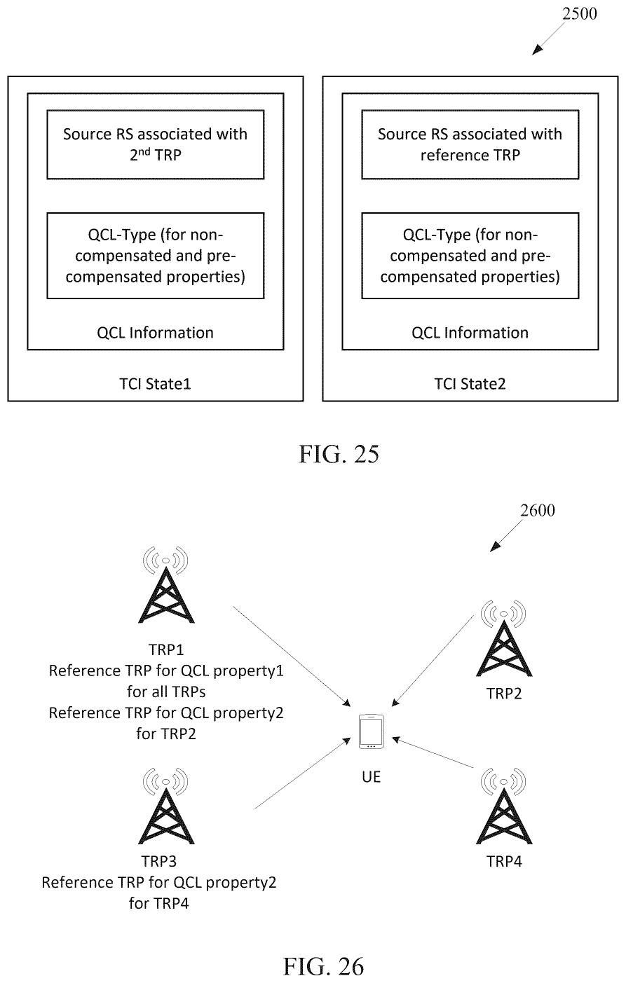

FIG. 25 illustrates an example of TCI state 1 and TCI state 2 2500 according to embodiments of the present disclosure. An embodiment of the TCI state 1 and TCI state 2 2500 shown in FIG. 25 is for illustration only.

As illustrated in FIG. 24, the source RS for non-compensated QCL properties and pre-compensated QCL properties can be in a same TCI state. As illustrated in FIG. 25, the source RS for non-compensated QCL properties and pre-compensated QCL properties can be in a separate TCI states, e.g., for second TRP. In one example of FIG. 25, TCI state 1 is associated with second TRP and TCI state 2 is associated with reference TRP. For reference TRP, a single TCI state can be used with a QCL Type(s) that includes non-compensated and pre-compensate QCL properties, and a source RS for non-compensated and pre-compensated QCL properties (e.g., associated with (or transmitted by or received by) reference TRP or RS in RS set associated with reference TRP).

In one example as illustrated in FIG. 24, source RS and QCL Type can be grouped (e.g., included) within an QCL information element.

In one example as illustrated in FIG. 24, additional source RS and/or corresponding QCL Types with non-compensated or pre-compensated QCL properties can be included in the TCI state.

In one example as illustrated in FIG. 25, there is no QCL information, but the remaining parameters remain (e.g., without the QCL information grouping).

In one example as illustrated in FIG. 25, additional source RS and/or corresponding QCL Types with non-compensated or pre-compensated QCL properties can be included in the TCI state.

In one example, for the second TRP (e.g., with some QCL properties pre-compensated), the UE is configured (e.g., by RRC signaling and/or MAC CE signaling) a set or list of QCL properties which are pre-compensated (or a set or list of QCL properties which are non-compensated). For the pre-compensated QCL properties, the UE follows the source RS associated with the pre-compensated QCL properties (associated with (or transmitted by or received by) reference TRP or RS in RS set associated with reference TRP) as illustrated in FIG. 24 and FIG. 25. For the non-compensated QCL properties, the UE follows the source RS associated with the non-compensated QCL properties (associated with (or transmitted by or received by) second TRP or RS in RS set associated with second TRP) as illustrated in FIG. 24 and FIG. 25.

In one example, for the second TRP (e.g., with some QCL properties pre-compensated), the UE is activated (e.g., by MAC CE signaling and/or RRC signaling and/or L1 control signaling) a set or list of QCL properties which are pre-compensated (or a set or list of QCL properties which are non-compensated). In one example, activation can be with TCI state codepoint activation. In one example, activation can be separate from TCI state codepoint activation. For the pre-compensated QCL properties, the UE follows the source RS associated with the pre-compensated QCL properties (associated with (or transmitted by or received by) reference TRP or RS in RS set associated with reference TRP) as illustrated in FIG. 24 and FIG. 25. For the non-compensated QCL properties, the UE follows the source RS associated with the non-compensated QCL properties (associated with (or transmitted by or received by) second TRP or RS in RS set associated with second TRP) as illustrated in FIG. 24 and FIG. 25.

In one example, for the second TRP (e.g., with some QCL properties pre-compensated), the UE is indicated (e.g., by L1 control signaling and/or MAC CE signaling) a set or list of QCL properties which are pre-compensated (or a set or list of QCL properties which are non-compensated). In one example, indication can be with TCI state codepoint indication. In one example, indication can be separate from TCI state codepoint indication. For the pre-compensated QCL properties, the UE follows the source RS associated with the pre-compensated QCL properties (associated with (or transmitted by or received by) reference TRP or RS in RS set associated with reference TRP) as illustrated in FIG. 24 and FIG. 25. For the non-compensated QCL properties, the UE follows the source RS associated with the non-compensated QCL properties (associated with (or transmitted by or received by) second TRP or RS in RS set associated with second TRP) as illustrated in FIG. 24 and FIG. 25.

In one example, for the second TRP (e.g., with some QCL properties pre-compensated), the UE is configured (e.g., by RRC signaling and/or MAC CE signaling) a reference TRP or source RS or RS set or TCI state to use for pre-compensated QCL properties.

In one example, for the second TRP (e.g., with some QCL properties pre-compensated), the UE is activated (e.g., by MAC CE signaling and/or RRC signaling and/or L1 control signaling) a reference TRP or source RS or RS set or TCI state to use for pre-compensated QCL properties. In one example, activation can be with TCI state codepoint activation. In one example, activation can be separate from TCI state codepoint activation.

In one example, for the second TRP (e.g., with some QCL properties pre-compensated), the UE is indicated (e.g., by L1 control signaling and/or MAC CE signaling) a reference TRP or source RS or RS set or TCI state to use for pre-compensated QCL properties. In one example, indication can be with TCI state codepoint indication. In one example, indication can be separate from TCI state codepoint indication.

In one example, for transmission from a second TRP, with pre-compensated QCL properties, the UE does not use the QCL properties of the source RS associated with (or transmitted by or received by) second TRP or RS in RS set associated with second TRP for the pre-compensated QCL properties as disclosed in the present disclosure. The pre-compensated QCL properties are said to be muted. In one example, for muted QCL properties, the UE uses a source RS of a reference TRP or RS in RS set associated with reference TRP, wherein the reference TRP and/or source RS and/or RS set and/or corresponding TCI state for the muted QCL properties can be configured and/or activated and/or indicated to the UE as disclosed in the present disclosure. The muted (and/or non-muted) QCL properties can be configured and/or activated and/or indicated to the UE as disclosed in the present disclosure.

FIG. 26 illustrates another example of network configuration 2600 according to embodiments of the present disclosure. An embodiment of the network configuration 2600 shown in FIG. 26 is for illustration only.

In one example, a UE is configured to communicate with up four TRPs and one or more of the TRPs can be configured or activated or indicated as a reference TRP or TRP(s) for first QCL properties (e.g., associated with time and/or frequency and/or phase). One or more of the TRPs can be configured or activated or indicated as a reference TRP or TRP(s) for second QCL properties (e.g., associated with time and/or frequency and/or phase). For example, in FIG. 26, the TRP1 is configured as a reference TRP, for first QCL parameters (e.g., frequency related parameters) for all TRPs. TRP1 is configured as a reference TRP for second QCL parameters (e.g., time related parameters) for TRP2 (in addition to TRP1). TRP3 is configured as a reference TRP for second QCL parameters (e.g., time related parameters) for TRP4 (in addition to TRP3).

The UE is further configured to receive a reference signal (RS) for each TRP or each set of RS, e.g., associated with a TRP, wherein the reference signal can be tracking reference signal (TRS) or a non-zero power channel state information reference signal (NZP CSI-RS). In one example, the UE is configured to perform measurements on the reference signals, and report measurements. In one example, measurement and reporting is for calibration of mismatches, e.g., for one or more QCL properties, between a reference TRP and the other TRPs.

In one example, a UE can measure a first calibration coefficient between first reference TRP and a third TRP. The first calibration coefficient is as disclosed in the present disclosure. The UE reports the first calibration coefficient between the first reference TRP and the third TRP to the network. A UE can measure a second calibration coefficient between second reference TRP and the third TRP.

The second calibration coefficient is as disclosed in the present disclosure. The UE reports the second calibration coefficient between the second reference TRP and the third TRP to the network. In the example of FIG. 26, the TRP1 is reference for first calibration coefficient and second calibration coefficient. For TRP2, the UE reports measurement of first calibration coefficient relative to TRP1 and measurement of second calibration coefficient relative to TRP1. TRP3 is a reference TRP for second calibration coefficient. For TRP 3, UE reports measurement of first calibration coefficient relative to TRP1. For TRP4, the UE reports measurement of first calibration coefficient relative to TRP1 and measurement of second calibration coefficient relative to TRP3.

In one example, a UE can measure a coefficient for each TRP. In one example, the coefficient can be related to time property and/or frequency property and/or phase property. In one example, the coefficient is related to a QCL parameter e.g., Doppler shift, Doppler spread, average delay, delay spread. The UE reports the coefficient for a TRP to the network. The network can calculate a calibration coefficient between a first reference TRP and a third TRP based on the reported first coefficient (form first TRP and third TRP) and the selection of a first reference TRP. The network can calculate a calibration coefficient between a second reference TRP and a third TRP based on the reported second coefficient (form second TRP and third TRP) and the selection of a second reference TRP.

As illustrated in FIG. 26, there can be three types of QCL properties: (i) QCL property1, where TRP1 (or a reference signal or TCI state from TRP1 or RS in RS set associated with TRP1) is a reference for all TRPs; (ii) QCL property2, where TRP1 (or a reference signal or TCI state from TRP1 or RS in RS set associated with TRP1) is a reference for transmissions associated with TRP1 and TRP2. TRP3 (or a reference signal or TCI state from TRP3 or RS in RS set associated with TRP3) is a reference for transmissions associated with TRP3 and TRP4; and (iii) QCL property3, where each TRP (or a reference signal or TCI state from each TRP or RS in RS set associated with each TRP), is a reference for transmissions associated with that TRP.

For transmissions associated with TRP1 a reference signal associated with or transmitted from or received by TRP1 or RS in RS set associated with TRP1 is used for a TCI state to receive a transmission associated with TRP1.

For transmissions associated with TRP2 a first reference signal associated with or transmitted from or received by TRP1 or RS in RS set associated with TRP1 is used for QCL property1 and QCL property2, while a second reference signal associated with or transmitted from or received by TRP2 or RS in RS set associated with TRP2 is used for the other QCL properties (e.g., QCL property 3) to receive a transmission associated with TRP2. In some examples, of a TCI state with first QCL properties associated to a first source reference signal and second QCL properties associated with second source reference signal can apply to this case.

For transmissions associated with TRP3 a first reference signal associated with or transmitted from or received by TRP1 or RS in RS set associated with TRP1 is used for QCL property1, while a second reference signal associated with or transmitted from or received by TRP3 or RS in RS set associated with TRP3 is used for the other QCL properties (e.g., QCL property2 and QCL property3) to receive a transmission associated with TRP3. In some examples, of a TCI state with first QCL properties associated to a first source reference signal and second QCL properties associated with second source reference signal can apply to this case.

For transmissions associated with TRP4 a first reference signal associated with or transmitted from or received by TRP1 or RS in RS set associated with TRP1 is used for QCL property1, while a second reference signal associated with or transmitted from or received by TRP3 or RS in RS set associated with TRP3 is used for QCL property2, while a third reference signal associated with or transmitted from or received by TRP4 or RS in RS set associated with TRP4 is used for other QCL properties (e.g., QCL property3) to receive a transmission associated with TRP4. The following examples, of a TCI state with first QCL properties associated to a first source reference signal, second QCL properties associated with second source reference signal, and third QCL properties associated with third source reference signal can apply to this case.

In some examples as disclosed in the present disclosure, the network, can pre-compensate a transmission from a third TRP for a DL transmission, wherein the pre-compensation is based on a first reference TRP for first QCL properties and a second reference TRP for second QCL properties. In one example, to a receive a pre-compensated transmission from the third TRP, the UE can apply the QCL parameters or properties of the indicated TCI state of the third TRP for the parameters or QCL properties that have not been pre-compensated by the network, while the UE can apply the QCL parameters (or properties) of the first reference TRP for the first QCL parameters (or properties) that have been pre-compensated by the network based on first reference TRP, and the UE can apply the QCL parameters (or properties) of the second reference TRP for the second QCL parameters (or properties) that have been pre-compensated by the network based on second reference TRP.

In some examples as disclosed in the present disclosure, a transmission from a reference TRP is not pre-compensated by the network for the corresponding QCL properties. The UE can apply the corresponding QCL parameters or properties of the indicated TCI state of the reference TRP to receive a transmission from the reference TRP.

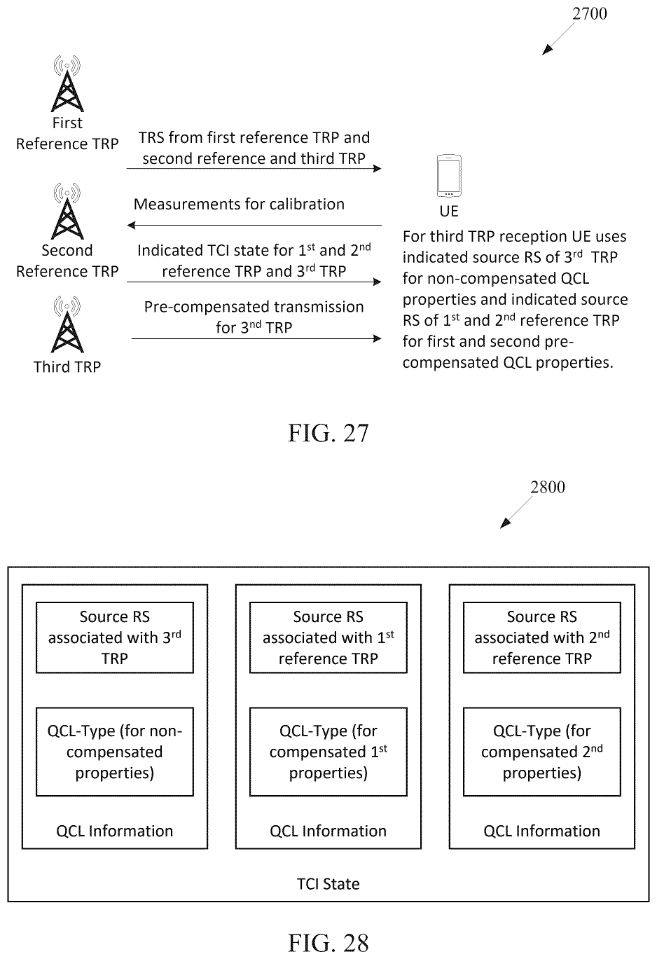

FIG. 27 illustrates another example of signaling flow 2700 according to embodiments of the present disclosure. An embodiment of the signaling flow 2700 shown in FIG. 27 is for illustration only. The signaling flow 2700 as may be performed by a UE (e.g., 111-116 as illustrated in FIG. 1) and a base station (e.g., 101-103 as illustrated in FIG. 1). One or more of the components illustrated in FIG. 27 can be implemented in specialized circuitry configured to perform the noted functions or one or more of the components can be implemented by one or more processors executing instructions to perform the noted functions.

As illustrated in FIG. 27, in a first step, the first and second reference TRPs transmit a first and a second reference signal (e.g., a first and a second TRS or a first and a second NZP CSI-RS) respectively. The third TRP transmits a third reference signal (e.g., a third TRS or a NZP CSI-RS).

In a second step, the UE performs measurements for calibration as disclosed in the present disclosure and reports the measurements to the network.

In a third step, the UE is indicated a TCI state(s) for the first reference TRP and the second reference TRP and for the third TRP. The configuration, activation and indication of the TCI state(s) can be as disclosed in the present disclosure. The TCI state(s) can include a source reference signal for the first reference TRP, in one example, the source reference signal for the first reference TRP is the first reference signal (e.g., first TRS or first NZP CSI-RS) or RS in RS set associated with first reference TRP. The TCI state(s) can include a source reference signal for the second reference TRP, in one example, the source reference signal for the second reference TRP is the second reference signal (e.g., second TRS or second NZP CSI-RS) or RS in RS set associated with second reference TRP. The TCI state(s) can include a source reference signal for the third TRP, in one example, the source reference signal for the third TRP is the third reference signal (e.g., third TRS or third NZP CSI-RS) or RS in RS set associated with third TRP. The TCI state(s) can include a QCL Type as described later in the present disclosure.

In a fourth step, the network pre-compensates a transmission for the third TRP based on the measurements from the UE and transmits the pre-compensated transmission from the third TRP. In one example, the pre-compensation is for a first set of QCL properties and for a second set of QCL properties, for the remaining QCL properties (e.g., the remaining QCL properties are a third set of QCL properties) there is no pre-compensation. In one example, to receive a transmission from the third TRP, the UE applies the indicated TCI state of the first reference TRP for the first set of QCL properties (e.g., that have been pre-compensated based on a first reference TRP), and the UE applies the indicated TCI state of the second reference TRP for the second set of QCL properties (e.g., that have been pre-compensated based on a second reference TRP), and the UE applies the indicated TCI state of the third TRP for the third set of QCL properties (e.g., that have not been pre-compensated).

In one example, a new QCL-Type is defined, the QCL-Type is based on the QCL properties that are pre-compensated by the network based on a first reference TRP. In one example, a new QCL-Type is defined, the QCL-Type is based on the QCL properties that are pre-compensated by the network based on a second reference TRP. In one example, a new QCL-Type is defined, the QCL-Type is based on the QCL properties that are not pre-compensated by the network. A new QCL type can defined based on a row in TABLE 1, where an “x” indicates that the QCL property is considered in the QCL-Type. In a variant example, a new column is added to TABLE 1 for phase related QCL properties, accordingly new rows are added to TABLE 1 to cover the phase related QCL properties.

FIG. 28 illustrates yet another example of TCI state 2800 according to embodiments of the present disclosure. An embodiment of the TCI state 2800 shown in FIG. 28 is for illustration only.

In one example, for the third TRP (e.g., with some QCL properties pre-compensated based on a first reference TRP and a second reference TRP), the UE is indicated TCI state(s) with (for example as illustrated in FIG. 28): (i) source RS (e.g., associated with (or transmitted by or received by) third TRP or RS in RS set associated with third TRP), and a corresponding QCL type, wherein the QCL type includes one or more QCL properties that are not pre-compensated for a transmission from the third TRP; (ii) source RS (e.g., associated with (or transmitted by or received by) first reference TRP or RS in RS set associated with first reference TRP), and a corresponding QCL type, wherein the QCL type includes one or more QCL properties that are pre-compensated for a transmission from the third TRP, the compensation is with respect to the first reference TRP; and (iii) source RS (e.g., associated with (or transmitted by or received by) second reference TRP or RS in RS set associated with second reference TRP), and a corresponding QCL type, wherein the QCL type includes one or more QCL properties that are pre-compensated for a transmission from the third TRP, the compensation is with respect to the second reference TRP.

In one example as illustrated in FIG. 28, there is no QCL information, but the remaining parameters remain (e.g., without the QCL information grouping).

In one example as illustrated in FIG. 28, there is more than one QCL-Type and/or source RS associated with the third TRP for non-compensated QCL properties in the TCI state.

In one example as illustrated in FIG. 28, there is more than one QCL-Type and/or source RS associated with the first or second reference TRPs for compensated first or second QCL properties in the TCI state respectively.

In one example, for the third TRP (e.g., with some QCL properties pre-compensated), the UE is indicated TCI state(s) with a QCL Type that includes non-compensated and pre-compensate QCL properties. The TCI state(s) include source RS for non-compensated QCL properties (e.g., associated with (or transmitted by or received by) third TRP or RS in RS set associated with third TRP). The TCI state(s) include source RS for first compensated QCL properties (e.g., associated with (or transmitted by or received by) first reference TRP or RS in RS set associated with first reference TRP). The TCI state(s) include source RS for second compensated QCL properties (e.g., associated with (or transmitted by or received by) second reference TRP or RS in RS set associated with second reference TRP).

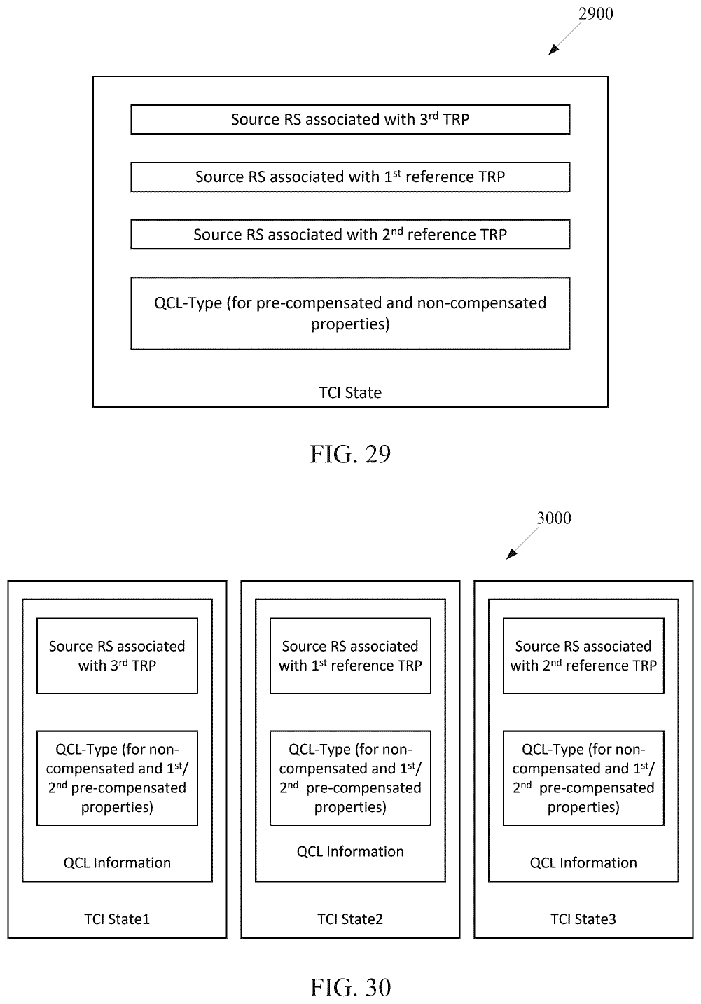

FIG. 29 illustrates yet another example of TCI state 2900 according to embodiments of the present disclosure. An embodiment of the TCI state 2900 shown in FIG. 29 is for illustration only.

FIG. 30 illustrates an example of TCI state 1, TCI state 2, and TCI state 3 3000 according to embodiments of the present disclosure. An embodiment of the TCI state 1, TCI state 2, and TCI state 3 3000 shown in FIG. 30 is for illustration only.

As illustrated in FIG. 29, the source RS for non-compensated QCL properties and pre-compensated QCL properties can be in a same TCI state. As illustrated in FIG. 29, the source RS for non-compensated QCL properties and pre-compensated QCL properties can be in a separate TCI states. In one example of FIG. 30, TCI state 1 is associated with third TRP and TCI state 2 is associated with first reference TRP and TCI state 3 is associated with second reference TRP.

In one example as illustrated in FIG. 29, source RS and QCL Type can be grouped (e.g., included) within an QCL information element.

In one example as illustrated in FIG. 29, additional source RS and/or corresponding QCL Types with non-compensated or first pre-compensated QCL properties or second pre-compensated QCL properties can be included in the TCI state.

In one example as illustrated in FIG. 30, there is no QCL information, but the remaining parameters remain (e.g., without the QCL information grouping).

In one example as illustrated in FIG. 30, additional source RS and/or corresponding QCL Types with non-compensated or pre-compensated QCL properties can be included in the TCI state.

In one example, for the third TRP (e.g., with some QCL properties pre-compensated), the UE is configured (e.g., by RRC signaling and/or MAC CE signaling) a set or list of first QCL properties which are pre-compensated based on first reference TRP, a set or list of second QCL properties which are pre-compensated based on second reference TRP (and possibly a set or list of QCL properties which are non-compensated). For the first pre-compensated QCL properties, the UE follows the source RS associated with the first pre-compensated QCL properties (associated with (or transmitted by or received by) first reference TRP or RS in RS set associated with first reference TRP) as illustrated in FIG. 29 and FIG. 30. For the second pre-compensated QCL properties, the UE follows the source RS associated with the second pre-compensated QCL properties (associated with (or transmitted by or received by) second reference TRP or RS in RS set associated with second reference TRP) as illustrated in FIG. 29 and FIG. 30. For the non-compensated QCL properties, the UE follows the source RS associated with the non-compensated QCL properties (associated with (or transmitted by or received by) third TRP or RS in RS set associated with third TRP) as illustrated in FIG. 29 and FIG. 30.

In one example, for the third TRP (e.g., with some QCL properties pre-compensated), the UE is activated (e.g., by MAC CE signaling and/or RRC signaling and/or L1 control signaling) a set or list of first QCL properties which are pre-compensated based on first reference TRP, a set or list of second QCL properties which are pre-compensated based on second reference TRP (and possibly a set or list of QCL properties which are non-compensated). In one example, activation can be with TCI state codepoint activation. In one example, activation can be separate from TCI state codepoint activation. For the first pre-compensated QCL properties, the UE follows the source RS associated with the first pre-compensated QCL properties (associated with (or transmitted by or received by) first reference TRP or RS in RS set associated with first reference TRP) as illustrated in FIG. 29 and FIG. 30. For the second pre-compensated QCL properties, the UE follows the source RS associated with the second pre-compensated QCL properties (associated with (or transmitted by or received by) second reference TRP or RS in RS set associated with second reference TRP) as illustrated in FIG. 29 and FIG. 30. For the non-compensated QCL properties, the UE follows the source RS associated with the non-compensated QCL properties (associated with (or transmitted by or received by) third TRP or RS in RS set associated with third TRP) as illustrated in FIG. 29 and FIG. 30.

In one example, for the third TRP (e.g., with some QCL properties pre-compensated), the UE is indicated (e.g., by L1 control signaling and/or MAC CE signaling) a set or list of first QCL properties which are pre-compensated based on first reference TRP, a set or list of second QCL properties which are pre-compensated based on second reference TRP (and possibly a set or list of QCL properties which are non-compensated). In one example, indication can be with TCI state codepoint indication. In one example, indication can be separate from TCI state codepoint indication. For the first pre-compensated QCL properties, the UE follows the source RS associated with the first pre-compensated QCL properties (associated with (or transmitted by or received by) first reference TRP or RS in RS set associated with first reference TRP) as illustrated in FIG. 29 and FIG. 30. For the second pre-compensated QCL properties, the UE follows the source RS associated with the second pre-compensated QCL properties (associated with (or transmitted by or received by) second reference TRP or RS in RS set associated with first reference TRP) as illustrated in FIG. 29 and FIG. 30. For the non-compensated QCL properties, the UE follows the source RS associated with the non-compensated QCL properties (associated with (or transmitted by or received by) third TRP or RS in RS set associated with third TRP) as illustrated in FIG. 29 and FIG. 30.

In one example, for the third TRP (e.g., with some QCL properties pre-compensated), the UE is configured (e.g., by RRC signaling and/or MAC CE signaling) a first reference TRP or source RS or RS set associated with first reference TRP or TCI state to use for first pre-compensated QCL properties, and a second reference TRP or source RS or RS set associated with second reference TRP or TCI state to use for second pre-compensated QCL properties.

In one example, for the third TRP (e.g., with some QCL properties pre-compensated), the UE is activated (e.g., by MAC CE signaling and/or RRC signaling and/or L1 control signaling) a first reference TRP or source RS or RS set associated with first reference TRP or TCI state to use for first pre-compensated QCL properties and a second reference TRP or source RS or RS set associated with first reference TRP or TCI state to use for second pre-compensated QCL properties. In one example, activation can be with TCI state codepoint activation. In one example, activation can be separate from TCI state codepoint activation.

In one example, for the third TRP (e.g., with some QCL properties pre-compensated), the UE is indicated (e.g., by L1 control signaling and/or MAC CE signaling) a first reference TRP or source RS or RS set associated with first reference TRP or TCI state to use for first pre-compensated QCL properties and a second reference TRP or source RS or RS set associated with first reference TRP or TCI state to use for second pre-compensated QCL properties. In one example, indication can be with TCI state codepoint indication. In one example, indication can be separate from TCI state codepoint indication.

Muting only when the DL RSs for TRPs are configured for CJT calibration reporting. Based on the CJT calibration reporting, the NW calibrates the CJT TRPs, and after the calibration, the QCL assumptions (and Types) are aligned (i.e., same/common) across CJT TRPs.

In one example, for transmission from a third TRP, with first pre-compensated QCL properties and second pre-compensated QCL properties, the UE does not use the QCL properties of the source RS associated with (or transmitted by or received by) third TRP for the first and second pre-compensated QCL properties as disclosed in the present disclosure. The first and second pre-compensated QCL properties are said to be muted. In one example, for first muted QCL properties, the UE uses a source RS of a first reference TRP or RS in RS set associated with first reference TRP, wherein the first reference TRP and/or source RS and/or corresponding TCI state for the first muted QCL properties can be configured and/or activated and/or indicated to the UE as disclosed in the present disclosure. For second muted QCL properties, the UE uses a source RS of a second reference TRP or RS in RS set associated with second reference TRP, wherein the second reference TRP and/or source RS and/or corresponding TCI state for the second muted QCL properties can be configured and/or activated and/or indicated to the UE as disclosed in the present disclosure. The first muted QCL properties can be configured and/or activated and/or indicated to the UE as disclosed in the present disclosure. The second muted QCL properties can be configured and/or activated and/or indicated to the UE as disclosed in the present disclosure. The unmuted QCL properties can be configured and/or activated and/or indicated to the UE as disclosed in the present disclosure.

In one example as disclosed in the present disclosure, there is a first pre-compensated QCL properties and a second pre-compensated QCL properties, there is no non-compensated QCL properties. The UE is not configured a source reference signal for the non-compensated QCL properties.

In one example, TRP1 is a reference TRP for first QCL properties (e.g., frequency related properties, e.g., Doppler spread and/or Doppler shift) for all TRPs. TRP1 is a reference TRP for second QCL properties (e.g., time related properties, e.g., average delay and/or delay spread) for TRP1 and TRP2. TRP3 is a reference TRP for second QCL properties (e.g., time related properties, e.g., average delay and/or delay spread) for TRP3 and TRP4. A UE is configured and/or activated and/or indicated TCI state for or based on TRP1 and TRP3, wherein: (i) TCI state for/based on TRP1 can apply for transmission from TRP1 and TRP2; and (ii) TCI state for/based on TRP3 can apply for transmission from TRP3 and TRP4, except for first QCL properties are determined on reference TRP1.

In one example, there can be two lists of (e.g., of DL-joint or UL) TCI states, wherein the first list is based on the TRP1 (e.g., source reference signal is associated with or transmitted from or received by TRP1 or in RS set associated with TRP1). The second list is based on the TRP3 (e.g., source reference signal is associated with or transmitted from or received by TRP3 or in RS set associated with TRP3). In one example, a UE is activated (by MAC CE signaling RRC signaling or L1 control (DCI) signaling) one set of codepoints with codepoints including TCI states from the first list and/or TCI states from the second list. The UE is indicated a TCI state codepoint by L1 control or MAC CE signaling. In one example, a UE is activated (by MAC CE signaling RRC signaling or L1 control (DCI) signaling) two sets of codepoints the first set of codepoints includes TCI states from the first list and the second set of codepoints includes TCI states from the second list. The UE is indicated a first TCI state codepoint and/or a second TCI state codepoint by L1 control or MAC CE signaling.

In one example, TRP1 is a reference TRP for first QCL properties (e.g., frequency related properties, e.g., Doppler spread and/or Doppler shift) for all TRPs. TRP2 is a reference TRP for second QCL properties (e.g., time related properties, e.g., average delay and/or delay spread) for TRP2 and TRP3 and TRP4. A UE is configured and/or activated and/or indicated TCI state for or based on TRP1 and TRP2, wherein: (i) TCI state for/based on TRP1 can apply for transmission from TRP1; and (ii) TCI state for/based on TRP2 can apply for transmission from TRP2 and TRP3 and TRP4, except for first QCL properties are determined on reference TRP1.

In one example, there can be two lists of (e.g., of DL-Joint or UL) TCI states, wherein the first list is based on the TRP1 (e.g., source reference signal is associated with or transmitted from or received by TRP1). The second list is based on the TRP2 (e.g., source reference signal is associated with or transmitted from or received by TRP2). In one example, a UE is activated (by MAC CE signaling RRC signaling or L1 control (DCI) signaling) one set of codepoints with codepoints including TCI states from the first list and/or TCI states from the second list. The UE is indicated a TCI state codepoint by L1 control or MAC CE signaling. In one example, a UE is activated (by MAC CE signaling RRC signaling or L1 control (DCI) signaling) two sets of codepoints the first set of codepoints includes TCI states from the first list and the second set of codepoints includes TCI states from the second list. The UE is indicated a first TCI state codepoint and/or a second TCI state codepoint by L1 control or MAC CE signaling.

In one example, for one or more QCL properties or QCL Types, a UE selects a reference TRP for measurement, e.g., TRPm. For transmission, a UE selects a second TRPt as a reference TRP. In one example, the pre-compensation of the one or more QCL properties is with respect to TRPt. In one example, if the QCL property measurement for TRP3 is m_m3, and the QCL property measurement for TRPt is m_mt. The measurement quantity used to compensate a transmission from TRP3 when TRPt is the reference is given by m_m3−m_mt. Some examples as disclosed in the present disclosure can follow where the TCI state or QCL information of the reference TRP is that corresponding to TRPt.

In one example, there is one reference TRP, and QCL properties are compensated according to the reference TRP. There is no non-compensated QCL properties. The UE can be indicated one TCI state with a source RS (e.g., based on reference TRP or RS in RS set associated with reference TRP) for all TRPs.

The present disclosure provides embodiments: (i) a TCI state indication for up to 4 TRPs including grouping source reference signals from multiple TRPs in the same TCI state; (ii) a TCI state configuration with pre-compensated and non-compensated QCL properties; and (iii) multiple sets of pre-compensated QCL properties with difference reference TRPs.

Wireless communication systems such as 5G NR and future 6G system support multi-antenna transmission and reception to improve capacity, provide diversity against fading and provide beam-based operation. To improve capacity multi-antenna transmission and reception enables support of spatial multiplexing of multiple layers over multiple antenna ports. Antenna ports can be characterized by large scale fading parameters such frequency domain-related parameters (e.g., Doppler spread and Doppler shift), time domain-related parameters such as (average delay and delay spread), spatial domain-related parameters such spatial filters (or beams) used to transmit and receive a channel or signal on an antenna port. Large scale parameters are referred to as quasi-co-location (QCL) properties. Two signals have the same QCL properties, when they experience the same wireless channel conditions for a particular QCL property.

For DL transmissions, a physical downlink shared channel (PDSCH) can be transmitted on multiple antenna ports, each antenna port is associated with a demodulation-reference signal (DM-RS) that can assist the receiver with coherent demodulation. The DM-RS can be quasi-co-located with another reference signal for one or more QCL properties, in fact the DM-RS can be quasi-co-collocated with different reference signals for different QCL properties. For example, a DM-RS is QCLed with a first reference signal, RS1, for a first QCL property or properties and QCLed, with a second reference signal, RS2, for a second QCL property or properties and so on. The reference signal the DM-RS is QCLed to is referred to as the source reference signal or source RS. The DM-RS that is QCLed with the source reference signal is referred to as the target reference signal or target RS. “QCL-Info” information element, as illustrated below provides at least a source RS and a QCL type (list of QCL properties) that can be associated with a target RS (e.g., DM-RS). TABLE 2 shows an example QCL information.

TABLE 2
QCL-Info

QCL-Info ::= SEQUENCE {
...
referenceSignal CHOICE {
csi-rs NZP-CSI-RS-ResourceId,
ssb SSB-Index
},
qcl-Type ENUMERATED {typeA, typeB, typeC, typeD},
...
}

A TCI state, as illustrated below, can be configured to included one or more QCL-Info information elements. TCI state is associated with (or indicated to) a DM-RS (target RS) and can determine the QCL properties of DM-RS based on the one or more source RS in the one or more QCL-Info information elements in the TCI state and the corresponding one or more QCL-Types. TABLE 3 shows an example TCI state.

TABLE 3
TCI-State

| | |
|---|---|
| TCI-State ::= | SEQUENCE { |
| tci-StateId | TCI-StateId, |
| qcl-Type1 | QCL-Info, |
| qcl-Type2 | QCL-Info OPTIONAL, |

...
}

Similarly, for UL transmissions, a physical uplink shared channel (PUSCH) can be transmitted on multiple antenna ports, each antenna port is associated with a demodulation-reference signal (DM-RS) that can assist the receiver with coherent demodulation. The DM-RS (target RS) can be quasi-co-located with another reference signal (source RS) for one or more QCL properties, in fact the DM-RS can be quasi-co-collocated with different reference signals for different QCL properties.

As wireless communication systems and their multi-antenna systems evolve to meet new and enhanced requirements and features and support new deployment scenarios, the TCI state indication framework can be enhanced to better serve the evolution of wireless communication systems.

Multi-TRP (mTRP) transmission can provide significant benefit to wireless communication, by improving reliability by providing diversity against fading. mTRP transmission also improves capacity by allowing more degrees of spatial multiplexing thanks to the multiple TRPs available for communication with the UE. The multiple TRPs can be co-located or distributed. Distributed mTRP can be a type of distributed antenna system. There are various operating schemes for mTRP systems, such as dynamical point selection (DPS), coherent joint transmission (CJT), non-coherent joint transmission (NCJT) and single frequency network (SFN). One embodiment in supporting these schemes is the flexibility of indication of QCL properties, which can be different for different antenna ports.

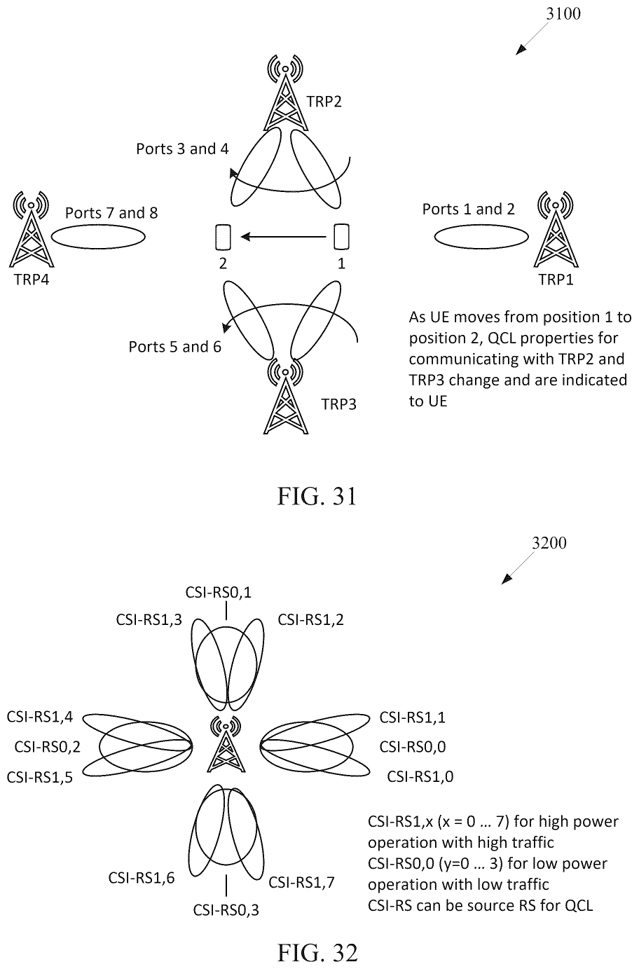

FIG. 31 illustrates an example of network configuration for UE mobility 3100 according to embodiments of the present disclosure. An embodiment of the network configuration for UE mobility 3100 shown in FIG. 31 is for illustration only.

To illustrate this by way of an example, as illustrate in FIG. 31, where a UE is illustrated to be communicating with 4 TRPs. In this example, the UE communicates using eight antenna ports with the network, two antenna ports per TRP. Each antenna port (or each pair of antenna ports) can have different QCL properties, as it is associated with a different TRP and hence a different channel. In this example, the UE moves in such a way that the beam changes for two TRPs (e.g., TRP2 and TRP3) but not for the other two TRPs (e.g., TRP1 and TRP4). In this case, the UE can be signaled with new QCL properties for the DM-RS of the antenna ports (3, 4, 5 and 6) that have new QCL properties and not the other DM-RS antenna ports (1, 2, 7, and 8).

In the present disclosure, the QCL properties can be associated with a DM-RS antenna port, where the DMRS antenna port follows (i.e., is the target of) the QCL property. This provides more flexibility, as the DM-RS ports can be associated with different TRPs or can experience different channel conditions (e.g., transmitted on different multi-path). Furthermore, efficient signaling is used to indicate QCL properties. The indication of QCL properties can be for an antenna port or a group of antenna ports or a list of antenna ports as described in the present disclosure.

Energy efficiency is an important features of future wireless communication systems, both on the network side as well as the UE side. One way to achieve energy efficiency, is to reduce transmission time, and hence the “on-time” for the network and UE, by increasing channel throughput. Multi antenna systems, by their very nature, improve channel throughput by improving spatial multiplexing, and hence can reduce transmission time. However, multi-antenna systems consume more energy given the larger number of antenna elements, during periods of no or low traffic it may be efficient to power down at least some of the antenna elements to save power. There are several ways to power down antenna elements. In one example, antenna ports can be turned off. In another example, some of the antenna elements of an antenna port are turned off, this leads to a new spatial filter with new QCL properties. In another example, both of these methods can be used.

FIG. 32 illustrates an example of UE configuration with CSI-RS resources 3200 according to embodiments of the present disclosure. An embodiment of the UE configuration with CSI-RS resources 3200 shown in FIG. 32 is for illustration only.

In FIG. 32, a UE can be configured with first CSI-RS resources (CSI-RS0, y, where y=0, . . . , 3) when the network has low traffic, for example, this can correspond to wider spatial filters (beam) with fewer antenna elements per spatial filter (beam), this allows the network to operate with a lower power level. The UE can be configured with second CSI-RS resources (CSI-RS0, x, where x=0, . . . , 7) when the network has high traffic, for example, this can correspond to narrow spatial filters (beam) with more antenna elements per spatial filter (beam), this can allow the network to operate with high traffic. As the network switches between low energy and high energy mode, a TCI state or quasi-co-location information corresponding to the operation mode is indicated to the UE.

To maximize energy saving in the network, adaptation to traffic condition can be fast, hence leading to fast adaptation in the QCL properties for data transmission and reception as the network adapts its multi-antenna transmission system to current traffic condition. This may also benefit from efficient indication of QCL properties. For example, when the network is serving multiple UEs and switches from one set of QCL-properties (or beams) to another set of QCL-properties or beams, e.g., based on traffic conditions or power saving mode, it can efficiently indicate new QCL-properties to a group of UEs.

The present disclosure provides methods for efficient indication of TCI states or QCL properties for a set of entities. The set of entities can be represented for example, by a bitmap or a field-map where a bit in the bitmap or a field in the field-map can correspond to an entity. As described in the present disclosure, an entity can be a group of entities or a list of entities that have same TCI state(s) or QCL-properties. An entity can be: (i) an antenna port, (ii) a UE, (iii) a carrier (e.g., component carrier), (iv) a TRP, (v) a TRP panel, and/or (vi) a UE panel.

In the present disclosure, efficient beam indication with two stage/part downlink control information (DCI) are provided.

The present disclosure provides embodiments related to beam indication for a set of entities (e.g., antenna ports or groups of antenna ports or lists of antenna ports): (i) signaling of QCL properties for antenna-ports; (ii) grouping of antenna ports that share common QCL properties; and (iii) common signaling of QCL properties for UEs.

In one example of the present disclosure, a UE can be indicated a QCL property or QCL properties for one or more antenna ports, or groups of antenna ports, or lists of antenna ports through downlink control information (DCI). In one example, DCI is included in a single stage. In one example, DCI is included in two stages, or two parts; a first stage/part and a second stage/part.

In another example of the present disclosure, common signaling to set of UEs can indicate a QCL property or QCL properties for one or more UEs through downlink control information (DCI). In one example, DCI is included in a single stage. In one example, DCI is included in two stages, or two parts; a first stage/part and a second stage/part.

In another example of the present disclosure, for a UE or a set of UEs, signaling can indicate a QCL property or QCL properties for one or more entities through downlink control information (DCI). In one example, DCI is included in a single stage. In one example, DCI is included in two stages, or two parts; a first stage/part and a second stage/part. An entity can be X or a group of X following same TCI state(s) or QCL propert(ies) or a list of X following same TCI state(s) or QCL propert(ies). Where X can be antenna port, UE, carrier (e.g., component carrier), TRP, antenna panel of TRP, antenna of UE, transmission direction (e.g., DL or UL or SL), or a combination of these.

In one example, a QCL property is indicated through TCI state. Wherein, a UE is configured with one or more lists of TCI states. A list of TCI states is a list of one of: (i) one or more DL TCI states; (ii) one or more UL TCI states; (iii) one or more joint TCI states; (iv) one or more DL and joint TCI states; (v) one or more UL and joint TCI states; (vi) one or more DL and UL TCI states; and/or (vii) one or more DL, UL and joint TCI states.

A UE can be activated with a list or multiple lists of TCI state codepoints, wherein a TCI state codepoint can include: (i) a DL TCI state, wherein a DL TCI state can be used for QCL properties or/and spatial information for DL transmissions; (ii) an UL TCI state, wherein an UL TCI state can be used for QCL properties or/and spatial information for UL transmissions; (iii) a joint TCI state, wherein a joint TCI state can be used for QCL properties or/and spatial information for DL transmissions and UL transmissions; and/or (4) a pair of DL and UL TCI states, wherein a pair of DL and UL TCI states can be used for QCL properties or/and spatial information for DL transmissions and UL transmissions respectively.

In one example, a TCI state can include one or more QCL-Info information elements as disclosed in the present disclosure.

In one example, a QCL-Info can include a source RS and a corresponding QCL-Type.

In one example a QCL-info can include a source RS and more than one corresponding QCL-Types, the source RS is used for the more than one QCL-Types.

In one example, a QCL-Info can include more than one source RSs and a corresponding QCL-Type, the more than one source RSs are for the QCL-Type.

In one example, a QCL-Info can include more than one source RSs and more than one QCL-Types: (i) in one example, there is a one to one mapping between a source RS and a QCL-Type and/or (ii) in one example, each of the more than one source RSs are for the more than one QCL-Types.

In one example, a QCL-Info can include an antenna port of a source RS and a corresponding QCL-Type.

In one example a QCL-info can include an antenna port of a source RS and more than one corresponding QCL-Types, the antenna port of the source is used for the more than one QCL-Types.

In one example, a QCL-Info can include more than one antenna ports of one or more source RS and a corresponding QCL-Type, the more than one antenna port of the one or more source RS are for the QCL-Type.

In one example, a QCL-Info can include more than one antenna ports of one or more source RS and more than one QCL-Types: (i) in one example, there is a one to one mapping between an antenna port of a source RS and a QCL-Type and/or (ii) in one example, each of the more than one antenna ports of the one or more source RS are for the more than one QCL-Types.

In one example, the source RS can be one of: (i) SS/PBCH block index; (ii) channel state information reference signal (CSI-RS); (iii) sounding reference signal (SRS); and/or low-power synchronization signal (LP-SS).

In one example, the SS/PBCH block index is configured with one antenna port. In one example, the SS/PBCH block index can be configured with more than one antenna port.

In one example, the CSI-RS is configured with one antenna port. In one example, the CSI-RS can be configured with more than one antenna port.

In one example, the SRS is configured with one antenna port. In one example, the SRS can be configured with more than one antenna port.

In one example, the LP-SS is configured with one antenna port. In one example, the LP-SS can be configured with more than one antenna port.

In one example, the antenna port of a source RS can be one of: (i) antenna port of SS/PBCH block index; (ii) antenna port of CSI-RS; (iii) antenna port of SRS; and/or antenna port of LP-SS.

In one example, the QCL-Type can be one of: (i) Type A, {Doppler shift, Doppler spread, average delay, delay spread}; (ii) Type B, {Doppler shift, Doppler spread}; (iii) Type C, {Doppler shift, average delay}; and/or (iv) Type D, {Spatial Rx parameter}.

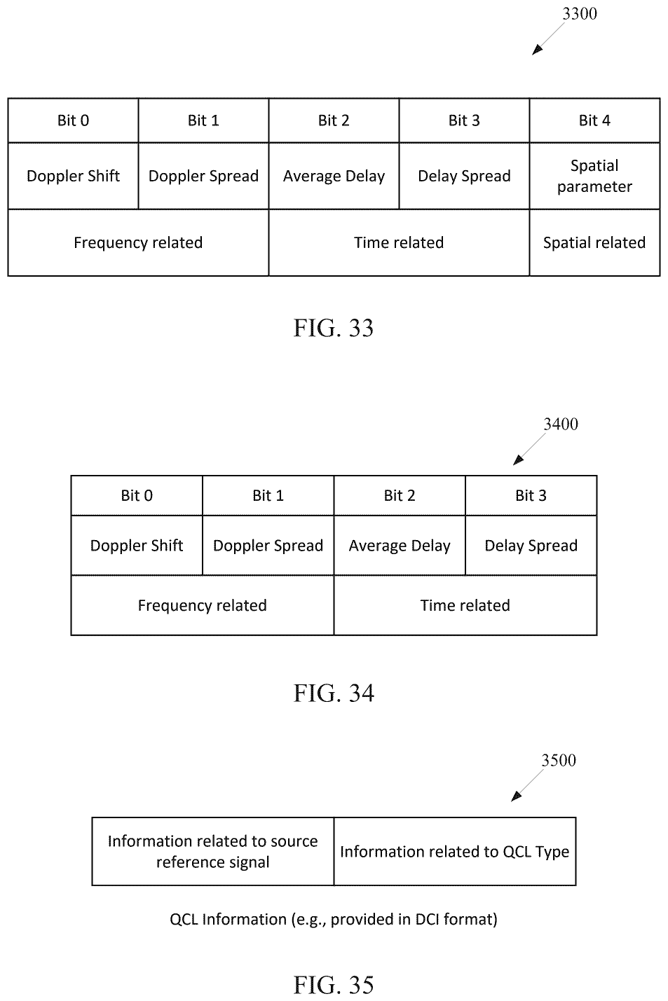

In one example, the QCL-Type=a QCL-property bitmap is as illustrated in FIG. 33, the QCL-property bitmap can include frequency domain-related QCL properties, time domain-related QCL properties, and spatial domain-related QCL properties. Wherein a bit in the bitmap corresponds to a QCL property, and a QCL property may be {Doppler shift, Doppler spread, average delay, delay spread, spatial parameter}. In a variant example, a QCL property may also include phase information, a bit in the bitmap corresponds to a QCL property, and a QCL property may be {Doppler shift, Doppler spread, average delay, delay spread, phase information, spatial parameter}. For example, if the bit is “1” the QCL property applies, i.e., the target RS signaled to use the QCL-type, follows the QCL property with bit set to “1” of the source RS associated with the QCL-Type. For example, if the bit is “0” the QCL property does not apply, i.e., the target RS signaled to use the QCL-type, does not follow the QCL property with bit set to “0” of the source RS associated with the QCL-Type. In one example, the role of “0” and “1” can be reversed.

FIG. 33 illustrates an example of QCL-property bitmap 3300 according to embodiments of the present disclosure. An embodiment of the QCL-property bitmap 3300 shown in FIG. 33 is for illustration only.

In one example, the QCL-Type=a QCL-property bitmap is as illustrated in FIG. 34, the QCL-property bitmap can include frequency domain-related QCL properties and time domain-related QCL properties. Wherein a bit in the bitmap corresponds to a QCL property, and a QCL property may be {Doppler shift, Doppler spread, average delay, delay spread}. In a variant example, a QCL property may also include phase information, a bit in the bitmap corresponds to a QCL property, and a QCL property may be {Doppler shift, Doppler spread, average delay, delay spread, phase information}. For example, if the bit is “1” the QCL property applies, i.e., the target RS signaled to use the QCL-type, follows the QCL property with bit set to “1” of the source RS associated with the QCL-Type. For example, if the bit is “0” the QCL property does not apply, i.e., the target RS signaled to use the QCL-type, does not follow the QCL property with bit set to “0” of the source RS associated with the QCL-Type. In one example, the role of “0” and “1” can be reversed.

FIG. 34 illustrates another example of QCL-property bitmap 3400 according to embodiments of the present disclosure. An embodiment of the QCL-property bitmap 3400 shown in FIG. 34 is for illustration only.

In one example, the QCL-Type=a QCL-property bitmap and the QCL properties in the bitmap can be configured by higher layers (e.g., RRC signaling and/or SIB signaling and/or MAC CE signaling) and/or indicated by L1 control (e.g., DCI) signaling. The QCL properties can include; frequency domain-related QCL properties and/or time domain-related QCL properties and/or phase-related QCL properties and/or spatial domain-related QCL properties. In one example, the frequency domain-related QCL properties can include Doppler shift and/or Doppler spread. In one example, the time domain-related QCL properties can include average delay and/or delay spread. In one example, phase-related QCL properties can include phase information. In one example, the spatial domain-related QCL properties can include spatial parameters (e.g., for spatial domain transmit filter or spatial domain receive filter). For example, if the bit is “1” the QCL property applies, i.e., the target RS signaled to use the QCL-type, follows the QCL property with bit set to “1” of the source RS associated with the QCL-Type. For example, if the bit is “0” the QCL property does not apply, i.e., the target RS signaled to use the QCL-type, does not follow the QCL property with bit set to “0” of the source RS associated with the QCL-Type. In one example, the role of “0” and “1” can be reversed.

In one example, the QCL-Type=a QCL-property bitmap and the QCL properties in the bitmap can be configured by higher layers (e.g., RRC signaling and/or SIB signaling and/or MAC CE signaling) and/or indicated by L1 control (e.g., DCI) signaling. The QCL properties can include; frequency domain-related QCL properties and/or time domain-related QCL properties and/or phase-related QCL properties. In one example, the frequency domain-related QCL properties can include Doppler Shift and/or Doppler spread. In one example, the time domain-related QCL properties can include average delay and/or delay spread. In one example, phase-related QCL properties can include phase information. For example, if the bit is “1” the QCL property applies, i.e., the target RS signaled to use the QCL-type, follows the QCL property with bit set to “1” of the source RS associated with the QCL-Type. For example, if the bit is “0” the QCL property does not apply, i.e., the target RS signaled to use the QCL-type, does not follow the QCL property with bit set to “0” of the source RS associated with the QCL-Type. In one example, the role of “0” and “1” can be reversed.

In one example, a DCI is used to indicate the TCI state or TCI state ID or TCI state codepoint as disclosed in the present disclosure, wherein the TCI state can include source RS(s) and corresponding QCL type(s) as disclosed in the present disclosure. In an alternative example, the DCI can indicate a source RS and corresponding QCL type as described later in the present disclosure.

In one example, for a DL TCI state, or source RS and corresponding QCL type for DL transmission, the indicated TCI state or source RS/QCL type applies to: (i) DL control channel (PDCCH), e.g., that follows the indicated TCI state or indicated source RS/QCL Type; (ii) DL shared channel (PDSCH), e.g., that follows the indicated TCI state or indicated source RS/QCL Type; and (iii) other DL channels or signals that follow the indicated TCI state or indicated source RS/QCL Type.

In one example, for a DL TCI state, or source RS and corresponding QCL type for DL transmission, the indicated TCI state or source RS/QCL type applies to: (i) an antenna port of a DL control channel (PDCCH), e.g., that follows the indicated TCI state or indicated source RS/QCL Type; (ii) an antenna port of a DL shared channel (PDSCH), e.g., that follows the indicated TCI state or indicated source RS/QCL Type; and/or (iii) an antenna port of other DL channels or signals that follow the indicated TCI state or indicated source RS/QCL Type.

In one example, for a UL TCI state, or source RS and corresponding QCL type for UL transmission, the indicated TCI state or source RS/QCL type applies to: (i) UL control channel (PUCCH), e.g., that follows the indicated TCI state or indicated source RS/QCL Type; (ii) UL shared channel (PUSCH), e.g., that follows the indicated TCI state or indicated source RS/QCL Type; and/or (iii) other UL channels or signals that follow the indicated TCI state or indicated source RS/QCL Type.

In one example, for a UL TCI state, or source RS and corresponding QCL type for UL transmission, the indicated TCI state or source RS/QCL type applies to: (i) an antenna port of a UL control channel (PUCCH), e.g., that follows the indicated TCI state or indicated source RS/QCL Type; (ii) an antenna port of a UL shared channel (PUSCH), e.g., that follows the indicated TCI state or indicated source RS/QCL Type; and/or (iii) an antenna port of other UL channels or signals that follow the indicated TCI state or indicated source RS/QCL Type.

In one example, for a joint TCI state, or source RS and corresponding QCL type for DL transmission and UL transmission, the indicated TCI state or source RS/QCL type applies to: (i) DL control channel (PDCCH), e.g., that follows the indicated TCI state or indicated source RS/QCL Type; (ii) DL shared channel (PDSCH), e.g., that follows the indicated TCI state or indicated source RS/QCL Type; (iii) other DL channels or signals that follow the indicated TCI state or indicated source RS/QCL Type; (iv) UL control channel (PUCCH), e.g., that follows the indicated TCI state or indicated source RS/QCL Type; (v) UL shared channel (PUSCH), e.g., that follows the indicated TCI state or indicated source RS/QCL Type; and/or (vi) other UL channels or signals that follow the indicated TCI state or indicated source RS/QCL Type.

In one example, for a joint TCI state, or source RS and corresponding QCL type for DL transmission and UL transmission, the indicated TCI state or source RS/QCL type applies to: (i) an antenna port of a DL control channel (PDCCH), e.g., that follows the indicated TCI state or indicated source RS/QCL Type; (ii) an antenna port of a DL shared channel (PDSCH), e.g., that follows the indicated TCI state or indicated source RS/QCL Type; (iii) an antenna port of other DL channels or signals that follow the indicated TCI state or indicated source RS/QCL Type; (iv) an antenna port of a UL control channel (PUCCH), e.g., that follows the indicated TCI state or indicated source RS/QCL Type; (v) an antenna port of a UL shared channel (PUSCH), e.g., that follows the indicated TCI state or indicated source RS/QCL Type; (vi) an antenna port of other UL channels or signals that follow the indicated TCI state or indicated source RS/QCL Type.

FIG. 35 illustrates an example of QCL information 3500 according to embodiments of the present disclosure. An embodiment of the QCL information 3500 shown in FIG. 35 is for illustration only.

In one example, to indicate a QCL information in a DCI format, the following can be included in a DCI format at illustrated in FIG. 35: (i) information related to a source reference signal; and (ii) information related to a QCL-Type.

In one example, information related to the source reference signal can be a reference signal ID, wherein the reference signal can be: (i) SS/PBCH block index; (ii) channel state information reference signal (CSI-RS); (iii) sounding reference signal (SRS); and/or low-power synchronization signal (LP-SS).

In one example, the SS/PBCH block index is configured with one antenna port. In one example, the SS/PBCH block index can be configured with more than one antenna port.

In one example, the CSI-RS is configured with one antenna port. In one example, the CSI-RS can be configured with more than one antenna port.

In one example, the SRS is configured with one antenna port. In one example, the SRS can be configured with more than one antenna port.

In one example, the LP-SS is configured with one antenna port. In one example, the LP-SS can be configured with more than one antenna port.

In one example, information related to the source reference signal can be a reference signal ID and antenna port index of reference signal, wherein the reference signal can be: (i) SS/PBCH block index; (ii) channel state information reference signal (CSI-RS); (iii) sounding reference signal (SRS); and/or (iv) low-power synchronization signal (LP-SS).

In one example, information related to QCL-Type can indicate one of: (i) Type A, {Doppler shift, Doppler spread, average delay, delay spread}; (ii) Type B, {Doppler shift, Doppler spread}; (iii) Type C, {Doppler shift, average delay}; and/or (iv) Type D, {Spatial Rx parameter}.

In one example, information related to QCL-Type can be a QCL-property bitmap as disclosed in the present disclosure and as illustrated in FIG. 33. In one example, QCL-property bitmap can also include phase-related QCL properties.

In one example, information related to QCL-Type can be a QCL-property bitmap as disclosed in the present disclosure and as illustrated in FIG. 34. In one example, QCL-property bitmap can also include phase-related QCL properties.

In one example, information related to QCL-Type can be a QCL-property bitmap and the QCL properties in the bitmap can be configured by higher layers (e.g., RRC signaling and/or SIB signaling and/or MAC CE signaling) and/or indicated by L1 control (e.g., DCI) signaling as disclosed in the present disclosure.

In one example, a UE can be configured with a list of antenna ports that follow the same TCI state type or source RS/QCL Type.

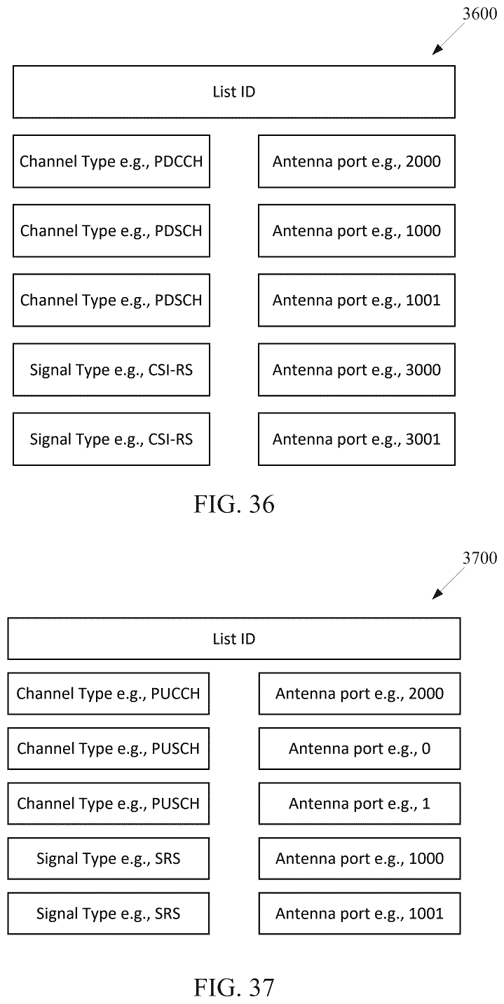

FIG. 36 illustrates an example of antenna port list for each channel or signal type 3600 according to embodiments of the present disclosure. An embodiment of the antenna port list for each channel or signal type 3600 shown in FIG. 36 is for illustration only.

In one example, the list of antenna ports (e.g., DM-RS or CSI-RS antenna ports) is for DL channels and signals, wherein, a list can include a list ID, one more channel or signal types and/or indices (e.g., PDCCH, PDSCH, CSI-RS), and one or more corresponding port IDs as illustrated in FIG. 36. In FIG. 36, as an example, the list includes a list ID, and antenna port 2000 for PDCCH, antenna ports 1000 and 1001 for PDSCH and antenna ports 3000 and 3001 for CSI-RS. When a UE is indicated a TCI state or source RS/QCL Type for a list ID, the ports associated with the list ID follow the indicated TCI state or source RS/QCL Type. In one example as illustrated in FIG. 36, there can be up to one antenna port for each channel or signal type.

FIG. 37 illustrates another example of antenna port list for each channel or signal type 3700 according to embodiments of the present disclosure. An embodiment of the antenna port list for each channel or signal type 3700 shown in FIG. 37 is for illustration only.

In one example, the list of antenna ports (e.g., DM-RS or SRS antenna ports) is for UL channels and signals, wherein, a list can include a list ID, one more channel or signal types and/or indices (e.g., PUCCH, PUSCH, SRS), and one or more corresponding port IDs as illustrated in FIG. 37. In FIG. 37, as an example, the list includes a list ID, and antenna port 2000 for PUCCH, antenna ports 0 and 1 for PUSCH and antenna ports 1000 and 1001 for SRS. When a UE is indicated a TCI state or source RS/QCL Type for a list ID, the ports associated with the list ID follow the indicated TCI state or source RS/QCL Type. In one example as illustrated in FIG. 37, there can be up to one antenna port for each channel or signal type.

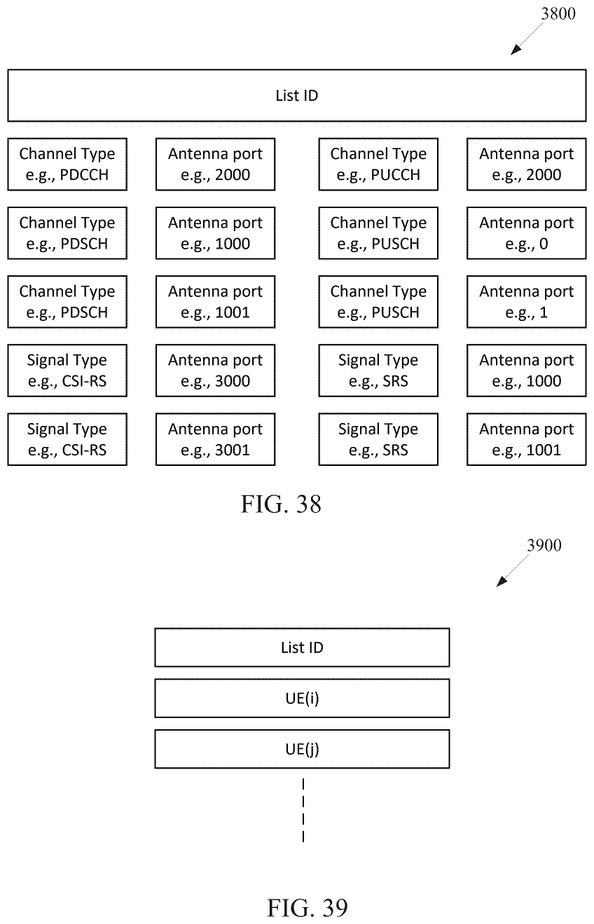

FIG. 38 illustrates yet another example of antenna port list for each channel or signal type 3800 according to embodiments of the present disclosure. An embodiment of the antenna port list for each channel or signal type 3800 shown in FIG. 38 is for illustration only.

In one example, the list of antenna ports (e.g., DM-RS or CSI-RS or SRS antenna ports) is for DL channels and signals and UL channels and signals, wherein, a list can include a list ID, one more channel or signal types and/or indices (e.g., PDCCH, PDSCH, CSI-RS, PUCCH, PUSCH, SRS), and one or more corresponding port IDs as illustrated in FIG. 38. In FIG. 38, as an example, the list includes a list ID, and antenna port 2000 for PDCCH, antenna ports 1000 and 1001 for PDSCH, antenna ports 3000 and 3001 for CSI-RS and antenna port 2000 for PUCCH, antenna ports 0 and 1 for PUSCH and antenna ports 1000 and 1001 for SRS. When a UE is indicated a TCI state or source RS/QCL Type for a list ID, the ports associated with the list ID follow the indicated TCI state or source RS/QCL Type. In one example as illustrated in FIG. 38, there can be up to one antenna port for each channel or signal type.

FIG. 39 illustrates an example of a set of UE for TCI state indication 3900 according to embodiments of the present disclosure. An embodiment of the set of UE for TCI state indication 3900 shown in FIG. 39 is for illustration only.

In another example, for a set of UEs, a list of UEs that follow the same TCI state or source RS/QCL Type is configured. A list can include a list ID, and one or more UEs that follow the same TCI state or source RS/QCL Type e.g., as illustrated in FIG. 39. In one example, a list can be for DL channels. In one example, a list can be for UL channels. In one example, a list can be for DL and UL channels with a joint indication for DL and UL channels (e.g., a single joint DL/UL entry per UE). In one example, a list can be for DL and UL channels with separate indications for DL and UL channels (e.g., two separate entries per UE one for DL and other for UL). When a set of UEs is indicated a TCI state or source RS/QCL Type for a list ID, the UEs associated with the list ID follow the indicated TCI state or source RS/QCL Type.

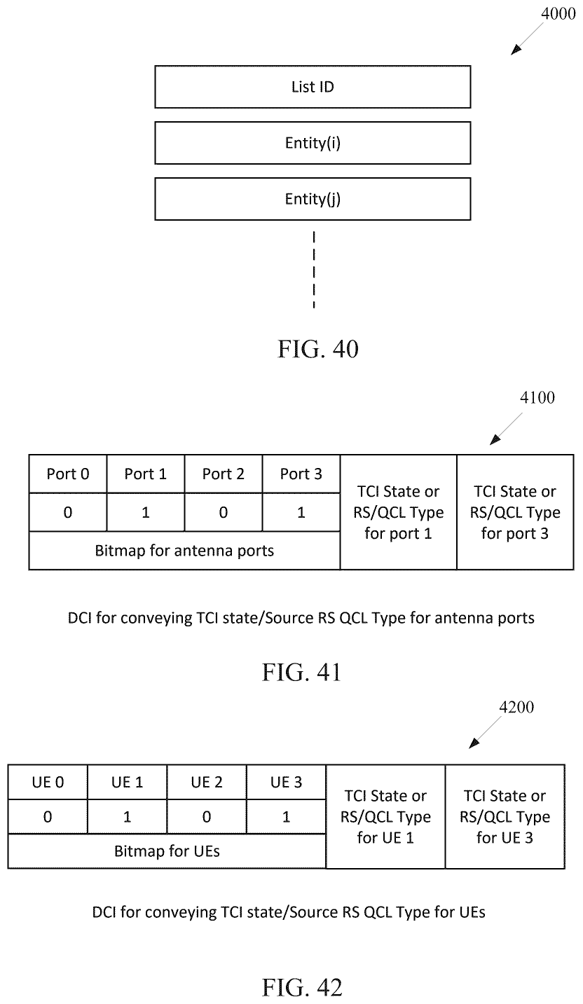

FIG. 40 illustrates another example of a set of entities for TCI state indication 4000 according to embodiments of the present disclosure. An embodiment of the set of entities for TCI state indication 4000 shown in FIG. 40 is for illustration only.

In another example, for a set of entities, a list of entities that follow the same TCI state or source RS/QCL Type is configured. A list can include a list ID, and one or more entities that follow the same TCI state or source RS/QCL Type e.g., as illustrated in FIG. 40. In one example, a list can be for DL channels. In one example, a list can be for UL channels. In one example, a list can be for DL and UL channels with a joint indication for DL and UL channels (e.g., a single joint DL/UL entry per entity). In one example, a list can be for DL and UL channels with separate indications for DL and UL channels (e.g., two separate entries per entity one for DL and other for UL). When a UE or a set of UEs is indicated a TCI state or source RS/QCL Type for a list ID, the entities associated with the list ID follow the indicated TCI state or source RS/QCL Type. Where an entity can be antenna port, UE, carrier (e.g., component carrier), TRP, antenna panel of TRP, antenna of UE, transmission direction (e.g., DL or UL or SL), or a combination of these.

In one example, a DCI is used to indicate the TCI state or TCI state ID or TCI state codepoint as disclosed in the present disclosure, wherein the TCI state can include source RS and corresponding QCL type as disclosed in the present disclosure. In an alternative example, the DCI can indicate a source RS and corresponding QCL type as disclosed in the present disclosure. The DCI includes a bitmap or field-map. In one example, the DCI is sent to a UE. In one example, the DCI is sent to a set of UEs.

FIG. 41 illustrates an example of DCI for conveying TCI state/source RS QCL type for antenna port 4100 according to embodiments of the present disclosure. An embodiment of the DCI for conveying TCI state/source RS QCL type for antenna port 4100 shown in FIG. 41 is for illustration only.

In one example, a bit in the bitmap corresponds to an antenna port. If a bit in the bitmap is “1” a TCI state ID/codepoint or source RS/QCL Type is included in the DCI for the corresponding antenna port. If a bit in the bitmap is “0” no TCI state ID/codepoint or source RS/QCL Type is included in the DCI for the corresponding antenna port. In one example, the role of “O” and “1” can be reversed. The TCI state ID/codepoints or source RS/QCL are in the order of bits with value “1” in the bitmap. This is illustrated by way of example in FIG. 41. In one example, if a TCI state is not indicated for an antenna port, e.g. corresponding to a bit with value “0”, a previously indicated/applied TCI state for the antenna port continues to be applied.

FIG. 42 illustrates an example of DCI for conveying TCI state/source RS QCL type for UEs 4200 according to embodiments of the present disclosure. An embodiment of the DCI for conveying TCI state/source RS QCL type for UEs 4200 shown in FIG. 42 is for illustration only.

In one example, a bit in the bitmap corresponds to a UE in a set of UEs. If a bit in the bitmap is “1” a TCI state ID/codepoint or source RS/QCL Type is included in the DCI for the corresponding UE. If a bit in the bitmap is “0” no TCI state ID/codepoint or source RS/QCL Type is included in the DCI for the corresponding UE. In one example, the role of “0” and “1” can be reversed. The TCI state ID/codepoints or source RS/QCL are in the order of bits with value “1” in the bitmap. This is illustrated by way of example in FIG. 42. In one example, if a TCI state is not indicated for a UE, e.g. corresponding to a bit with value “0”, a previously indicated/applied TCI state for the UE continues to be applied.

In one example, a bit in the bitmap corresponds to an entity in a set of entities. If a bit in the bitmap is “1” a TCI state ID/codepoint or source RS/QCL Type is included in the DCI for the corresponding entity. If a bit in the bitmap is “0” no TCI state ID/codepoint or source RS/QCL Type is included in the DCI for the corresponding entity. In one example, the role of “0” and “1” can be reversed. The TCI state ID/codepoints or source RS/QCL are in the order of bits with value “1” in the bitmap. In one example, if a TCI state is not indicated for an entity e.g. corresponding to a bit with value “0”, a previously indicated/applied TCI state for the entity continues to be applied. An entity can be as disclosed in the present disclosure.

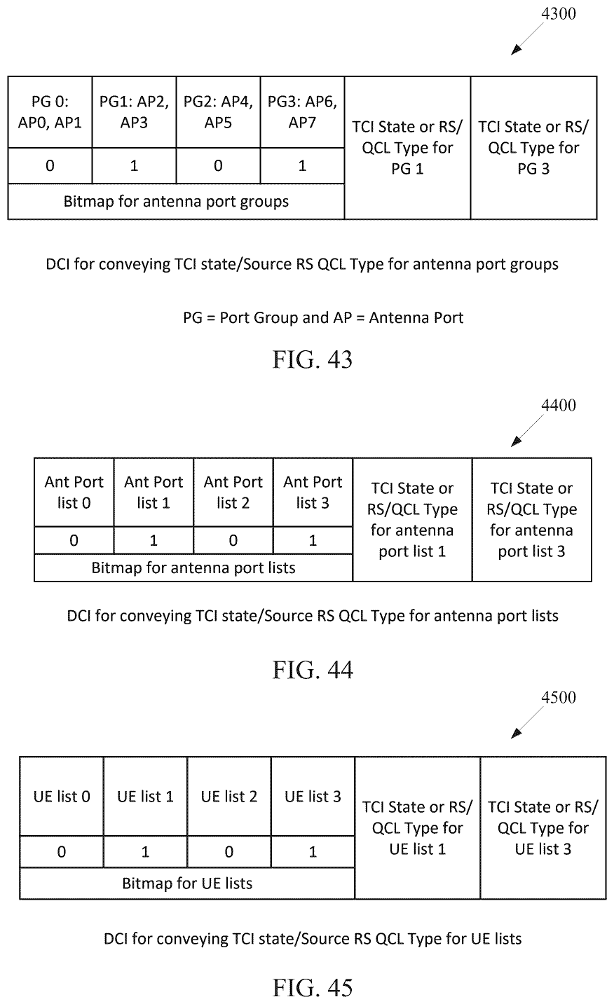

FIG. 43 illustrates an example of DCI for conveying TCI state/source RS QCL type for antenna port groups 4300 according to embodiments of the present disclosure. An embodiment of the DCI for conveying TCI state/source RS QCL type for antenna port groups 4300 shown in FIG. 43 is for illustration only.

In one example, a bit in the bitmap corresponds to a group of antenna ports that follow a same TCI state ID/codepoint or source RS/QCL-Type. In one example, the number of ports in a port group can be configured or indicated to a UE by higher layer signaling, e.g., SIB signaling and/or RRC signaling and/or MAC CE signaling and/or L1 control (DCI) signaling. For example, if the number of ports in a port group is 2, antenna ports 0 and 1 follow a first TCI state ID/codepoint or source RS/QCL Type, and antenna ports 2 and 3 follow a second TCI state ID/codepoint or source RS/QCL Type, etc. If a bit in the bitmap is “1” a TCI state ID/codepoint or source RS/QCL Type is included in the DCI for the corresponding antenna port group. If a bit in the bitmap is “0” no TCI state ID/codepoint or source RS/QCL Type is included in the DCI for the corresponding antenna port group. In one example, the role of “0” and “1” can be reversed. The TCI state ID/codepoints or source RS/QCL are in the order of bits with value “1” in the bitmap. This is illustrated by way of example in FIG. 43. In one example, if a TCI state is not indicated for an antenna port group e.g. corresponding to a bit with value “0”, a previously indicated/applied TCI state for the antenna port group continues to be applied. In another example, a group of antenna ports can be replaced by a group of UEs. In another example, a group of antenna ports can be replaced by a group of entities wherein an entity can be as disclosed in the present disclosure.

In one example, a bit in the bitmap corresponds to a list of antenna ports following a same TCI state ID/codepoint or source RS/QCL Type. The antenna ports that follow a same TCI state ID/codepoint or source RS/QCL Type can be configured as disclosed in the present disclosure (e.g., as illustrated in FIG. 36, FIG. 37 and FIG. 38). If a bit in the bitmap is “1” a TCI state ID/codepoint or source RS/QCL Type is included in the DCI for the corresponding list of antenna ports. If a bit in the bitmap is “0” no TCI state ID/codepoint or source RS/QCL Type is included in the DCI for the corresponding list of antenna ports. In one example, the role of “0” and “1” can be reversed. The TCI state ID/codepoints or source RS/QCL are in the order of bits with value “1” in the bitmap. This is illustrated by way of example in FIG. 44. In one example, if a TCI state is not indicated for a list of antenna ports e.g. corresponding to a bit with value “0”, a previously indicated/applied TCI state for the list of antenna ports continues to be applied.

FIG. 44 illustrates an example of DCI for conveying TCI state/source RS QCL type for antenna port lists 4400 according to embodiments of the present disclosure. An embodiment of the DCI for conveying TCI state/source RS QCL type for antenna port lists 4400 shown in FIG. 44 is for illustration only.

FIG. 45 illustrates an example of DCI for conveying TCI state/source RS QCL type for UE lists 4500 according to embodiments of the present disclosure. An embodiment of the DCI for conveying TCI state/source RS QCL type for UE lists 4500 shown in FIG. 45 is for illustration only.

In one example, a bit in the bitmap corresponds to a list of UEs following a same TCI state ID/codepoint or source RS/QCL Type. The UEs that follow a same TCI state ID/codepoint or source RS/QCL Type can be configured as disclosed in the present disclosure (e.g., as illustrated in FIG. 39). If a bit in the bitmap is “1” a TCI state ID/codepoint or source RS/QCL Type is included in the DCI for the corresponding list of UEs. If a bit in the bitmap is “0” no TCI state ID/codepoint or source RS/QCL Type is included in the DCI for the corresponding list of UEs. In one example, the role of “0” and “1” can be reversed. The TCI state ID/codepoints or source RS/QCL are in the order of bits with value “1” in the bitmap. This is illustrated by way of example in FIG. 45. In one example, if a TCI state is not indicated for a list of UEs e.g. corresponding to a bit with value “0”, a previously indicated/applied TCI state for the list of UEs continues to be applied.

In one example, a bit in the bitmap corresponds to a list of entities following a same TCI state ID/codepoint or source RS/QCL Type. The entities that follow a same TCI state ID/codepoint or source RS/QCL Type can be configured as disclosed in the present disclosure (e.g., as illustrated in FIG. 40). If a bit in the bitmap is “1” a TCI state ID/codepoint or source RS/QCL Type is included in the DCI for the corresponding list of entities. If a bit in the bitmap is “0” no TCI state ID/codepoint or source RS/QCL Type is included in the DCI for the corresponding list of entities. In one example, the role of “0” and “1” can be reversed. The TCI state ID/codepoints or source RS/QCL are in the order of bits with value “1” in the bitmap. In one example, if a TCI state is not indicated for a list of entities e.g. corresponding to a bit with value “0”, a previously indicated/applied TCI state for the list of entities continues to be applied. An entity can be as disclosed in the present disclosure.

In some examples, when a bit in the bitmap is “1,” wherein the bitmap can correspond to antenna port or an antenna port group or a list of antenna ports more than one TCI state ID/Codepoint or source RS/QCL-Type can be indicated to the UE for the antenna port or antenna port group or list of antenna ports respectively. In some examples, when a bit in the bitmap is “1,” wherein the bitmap can correspond to a UE or a group of UEs or a list of UEs more than one TCI state ID/Codepoint or source RS/QCL-Type can be indicated to a set of UEs for the UE or group of UEs or list of UEs respectively. In some examples, when a bit in the bitmap is “1,” wherein the bitmap can correspond to an entity or a group of entities or a list of entities more than one TCI state ID/Codepoint or source RS/QCL-Type can be indicated to an entity or a set of entities or a group of entities or a list of entities respectively, wherein an entity can be as disclosed in the present disclosure.

In one example, the multiple TCI state ID/Codepoint or source RS/QCL-Type can correspond to TCI states or source RS/QCL-Type for DL channels and signals and UL channels and signals.

In one example, the multiple TCI state ID/Codepoint or source RS/QCL-Type can correspond to indications with different source RS/QCL-Types, e.g., a first source RS with a first QCL type and a second source RS with a second QCL type are indicated for an antenna port or antenna port group or list of antenna ports or UE or group of UEs or list of UEs or entity or group of entities or list of entities with corresponding bit in bitmap set to “1.”

In one example, the multiple TCI state ID/Codepoint or source RS/QCL-Type can correspond to indications with different QCL-Types for single frequency network, e.g., a first source RS with a first QCL type associated with a reference TRP, and a second source RS with a second QCL type associated with another TRP are indicated for an antenna port or antenna port group or list of antenna ports or UE or group of UEs or list of UEs or entity or group of entities or list of entities with corresponding bit in bitmap set to “1.”

In one example, the number of TCI state ID/codepoints or source RS/QCL-Type can be configured and indicated to a UE by higher layer signaling, e.g., SIB signaling and/or RRC signaling and/or MAC CE signaling and/or L1 control (DCI) signaling.

In one example, the number of TCI state ID/codepoints or source RS/QCL-Type can be determined by the UE (e.g., implicit determination) based on other parameters or conditions. For example, if a UE is configured with separate TCI state indication, and an antenna port or an antenna port group or list of antenna ports or UE or group of UEs or list of UEs or entity or group of entities or list of entities is for DL and UL channels, two (a pair of DL and UL) TCI state IDs or source RS/QCL-Type can be indicated to the UE, if the UE is configured with joint TCI state indication one joint TCI state ID or source RS/QCL-Type can be indicated to the UE. In another example, if a UE is configured for single frequency network with 2 TRPs, two (for reference and other TRP) TCI state IDs or source RS/QCL Type can be indicated to the UE, if a UE is configured with single TRP, one TCI state ID or source RS/QCL Type can be indicated to the UE.

In one example, the number of TCI state ID/codepoints or source RS/QCL-Type associated with each bit of the bitmap is the same. In another example, the number of TCI state ID/codepoints or source RS/QCL-Types associated with each bit of the bitmap can be different, for example, if a bit in the bitmap corresponds to antenna ports or UEs or entities of DL and UL channels with separate beam indication, two state ID/codepoints or source RS/QCL-Type are indicated to the UE for that bit when it has a value of “1,” on the other hand, if a bit in the bitmap corresponds to antenna ports or UEs or entities of DL channels one state ID/codepoint or source RS/QCL-Type is indicated to the UE for that bit when it has a value of “1.”

In one example, a DCI is used to indicate the TCI state or TCI state ID or TCI state codepoint as disclosed in the present disclosure, wherein the TCI state can include source RS and corresponding QCL type as disclosed in the present disclosure. In an alternative example, the DCI can indicate a source RS and corresponding QCL type as disclosed in the present disclosure. The DCI includes a field-map. In one example, the DCI is transmitted to a UE. In one example, the DCI is transmitted to a set of UEs.

In one example, a field map can include multiple bits for corresponding object it represents (objects are described in the following examples). Each bit can correspond to a TCI state ID/codepoint or source RS/QCL Type. As an example for illustration, a field (e.g., for UE where a UE is an example of an object) can have two bits one bit for downlink TCI state ID/codepoint or source RS/QCL Type and the other bit for uplink TCI state ID/codepoint or source RS/QCL Type.

In one example, a field in the field-map corresponds to an antenna port.

In one example, a field in the field-map corresponds to a UE in a set of UEs.

In one example, a field in the field-map corresponds to a UE in an entity, wherein an entity can be as disclosed in the present disclosure.

In one example, a field in the field-map corresponds to a group of antenna ports that follow a same TCI state ID/codepoint or source RS/QCL-Type. The group of antenna ports is configured as disclosed in the present disclosure.

In one example, a field in the field-map corresponds to a group of UEs in a set of UEs that follow a same TCI state ID/codepoint or source RS/QCL-Type.

In one example, a field in the field-map corresponds to a group of entities that follow a same TCI state ID/codepoint or source RS/QCL-Type.

In one example, a field in the field-map corresponds to a list of antenna ports following a same TCI state ID/codepoint or source RS/QCL Type. The list of antenna ports is configured as disclosed in the present disclosure.

In one example, a field in the field-map corresponds to a list of UEs in a set of UEs following a same TCI state ID/codepoint or source RS/QCL Type. The list of UEs is configured as disclosed in the present disclosure.

In one example, a field in the field-map corresponds to a list of entities following a same TCI state ID/codepoint or source RS/QCL Type. The list of entities is configured as disclosed in the present disclosure.

A field can indicate the number of TCI state ID/codepoints or source RS/QCL Type being signaled for an antenna port or group of antenna ports or list of antenna ports or UE or group of UEs or list of UEs or entity or group of entities or list of entities. In one example, the field can indicate a pre-configured number. For example, if the field is of size 2-bits, a value of 0 (or N(0)) can indicate no TCI state ID/codepoints or source RS/QCL Type. A value of 01 can indicate N(1) TCI state ID/codepoints or source RS/QCL Type. A value of 10 can indicate N(2) TCI state ID/codepoints or source RS/QCL Type. A value of 11 can indicate N(3) TCI state ID/codepoints or source RS/QCL Type. In one example, N(0), if applicable, N(1), N(2) and N(3) can be configured and indicated to a UE by higher layer signaling, e.g., SIB signaling and/or RRC signaling and/or MAC CE signaling and/or L1 control (e.g., DCI) signaling. In one example, N(0)=0, N(1)=1, N(2)=2, and N(3)=3. In one example, if a TCI state is not indicated by DCI, e.g., corresponding a bit/field with value “0”, a previously indicated/applied TCI state continues to be applied for corresponding bit/field.

In one examples, the size of the DCI format conveying the beam indication can vary, depending on the number of antenna ports, or groups of antenna ports or list of antenna ports or UEs or groups of UEs or lists of UEs or entities or groups of entities or lists of entities for which a TCI state ID/codepoint or source RS/QCL-Type is being indicated, as well as the number of TCI state ID/codepoints or source RS/QCL-Type being indicated for each bit in the bitmap or field in the field-map with a non-zero value. Having a variable DCI format size can increase the complexity of the UE due to the increase in number of blind decodes. If the UE attempts to decode every possible DCI format size, the UE's decoding complexity may be high. Alternatively, several DCI-format sizes can be pre-defined, and the size of the actual DCI Format conveying the TCI state ID/codepoints or source RS/QCL-Type is rounded-up, by padding, to next pre-defined size that is larger than or equal to the DCI format size without padding. There is a tradeoff between the amount of padding (extra overhead) and number of pre-defined DCI format sizes (higher UE decoding complexity, and hence higher UE power consumption).

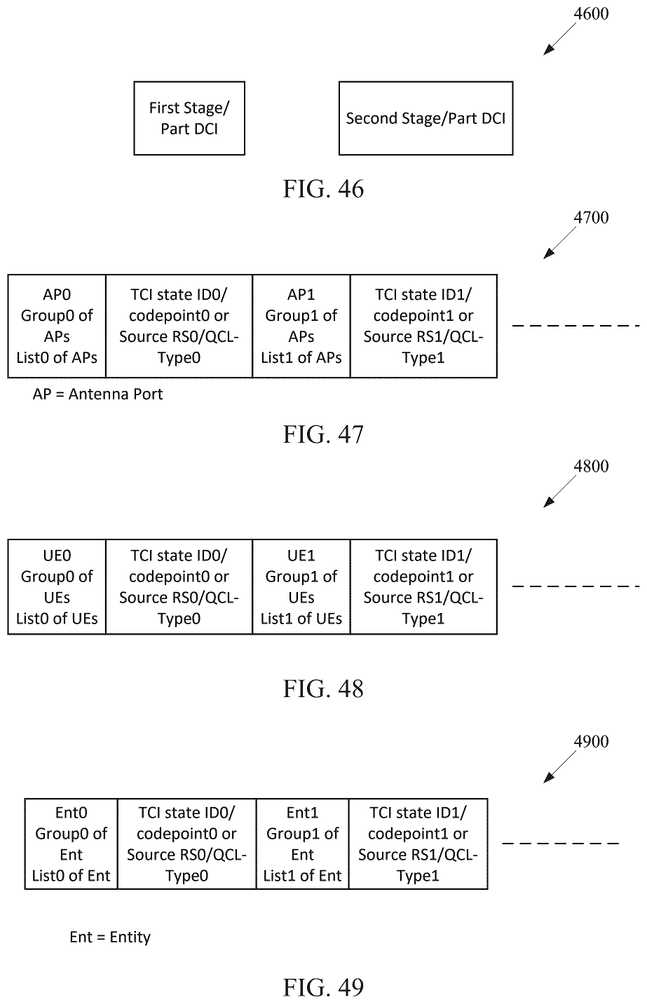

FIG. 46 illustrates an example of two stage/part DCI 4600 according to embodiments of the present disclosure. An embodiment of the two stage/part DCI 4600 shown in FIG. 46 is for illustration only.

To mitigate these issues, two stage/part DCI can be used as illustrated in FIG. 46, wherein the first stage/part DCI can indicate the size of the second stage/part DCI or number of elements in the second stage, e.g., number of TCI state IDs or TCI state codepoints or source/QCL-Type ID or codepoint. The UE uses blind decoding for the first stage/part DCI, when the first stage/part DCI is decoded, the UE can decode the second stage part based on information provided in the first stage/part DCI. The first stage/part DCI provides information to assist in determination of the presence of the second stage/part DCI and to assist in decoding the second stage/part DCI (e.g., resources used, payload size, modulation/coding scheme, etc.), hence reducing or eliminating blind decoding for the second stage/part DCI. In one example, there is a gap between the first stage/part DCI and second stage/part DCI as illustrated in FIG. 46. In one example, there is no gap between the first stage/part DCI and second stage/part DCI.

In one example, the first stage part DCI can include the size of the second stage/part DCI (e.g., size in number of bits or in number of bytes) or number of elements in the second stage, e.g., number of TCI state IDs or TCI state codepoints or source/QCL-Type ID or codepoint. The second stage/part DCI can be as disclosed in the present disclosure. For example, the second stage/part DCI can include: (i) a bitmap or a field-map of antenna ports or groups of antenna ports or lists of antenna ports or UEs or groups of UEs or lists of UEs or entities or groups of entities or lists of entities, as disclosed in the present disclosure; and/or (ii) one or more TCI state IDs/codepoints or source RS/QCL-Type for each bit in the bit-map or field in the field-map with a value of “1” or indicating a non-zero value as disclosed in the present disclosure.

In one example, the first stage DCI can include number of bits in a bitmap indicating a value of “1.” The second stage/part DCI can be as disclosed in the present disclosure. For example, the second stage/part DCI can include: (i) a bitmap of antenna ports or groups of antenna ports or lists of antenna ports or UEs or groups of UEs or lists of UEs or entities or groups of entities or lists of entities, as disclosed in the present disclosure; and/or (ii) one or more TCI state ID/codepoints or source RS/QCL-Type for each bit in the bit-map with a value of “1” or indicating a non-zero value as disclosed in the present disclosure.

In one example, the first stage DCI can include number of TCI state ID/codepoints or source RS/QCL-Type. The second stage/part DCI can be as disclosed in the present disclosure. For example, the second stage/part DCI can include: (i) a bitmap or a field-map of antenna ports or groups of antenna ports or lists of antenna ports or UEs or groups of UEs or lists of UEs or entities or groups of entities or lists of entities, as disclosed in the present disclosure; and/or (ii) one or more TCI state ID/codepoints or source RS/QCL-Type for each bit in the bit-map or field in the field-map with a value of “1” or indicating a non-zero value as disclosed in the present disclosure.

FIG. 47 illustrates an example of stage/part DCI 4700 according to embodiments of the present disclosure. An embodiment of the stage/part DCI 4700 shown in FIG. 47 is for illustration only.

FIG. 48 illustrates another example of stage/part DCI 4800 according to embodiments of the present disclosure. An embodiment of the stage/part DCI 4800 shown in FIG. 48 is for illustration only.

FIG. 49 illustrates yet another example of stage/part DCI 4900 according to embodiments of the present disclosure. An embodiment of the stage/part DCI 4900 shown in FIG. 49 is for illustration only.

In one example, the first stage part DCI can include the size of the second stage/part (e.g., size in number of bits or in number of bytes) or number of elements in the second stage, e.g., number of TCI state IDs or TCI state codepoints or source/QCL-Type ID or codepoint. The second stage/part DCI can include a list of pairs of ((1) antenna port or group of antenna ports or list of antenna ports or UE or group of UEs or list of UEs or entity or group of entities or list of entities, (2) corresponding TCI state ID/codepoint or source RS/QCL-Type) as illustrated in FIG. 47, FIG. 48, and FIG. 49.

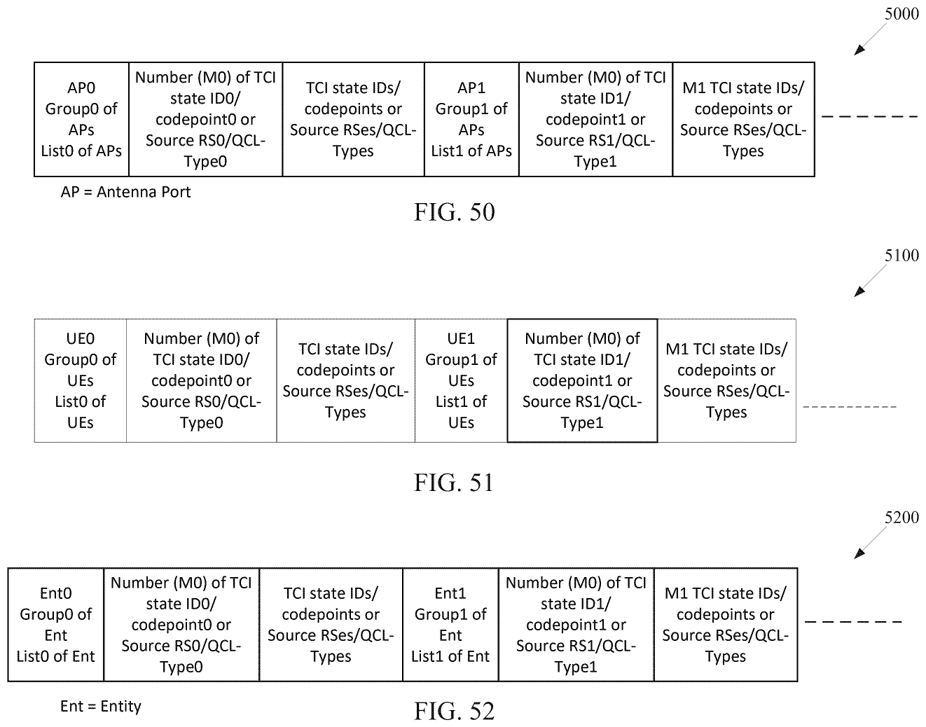

FIG. 50 illustrates yet another example of stage/part DCI 5000 according to embodiments of the present disclosure. An embodiment of the stage/part DCI 5000 shown in FIG. 50 is for illustration only.

FIG. 51 illustrates yet another example of stage/part DCI 5100 according to embodiments of the present disclosure. An embodiment of the stage/part DCI 5100 shown in FIG. 51 is for illustration only.

FIG. 52 illustrates yet another example of stage/part DCI 5200 according to embodiments of the present disclosure. An embodiment of the stage/part DCI 5200 shown in FIG. 52 is for illustration only.

In one example, the first stage part DCI can include the size of the second stage/part DCI (e.g., size in number of bits or in number of bytes) or number of elements in the second stage, e.g., number of TCI state IDs or TCI state codepoints or source/QCL-Type ID or codepoint. The second stage/part DCI, can include a list of triplets of ((1) antenna port or group of antenna ports or list of antenna ports or UE or group of UEs or list of UEs or entity or group of entities or list of entities, (2) number of TCI state IDs/codepoints or source RS/QCL-Types (e.g., M), (3) corresponding M TCI state IDs/codepoints or source RSes/QCL-Types) as illustrated in FIG. 50, FIG. 51, and FIG. 52. In one example, the number M across all entries is the same, and is provided once in the second stage/part DCI. In one example, the number M across all entries is the same, and is provided once in the first stage/part DCI. In one example, the number M can be different across entries, and the different values of M are provided in the first stage/part DCI.

In one example, the first stage/part DCI can include number of TCI state ID/codepoints or source RS/QCL-Type to be indicated to a UE or a set of UEs. The second stage/part DCI can include a list of pairs of ((1) antenna port or group of antenna ports or list of antenna ports or UE or group of UEs or list of UEs or entity or group of entities or list of entities, (2) corresponding TCI state ID/codepoint or source RS/QCL-Type) as illustrated in FIG. 47, FIG. 48, and FIG. 49.

In one example, the first stage/part DCI can include number of TCI state ID/codepoints or source RS/QCL-Type to be indicated to a UE or a set of UEs. The second stage/part DCI, can include a list of triplets of ((1) antenna port or group of antenna ports or list of antenna ports or UE or group of UEs or list of UEs or entity or group of entities or list of entities, (2) number of TCI state IDs/codepoints or source RS/QCL-Types (e.g., M), (3) corresponding M TCI state IDs/codepoints or source RSes/QCL-Types) as illustrated in FIG. 50, FIG. 51, and FIG. 52. In one example, the number M across all entries is the same, and is provided once in the second stage/part DCI. In one example, the number M across all entries is the same, and is provided once in the first stage/part DCI. In one example, the number M can be different across entries, and the different values of M are provided in the first stage/part DCI.

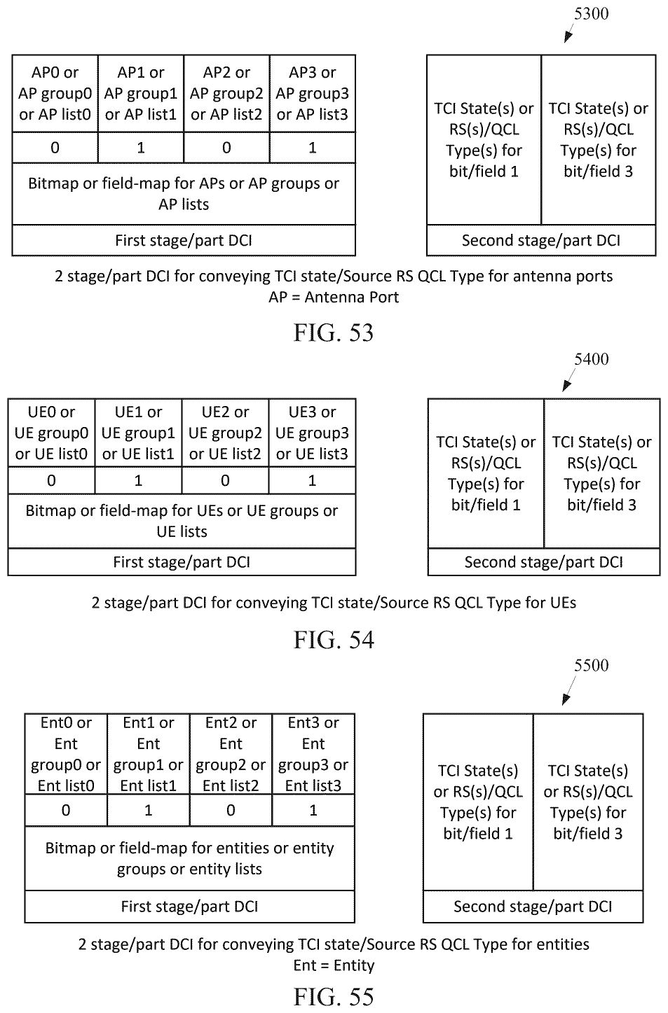

FIG. 53 illustrates an example of two stage/part DCI for conveying TCI state/source RS QCL type for antenna ports 5300 according to embodiments of the present disclosure. An embodiment of the two stage/part DCI for conveying TCI state/source RS QCL type for antenna ports 5300 shown in FIG. 53 is for illustration only.

FIG. 54 illustrates another example of two stage/part DCI for conveying TCI state/source RS QCL type for antenna ports 5400 according to embodiments of the present disclosure. An embodiment of the two stage/part DCI for conveying TCI state/source RS QCL type for antenna ports 5400 shown in FIG. 54 is for illustration only.

FIG. 55 illustrates yet another example of two stage/part DCI for conveying TCI state/source RS QCL type for antenna ports 5500 according to embodiments of the present disclosure. An embodiment of the two stage/part DCI for conveying TCI state/source RS QCL type for antenna ports 5500 shown in FIG. 55 is for illustration only.

In one example, the first stage/part DCI can include a bitmap or a field-map, wherein a bit in the bitmap or a field in the field-map can correspond to antenna ports or groups of antenna ports or lists of antenna ports or UEs or groups of UEs or lists of UEs or entities or groups of entities or lists of entities, as disclosed in the present disclosure. The second stage/part DCI can include one or more TCI state ID/codepoints or source RS/QCL-Type for each bit in the bitmap or field in the field-map with a value of “1” or indicating a non-zero value as disclosed in the present disclosure. This is illustrated in FIG. 53, FIG. 54, and FIG. 55. In one example, if a TCI state is not indicated by DCI, e.g., corresponding a bit/field with value “0”, a previously indicated/applied TCI state continues to be applied for corresponding bit/field.

In one example, the first stage/part DCI can include a combinatorial indicator, e.g., K choose N indicating the presence of K TCI state IDs/codepoints or source RS/QCL-Type in the second stage/part DCI, wherein K corresponds to K antenna ports or K groups of antenna ports or K lists of antenna ports or K UEs or K groups of UEs or K lists of UEs or K entities or K groups of entities or K lists of entities in set of M antenna ports or M groups of antenna ports or M lists of antenna ports or M UEs or M groups of UEs or M lists of UEs or M entities or M groups of entities or M lists of entities respectively. The second/part DCI stage can include the corresponding K TCI state IDs/codepoints or source RS/QCL-Type. In one example, K and/or M can be configured and indicated to a UE by higher layer signaling, e.g., SIB signaling and/or RRC signaling and/or MAC CE signaling and/or L1 control (e.g., DCI) signaling. In one example, if a TCI state is not indicated by DCI, e.g., not part of the K indicated TCI states/TCI state codepoints or source RS/QCL-Type, a previously indicated/applied TCI state continues to be applied for corresponding bit/field.

In one example, the first stage/part DCI can include a combinatorial indicator, e.g., K choose N indicating the presence of K groups of TCI state IDs/codepoints or source RS/QCL-Type in the second stage/part DCI, wherein K corresponds to K antenna ports or K groups of antenna ports or K lists of antenna ports or K UEs or K groups of UEs or K lists of UEs or K entities or K groups of entities or K lists of entities in set of M antenna ports or M groups of antenna ports or M lists of antenna ports or M UEs or M groups of UEs or M lists of UEs or M entities or M groups of entities or M lists of entities respectively. The second/part DCI stage can include the corresponding K groups of TCI state IDs/codepoints or source RS/QCL-Type. In one example, K and/or M can be configured and indicated to a UE by higher layer signaling, e.g., SIB signaling and/or RRC signaling and/or MAC CE signaling and/or L1 control (e.g., DCI) signaling. In one example, if a TCI state is not indicated by DCI, e.g., not part of the K groups of indicated TCI states/TCI state codepoints or source RS/QCL-Type, a previously indicated/applied TCI state continues to be applied for corresponding bit/field.

In one example, a group of TCI states can include a DL TCI state and an UL TCI state (e.g., in case of separate beam indication).

In one example, a group of TCI states can be TCI states of a UE panel.

In one example, a group of TCI states can be TCI states of a TRP panel.

In some examples, the first stage additionally includes a first TCI state ID/codepoints or source RS/QCL-Type of a first antenna port or group of antenna port or list of antenna port, or first UE or group of UEs or list of UEs or first entity or group of entities or list of entities. The present disclosure provide embodiment include a per antenna port or UE or an entity beam indication using two stage/part DCI.

The above flowcharts illustrate example methods that can be implemented in accordance with the principles of the present disclosure and various changes could be made to the methods illustrated in the flowcharts herein. For example, while shown as a series of steps, various steps in each FIG. could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE), comprising:
a processor, and
a transceiver operably coupled to the processor, the transceiver configured to:
receive a configuration of one or more sets of transmission configuration indicator (TCI) states,
receive a first message activating TCI state code points, from the one or more sets of TCI states, and
receive a second message indicating TCI state code points for N entities,
wherein:
the second message includes:
a field map of size N fields, and
a list of TCI states code points in order of the N fields of the field map and according to a number of TCI state code points indicated by each field,
each field of the N fields correspond to an entity of the N entities, and
each field indicates the number of TCI state code points indicated for the corresponding entity.

2. The UE of claim 1, wherein:
the field map is a bitmap,
a bit of the bitmap corresponds to a field of the field map,
when the bit has a value of “1”, a TCI state code point is present for the corresponding entity,
when the bit has a value “0”, the TCI state code point is absent for the corresponding entity, and
the processor is further configured to, when the bit indicates that the TCI state code point is absent for an entity, apply a previously indicated TCI state code point for the entity.

3. The UE of claim 1, wherein an entity from the N entities is a demodulation reference signal (DM-RS) antenna port.

4. The UE of claim 1, wherein:
the transceiver is further configured to receive N lists of demodulation reference signal (DM-RS) antenna ports, and
an entity of the N entities corresponds to a list from the N lists.

5. The UE of claim 1, wherein:
the transceiver is further configured to receive a configuration of a quasi-co-location (QCL) type,
the QCL-type configuration includes a list of QCL properties, and
the list of QCL properties include one or more of:
a Doppler shift,
a Doppler spread,
a delay spread,
an average delay,
spatial receive parameters, and
phase information.

6. The UE of claim 1, wherein:
the second message is a downlink control information (DCI) format with two parts,
a first part of the two parts includes the field map, and
a second part of the two parts includes the list of indicated TCI state code points based on the field map.

7. The UE of claim 1, wherein:
the transceiver is further configured to receive a first TCI state code point to a first entity from the N entities,
the first TCI state code point is associated with a first reference signal (RS) and corresponding first and second quasi-co-location (QCL) types,
the transceiver is further configured to receive a second TCI state code point to a second entity from the N entities,
the second TCI state code point is associated with the first RS and corresponding first QCL-type, and
the second TCI state code point is associated with a second RS and a corresponding second QCL-type.

8. A base station (BS), comprising:
a processor, and
a transceiver operably coupled to the processor, the transceiver configured to:
transmit a configuration of one or more sets of transmission configuration indicator (TCI) states,
transmit a first message activating TCI state code points, from the one or more sets of TCI states, and
transmit a second message indicating TCI state code points for N entities,
wherein:
the second message includes:
a field map of size N fields, and
a list of TCI states code points in order of the N fields of the field map and according to a number of TCI state code points indicated by each field,
each field of the N fields correspond to an entity of the N entities, and
each field indicates the number of TCI state code points indicated for the corresponding entity.

9. The BS of claim 8, wherein:
the field map is a bitmap,
a bit of the bitmap corresponds to a field of the field map,
when the bit has a value of “1”, a TCI state code point is present for the corresponding entity,
when the bit has a value “0”, the TCI state code point is absent for the corresponding entity, and
the processor is further configured to, when the bit indicates that the TCI state code point is absent for an entity, apply a previously indicated TCI state code point for the entity.

10. The BS of claim 8, wherein an entity from the N entities is a demodulation reference signal (DM-RS) antenna port.

11. The BS of claim 8, wherein:
the transceiver is further configured to transmit N lists of demodulation reference signal (DM-RS) antenna ports, and
an entity of the N entities corresponds to a list from the N lists.

12. The BS of claim 8, wherein:
the transceiver is further configured to transmit a configuration of a quasi-co-location (QCL) type,
the QCL-type configuration includes a list of QCL properties, and
the list of QCL properties include one or more of:
a Doppler shift,
a Doppler spread,
a delay spread,
an average delay,
spatial receive parameters, and
phase information.

13. The BS of claim 8, wherein:
the second message is a downlink control information (DCI) format with two parts,
a first part of the two parts includes the field map, and
a second part of the two parts includes the list of indicated TCI state code points based on the field map.

14. The BS of claim 8, wherein
the transceiver is further configured to transmit a first TCI state code point to a first entity from the N entities,
the first TCI state code point is associated with a first reference signal (RS) and corresponding first and second quasi-co-location (QCL) type,
the transceiver is further configured to transmit a second TCI state code point to a second entity from the N entities,
the second TCI state code point is associated with the first RS and corresponding first QCL-type, and
the second TCI state code point is associated with a second RS and corresponding second QCL-type.

15. A method of operating a user equipment (UE), the method comprising:
receiving a configuration of one or more sets of transmission configuration indicator (TCI) states;
receiving a first message activating TCI state code points, from the one or more sets of TCI states; and
receiving a second message indicating TCI state code points for N entities,
wherein:
the second message includes:
a field map of size N fields, and
a list of TCI states code points in order of the N fields of the field map and according to a number of TCI state code points indicated by each field,
each field of the N fields correspond to an entity of the N entities, and
each field indicates the number of TCI state code points indicated for the corresponding entity.

16. The method of claim 15, wherein:
the field map is a bitmap,
a bit of the bitmap corresponds to a field of the field map,
when the bit has a value of “1”, a TCI state code point is present for the corresponding entity,
when the bit has a value “0”, the TCI state code point is absent for the corresponding entity, and
the method further comprises, when the bit indicates that the TCI state code point is absent for an entity, applying a previously indicated TCI state code point for the entity.

17. The method of claim 15, further comprising:
receiving N lists of demodulation reference signal (DM-RS) antenna ports, and
wherein an entity of the N entities corresponds to a list from the N lists.

18. The method of claim 15, further comprising:
receiving a configuration of a quasi-co-location (QCL) type,
wherein the QCL-type configuration includes a list of QCL properties, and
wherein the list of QCL properties include one or more of:
a Doppler shift,
a Doppler spread,
a delay spread,
an average delay,
spatial receive parameters, and
phase information.

19. The method of claim 15, wherein:
the second message is a downlink control information (DCI) format with two parts,
a first part of the two parts includes the field map, and
a second part of the two parts includes the list of indicated TCI state code points based on the field map.

20. The method of claim 15, further comprising:
receiving a first TCI state code point to a first entity, from the N entities, wherein the first TCI state code point is associated with a first reference signal (RS) and corresponding first and second quasi-co-location (QCL) type;
receiving a second TCI state code point to a second entity from the N entities,
wherein the second TCI state code point is associated with the first RS and corresponding first QCL-type, and
wherein the second TCI state code point is associated with a second RS and corresponding second QCL-type.
